(19) United States
(12) Patent Application Publication
(10) Pub. No.: US 2016/0292248 A1
(43) Pub. Date: Oct. 6, 2016

(54) METHODS, SYSTEMS, AND ARTICLES OF MANUFACTURE FOR THE MANAGEMENT AND IDENTIFICATION OF CAUSAL KNOWLEDGE

(71) Applicant: CAMBRIDGE SOCIAL SCIENCE DECISION LAB INC., Washington, DC (US)

(72) Inventor: Fernando Martel Garcia, Washington, DC (US)

(73) Assignee: Cambridge Social Science Decision Lab Inc., Washington, DC (US)

(21) Appl. No.: 15/037,190

(22) PCT Filed: Nov. 24, 2014
(86) PCT No.: PCT/US14/67127

§ 371 Date: May 17, 2016

Related U.S. Application Data
(60) Provisional application No. 61/907,841, filed on Nov. 22, 2013.
(60) Provisional application No. 61/934,554, filed on Jan. 31, 2014.

(51) Int. Cl. G06F 17/30; G06F 17/18

(52) U.S. Cl. CPC G06F 17/30572; G06F 17/30958; G06F 17/18

(57) ABSTRACT

Systems, methods, and articles of manufacture are disclosed for the identification and management of causal knowledge. Organizations can use this knowledge to improve performance by, for example, designing cost-effective interventions to change customer or employee behavior. These methods use novel ways to abstract, standardize, and automate the identification and management of causal knowledge, thus making it accessible and affordable to most business users. Moreover, methods are disclosed that—for the first time—solve two critical problems of randomized controlled trials: Missing data on the outcomes of interest, and the inability to generalize findings from the experimental sample to the population using non-probability samples. This includes solving a fundamental problem (present also in probability samples) with the generalization of segmented analysis from a study sample to a population. Use of these embodiments will make the identification and management of causal knowledge much more cost effective, efficient, and reliable.

### CROSS-REFERENCE TO RELATED APPLICATIONS

This application claims priority to U.S. Provisional Patent Application 61/907,841, filed 22 Nov. 2013, and U.S. Provisional Patent Application 61/934,554, filed on 31 Jan. 2014, both of which (including their appendices) are incorporated herein by reference.

### FIELD OF THE INVENTION

This invention relates to automated systems for supporting the management and identification of causal knowledge in organizations, technological endeavors, and other fields. Specifically, it relates to methods, systems, and articles of manufacture for the integrated management of the full causal knowledge life cycle including eliciting, representing, validating, storing, and using casual knowledge for improved organizational performance.

### BACKGROUND OF THE INVENTION

From the dawn of civilization humans have been interested in causal knowledge, or knowledge about causes and their effects. Indeed, causal knowledge is central to organizational performance. After all, most government programs, business investments, and nonprofit campaigns are designed to cause changes in specific outcomes like improving public school test scores, increasing customer loyalty, or encouraging safer sex practices in a target population. In the private sector such causal knowledge can also form the basis of competitive advantage. For example, hospitals that know how to intervene effectively to reduce the 30 patient re-admission may be able to attract more and higher paying customers relative to the competition, as they can guarantee better quality at a lower cost.

Identifying casual knowledge—and managing it effectively to improve organizational performance—is a complex business process few if any organizations have mastered. Presently most organizations have no explicit knowledge identification and management strategy—partly because they lack dedicated systems and skilled personnel. The applicant also appreciates that most organizations do a very poor job of eliciting, managing, storing, and using existing causal knowledge about how to bring about changes in an outcome of interest. In part this is because the amount of causal knowledge available is in principle vast.

The identification of causal knowledge is also complicated by its counterfactual nature. For example, to say a marketing campaign caused sales to increase by one million dollars is to imply that—had the marketing campaign not taken place (a counterfactual scenario)—sales would have been lower by one million dollars. Unfortunately this counterfactual claim is unverifiable: Once the marketing campaign is implemented we cannot observe what would have happened had it not taken place, and, in particular, whether sales would have increased by one million (or more!) on their own. More generally, even if sales were to increase by one million dollars every time the campaign is implemented we still cannot rule out the possibility that sales would have increased on their own. In short, observed correlations between events do not imply causation. The upshot is that organizations that rely on passive observation, experience, and intuition to judge the effectiveness of their operations often make egregious mistakes, like wasting resources on ineffective campaigns, or forgoing effective ones.

Randomized control trials (RCTs) are the scientific gold standard for the identification causal knowledge. RCTs try to overcome the counterfactual problem by assigning, say, a marketing campaign at random (e.g. by tossing a coin) to some markets (the treatment group) but not others (the control group). Because the assignment is random the two groups are, on average, identical in sufficiently large samples. As a result, the average sales in the control group serves as a stand-in for the unobserved (i.e. counterfactual) average sales in the treatment group—had the treatment group not received the marketing campaign. (Intuitively an RCT is a method to ensure the average outcome in the control elements is a good plug-in estimate for the missing counterfactual for the treated elements.) If the difference between these two averages is one million dollars, say, then we can say with some confidence that the marketing campaign increased sales in the treatment group by a million (i.e. relative to what would have happened had it not received the marketing campaign).

One problem with RCTs is that they often require highly skilled labor, well executed experiments, careful analysis, and significant outlays. This is an expensive, complicated, and frail craft practiced by experts craftsmen subject to human unreliability. Indeed, in the applicant's experience the skill, human unreliability, and expense involved places this craft beyond the reach of most small and medium enterprises, many public agencies, and non-profits. Even large organizations have difficulty implementing such research programs effectively, especially when outside craftsmen are hired who's incentives are not always aligned with those of the organization. At the same time in-house solutions are often inefficient, with individual organizations having to “reinvent” research methods, measurement instruments (like customer satisfaction surveys), and intervention designs anew each time. This is incredibly time consuming, costly, and inefficient.

A second problem with RCTs has to do with attrition, or missing data on the outcome of interest. This can be a problem even for flawlessly executed RCTs. For example, suppose some study participants in the treatment group are harmed by an intervention, while others benefit from it. Suppose those harmed by the intervention also happen to be the ones refusing to answer the customer satisfaction survey used to measure the effectiveness of the intervention. It follows that if we ignore the missing responses when computing the average responses for the treatment and control groups, we will overestimate the impact of the intervention, as all those harmed by it are omitted from the calculation. In practice most analysts don't even know why some responses are missing. Consequently they cannot even guess whether the estimated effect is an over- or under-estimate of the true effect. As a result the results of the experiment are much less informative and valuable. Unfortunately, attrition is a very common phenomenon in RCTs. Indeed, the problem is so bad attrition has been dubbed “the Achilles' heel of the randomized experiment”. Although statisticians have devised various ways to deal with attrition none of these provides a proven diagnostic tests capable of detecting problematic attrition; nor a method of finding conditioning strategies that, if available, may render problematic attrition unproblematic.

A third problem with RCTs has to do with generalizability, or the extent to which findings from one RCT generalize to the broader population. Generalizability is the second Achilles' heel of the randomized experiment. For example, a credit card issuer may implement a pilot RCT in a small sample from the population of interest to test whether a new mail offer will increase uptake in the target population. The objective is to roll out the offer to all the population of interest in case it proves successful in the pilot group. In addition, the credit card issuer may also want to segment the results of the pilot study according those participant characteristics associated with the best uptake. Typically these segments are defined in terms of some characteristic like gender, age, or number of employees (if the intervention involves retail stores say). The idea is to then maximize the cost-effectiveness of the roll-out by targeting the intervention to those elements in the target population that share similar characteristics to those elements in the pilot that exhibited the greatest uptake. In both the segmented and unsegmented analysis the credit card issuer is generalizing (i.e. extrapolating) from the estimated effect in the pilot study, to what the true effect may be in the broader population, or segment thereof. Although statisticians have devised various ways to deal with generalizability, including random sampling from the population, these are often impractical for cost, logistical, or ethical reasons. In actual practice many organizations rely on convenience (i.e. non-probability) samples. Unfortunately there are no methods that can diagnose whether segmented or unsegmented findings of a convenience sample are generalizable, or that can find a solution in case generalizability problems are diagnosed.

If problems related to generalizability are not addressed findings from a pilot randomized controlled study can grossly over- or under-estimate the true effects of that same intervention in a target population, resulting in wasted effort or forgone opportunities. When findings from a pilot overestimate the true effects in a target population organizations run the risk of wasting costly efforts on interventions that will not live up to expectations. Similarly, when the findings from the pilot underestimate the true effect in the target population, organizations run the risk of forgoing profitable opportunities if the intervention is cancelled.

### SUMMARY OF THE INVENTION

What is needed is a fully integrated and automated solution that simplifies the process of managing and identifying causal knowledge, and that addresses the two major short-comings of RCTs: attrition, and lack of generalizability. First, such an integrated solution ought to standardize and automate the process of causal knowledge identification as much as possible, with a view to making it more reliable, affordable, and accessible to less skilled personnel. Second, it should provide simple practical processes to address the two fundamental problems of RCTs—attrition, and lack of generalizability. This is critical to improving the cost effectiveness of research, and to avoid wasting effort, or forgoing good opportunities, from unreliable findings and extrapolations. Third, such a solution would integrate research findings from individual RCTs into a single computer-accessible knowledge repository and causal knowledge management solution. One that summarizes all that is known about the specific causal mechanism in question, informs organizational decisions, and provides strategic direction for future research.

One aspect of embodiments of the invention is to provide methods, systems, and articles of manufacture that standardize, and partially automate and assist the management and identification of causal knowledge over the full knowledge life cycle. And do so in an affordable, reliable, and accessible way. The knowledge life cycle includes, but is not limited to, the activities of eliciting causal knowledge from experts, texts, or data; storing, representing and communicating these guesses in a user friendly manner; validating them using RCTs; updating stored guesses and identified knowledge in an institutional knowledge repository; and querying such a knowledge repository for the purposes of designing further studies, informing decisions, and improving organizational performance. Embodiments allow those skilled in the arts of causal research to delegate more tasks on less skilled personnel, and to leverage their time and expertise more efficiently. They also make the management and identification of causal knowledge more accessible to organizational personnel with little or no skill in the area. And they also may increase the coherence, reliability, productivity, and accessibility of an organization's research.

Another aspect of embodiments of the invention is directed to a system and computer-implemented method to minimize the impact of problematic attrition on causal knowledge identification. Some embodiments will provide users with the first proven processes for diagnosing problematic attrition, and for detecting possible covariate adjustment strategies that can render problematic attrition unproblematic. As used herein, “unproblematic attrition” refers to attrition that can be ignored, or adjusted for in ways explained below, such that the analysis gives “approximately unbiased and statistically consistent estimates” of causal quantities of interests. Embodiments will also provide options at the design stage (i.e. before the RCT is implemented) to help minimize the impact of any problematic attrition that might happen once the RCT is implemented. Indeed, an advantage of an integrated knowledge management and identification system is the ability to build-in preventive measures into the manufacturing process generating causal inferences. In combination these preventive, diagnostic, and conditional adjustment measures will increase the reliability of findings from RCTs. It will also result in significant cost savings, as fewer costly RCTs will be needed to reliably detect a cause and effect relation.

Yet another aspect of embodiments of the invention is directed to a system and computer-implemented method to ensure generalizable inferences from RCTs to target populations or subsets thereof. Specifically, the system provides users with new processes capable of determining ex ante whether findings from a planned RCT can be extrapolated reliably to a different target population (or subset thereof), and, if not, to automatically search for possible covariate adjustment strategies that may license such an extrapolation. Having determined whether, and how, generalization is feasible, the method then computes the correct estimate for the target population (or subset thereof). If no such identification strategy is possible, the process can suggest a different sampling strategy at the design stage to ensure generalizability. This choice tries to respect as much as possible the users preferred selection criteria, recognizing that the choice of participants for an RCT is often constrained by convenience, cost, logistics, and other practical or ethical considerations. Moreover, the process also envisages searching for other studies in the database that, when combined in specific ways with the non-generalizable study under consideration, can license an unbiased extrapolation. These processes also work ex post, by testing whether existing findings from previous studies can be generalized to new populations of interest. Importantly, these processes and functionalities also apply to segmentation analysis, where the goal is to extrapolate from segments (i.e. subgroups) in the pilot study where the intervention was specially successful, to similar groups in the population. As used herein, a “generalizable inference” refers to an analysis that, based on the sample of elements in the RCT, gives “approximately unbiased and statistically consistent estimates” of the distribution of outcomes that would be observed just in case the same intervention is performed in the target population (or any subset thereof).

According to other aspects of embodiments of the invention, a computerized system is provided to implement the methods and techniques disclosed herein. The use of a computer, and a computerized networked system advantageously automates the methods and facilitates application in various technical applications. Learning about the true causal structure generating the data in a domain of interest is computationally very expensive. First, the amount of potentially useful causal knowledge for designing an experiment is vast. For example, such knowledge may reside in written texts, like academic journals, or internal reports of an organization, or websites, or any other written medium. It may also reside in an organization's databases, or in third party databases. As an illustration, a hospital network may be interested in learning about common causes of 30 day patient readmission rates with a view to learning how to reduce such a rate. A Google Scholar search for “patient readmission” in 1/17/14 returned 155,000 results from the academic literature alone. It is clear that no human being can (or should) read all this literature to identify possible causes of high readmission rates. Thus there is an urgent need for computer assisted strategies for mining this knowledge in search for causal relations, as explained below. Second, the analytical techniques disclosed herein are computationally very expensive. For example, an important aspect of the invention is testing what combination of variables X might d-separate (i.e. render conditionally independent) any two variables S from Y in the underlying (i.e. unknown) causal graph generating the data we observe. A simple brute force implementation of this test in an application with 100 variables in the set X requires Σᵣ₌₁ⁿn!/r!(n−r)!=1.27×10³⁰ possible test. Although much more efficient testing strategies are possible still other aspects can ruin this advantage. For example, because causal graphs are non-parametric, it may be preferable to use non-parametric tests. Yet it turns out distribution free versions of these tests are so computationally expensive they are only applicable in small problems. Fundamentally, the reason most analytical techniques in this domain are computationally expensive has to do with the fact that the number of possible causal graphs consistent with any available dataset is exponential in the number of nodes (variables). A simple upper bound is O(2^{X (X-1)/2}). Thus computing the full posterior (i.e. belief, expressed as a probability) over the space of possible graphs P( [symbol] |X), let alone storing it, remains an impossible task for most practical problems. So even with the best computers we still have to work around these problems.

Some embodiments of the invention herein provide an integrated solution for Knowledge Identification & Management^{SM} with regards to specific technical problems or goals. It provides:
A computerized, networked system to discover and manage causal knowledge;
A user friendly Graphical Knowledge Management™ language to encode and communicate causal knowledge, including Knowledge Discovery Graphs™ (KDG).
A Knowledge Market™ for Business Science™ services and products;
A system for generating validated, verifiable, and replicable research reports.

In one embodiment there is provided a computer implemented method, the method comprising acts of receiving as input a research goal. For example, the user may want to reduce the rate of patient re-admission for a class of patients, for all patients in a hospital, or for some or all patients across a network of hospitals. The method provides a system to define the goal, including a variable name, keywords, and synonyms for the key concept.

In another aspect, the user is provided with various options to evaluate the potential causes of the goal in question, say hospital re-admission. In one elicitation strategy the method brings together proprietary or third-party databases of academic or professional literature, along with a choice of proprietary, open source, or third party processes for extracting causal relations from the literature in relation to the goal. Given these inputs the method facilitates the processing of the literature database using natural language processing techniques. Such processing is capable of extracting causal language related to the goal of interest, and to form a best guess—quantified in probability—as to the possible causes of the outcome of interest across all cases studied in the literature. In another possible elicitation strategy the method brings together proprietary or third party quantitative data on the outcome and potential causes (e.g. data on re-admissions and patient records), and combines these with structure learning capable of uncovering possible causal relations amongst the variables in the data set. In yet another elicitation strategy, the method combines a database of employee contacts and records (e.g. CVs, performance evaluations, publications) to help identify experts in the area (which can be done using processes in larger organizations). The method then allows the user to compose a survey (or source it from a third party via the knowledge market (described below), including more complex group elicitation methods like Delphi method, or surveys for the elicitation of parameters, and probability distributions), pilot test it, field it to the experts (typically over a networked device, but also on paper), and combine the experts assessment of the causes of the goal of interest through mathematical or behavioural aggregation. Finally, the method supports complex combinations of these elicitation strategies.

In yet another aspect of the innovation the results of these elicitation strategies are displayed in a Knowledge Discovery Graph^{SM} (KDG). A KDG is a directed acyclic graph of variables represented as nodes and directed, bi-directed, or partially directed edges denoting causal relations. A KDG shows graphically and intuitively the state of causal knowledge in the system at any point in the research process. Furthermore the graph acts as the primary graphical user interface to causal knowledge. For example, the thickness of the edges may reflect the degree of confidence in that particular causal relation. The color of the arrow may reflect whether the causal relation has been tested experimentally or is a best guess from an elicitation. Clicking on the arrow will bring up further information regarding the evidence behind the edge. This may include passages from, and links to, the relevant texts in case the arrow was draw as a result of text mining, or links to experimental studies in the database and estimated effects and models. Similarly the color of the nodes can represent whether data for that specific variable is available in the system, and clicking on a variable can bring up relevant information on that variable, including name, definition, measurement scale, and the ability to look at the tabular data and plot it. Similarly icons may be displayed next to the nodes to indicate which variables experts believe are directly manipulable by the organization (e.g. pay scales), which are manipulable only indirectly (e.g. smoking status, which can be affected indirectly via smoking cessation programs), and non-manipulable (e.g. race, gender). Indirectly manipulable causes can be defined as new outcomes and the process of elicitation repeated to find out what other variables can be used to change that cause of the goal of interest. This process can be continued until the user is satisfied with the representation.

In yet another aspect, and at the user's discretion, the process of elicitation can be repeated to elicit from data or experts the cost of manipulating the various manipulable variables in the KDG, as well as the expected effect of such manipulations on the goal of interest, and a measure of confidence in this effect. Together these inputs can be combined to determine the cost effectiveness of the various possible interventions, and rank which interventions should be tried first. That is, generate an optimal sequence of interventions.

In yet another aspect of the invention a method is provided for measuring the variables in the Knowledge Discovery Graph. The KDG itself represents the system's qualitative knowledge about the causes of the goal of interest (e.g. smoking causes cancer) but for empirical work these variables need to be measured and added to a database. Specifically, a method is provided to define measures (e.g. a Likert opinion scale, a readmission rate, etc.) and associated measurement instruments. These can also be sourced from a proprietary database, or third party provider (e.g. pre-compiled survey forms for measuring customer, patient, or employee satisfaction, as well as other measurement devices such as biometric data, which may be gathered in machine readable language using smart phones or other devices and transmitted over a network). Alternatively, pre-existing data in the organization's databases or from third-party providers can be linked directly to the KDG and used to “populate” the graph with data.

In one more aspect a method is provided for designing a research study to test aspects of the elicited KDG, including the effectiveness of an intervention on a population of interest. In one embodiment this task may be performed using the generalizability process disclosed herein. Often users want to test whether an intervention will be effective over a large population yet for logistic, regulatory, cost, ethical, or other reasons only a non-probability convenience subset of elements in this population can be part of the pilot study. With enough data the processes can tell ex ante—that is at the study design stage—whether findings from this convenience pilot study can be extrapolated to the broader population (or segments of the population defined by various characteristics of these elements like gender, age, ethnic groups, number of employees (if the elements are retail locations say) and so on), and how to do so without fear of under- or over-estimating the effects on the broader population. Alternative, if generalization is not possible the method helps design a sampling strategy that stays as close as possible to the convenience sample yet ensures generalizability. In addition, the method can help to determine the optimal number of elements that need to be recruited into the pilot for the estimated effects to be sufficiently precise. Moreover, the system allows access to previous experiments stored in the database, and to design a study capable of detecting differences between the proposed new intervention, and previous interventions stored in the database (so-called comparative effectiveness). Finally, the method outputs produces a Design Chart showing how elements are allocated to treatment and control (e.g in parallel groups, block randomized, etc). It also provides a Generalized Knowledge Discovery Graph (g-KDG) showing how the sample was selected from the population in the context of the causal model (see Martel García (2013a)). In one embodiment these are used to diagnose and remedy non-generalizabilty of convenience samples.

Another aspect provides a method for creating a 5W Chart, a modified Gantt chart depicting the who, what, where, when, and how of the study implementation, around a time line of activities. Features include:
Who—Enter team, contacts, etc e.g. PI, co-Pi, consultants, employees in participating stores, etc. . . . using drop down menus.
What—Enter tasks and responsibilities
Where—Activities assigned to treatment and control locations
When—Calendar for baseline, follow up, etc.
How—Instructions & checklists for accomplishing assigned tasks.

As with the Knowledge Discovery Graph, 5W Charts represent the main user interface for implementation activities, and are tradable objects themselves. For example, the user can search for pre-existing charts in a database, or from a third party, as well as all materials and methods, including:
Instruction sheets;
Checklists;
Communication (e.g. hook up to email & chat client);
Coordination (e.g. calendar, Gant chart, automated reminders);
Data entry forms;
Record keeping archive (Terms Of Reference, contracts, receipts, project documents).

In another aspect, a method is provided for the analysis of experimental outcomes, and the update of the Knowledge Discovery Graph and related features (e.g. associated databases, models, estimates, conditional probability tables etc.). In particular the user is presented with a graphical dashboard that shows the distribution of outcomes across experimental conditions, descriptive statistics, a choice of test statistics, and a choice of models for estimating the effect and its uncertainty. Critically, the system provides the users with processes disclosed herein to deal with missing data (Martel García 2013b), and generalizability of results (Martel García 2013a). Using minimal assumptions common to all experimental research (e.g. casual Markov assumption, faithfulness, excludability, randomization, and non-interference) these processes provide asymptotically correct statements about what effects can be estimated in the presence of missing data on the outcome of interest (so-called attrition), and whether such effects—which include overall effects as well as effects segmented by element characteristics (e.g. gender, income, number of employees, etc.)—can be extrapolated without bias from the pilot study to the target population. Also, the method allows for comparing how the KDG changes pre- and post intervention. In light of the evidence edges may be drawn or deleted (e.g. if a preponderance of evidence suggests no effect), change color or shapes, and icons are added or removed, among other, thereby giving a graphic snapshot of the system's state of causal knowledge.

One more aspect provides a method to run simulations using one or more Knowledge Discovery Graphs and associated database, including simulating the effect of scaling up the intervention in a pilot study to the full target population, comparing these results with results from previous interventions, or simulating the effect of various interventions at once. It also allows for conditioning the KDG on specific knowledge about a particular case, to yield probability statements about the possible effect of the intervention on that particular case, or group of cases. These simulations can be used to make evidence-based decisions. In addition, the system can also output automated research reports, including sources of information, descriptions of the interventions, charts and figures, comparisons of the KDG pre- and post intervention to share what was learned about the causal structure, simulation results and so forth. A method is provided for archiving all data and meta-data in a repository.

In yet another aspect, a computerized networked system that manages and implements all activities described herein, and that provides various users with access to existing knowledge graphs and associated materials. This can be accomplished with role based functional interfaces, that adapt what actions are allowed, knowledge presented, and so on according to the permissions of a user. In addition the method provides an application programing interface between the system and third party providers. This allows third party providers to share, buy, or sell data and computer-readable instructions across the network with the processors and server, and offer such services as measurements, measurement instruments, and other services like review and editing of research designs in a Knowledge Market™. These are only intended as exemplary services, and other services of a different kind may be provided.

### BRIEF DESCRIPTION OF THE DRAWINGS

FIG. 1 provides an illustration of an exemplary system in which to implement activities connected with the identification and management of causal knowledge.

FIG. 2 provides an exemplary flowchart of the Knowledge Identification & Management process.

FIG. 3 illustrates an exemplary implementation of the process to define new outcomes and population of interest.

FIG. 4 provides an exemplary flowchart of the causal knowledge elicitation process

FIG. 5 provides an example of a Directed Acyclic Graph.

FIG. 6 illustrates an exemplary implementation of the basic view for the elicitation process.

FIG. 7 illustrates an exemplary implementation of the advanced view for the elicitation process.

FIG. 8 provides a flowchart of the measurement process.

FIG. 9 illustrates an exemplary implementation of the measurement process.

FIG. 10 provides a flowchart of the study design process.

FIG. 11 illustrates an exemplary implementation of the randomized controlled trial (RCT) study design process.

FIG. 12 illustrates an exemplary implementation of the RCT design process, specifically for determining the optimal sample size.

FIG. 13 provides a flowchart of the study implementation process.

FIG. 14 illustrates an exemplary implementation of the Gannt abstraction engine.

FIG. 15 illustrates an exemplary implementation of an activity generation for the Gannt abstraction engine.

FIG. 16 provides a flowchart of the analysis and update process.

FIG. 17 illustrates an exemplary implementation of the analysis process.

FIG. 18 provides a flowchart of the causal knowledge query process.

FIG. 19 illustrates an exemplary implementation of the causal knowledge query process.

FIG. 20 summarizes the graphical conditions needed to identify and estimate causal effects in the presence of attrition.

FIG. 21 provides a flowchart of the attrition prevention, diagnosis, and remediation process.

FIG. 22 provides a flowchart of the attrition analysis process.

FIG. 23 illustrates an exemplary implementation of attrition analysis process.

FIG. 24 provides an exemplary illustration of a generalization directed acyclic graph, or g-DAG.

FIG. 25 provides an exemplary illustration of simplified g-DAGs (showing only the selection process) in a dynamic context.

FIG. 26 summarizes the graphical conditions needed to generalize findings from a study sample to the population of interest.

FIG. 27 provides a flowchart of the generalized inference process.

FIG. 28 illustrates an exemplary implementation of the generalized inference and RCT design process, specifically for determining the eligibility criteria of study elements.

FIG. 29 provides a flowchart of the generalization analysis sub-process to diagnose and remedy non-generalizability in convenience (i.e. non-probability) samples without changing the original sample.

FIG. 30 provides a flowchart of the generalization analysis sub-process to diagnose and remedy non-generalizability in convenience samples by minimally changing the original sample.

FIG. 31 provides a flowchart of the generalization analysis sub-process to minimize variance, maximize effect, and maintain overlap in unconstrained probability samples.

FIG. 32 illustrates an exemplary implementation of the generalization analysis sub-process to minimize variance, maximize effect, and maintain overlap in unconstrained probability samples, including web element to select sample on effect blanket.

FIG. 33 provides a flowchart of the generalization analysis sub-process to generalize segmented analyses from study samples to the population.

FIG. 34 process to combine studies that by themselves are not generalizable into a generalizable inference for the population.

### DETAILED DESCRIPTION

Conventional methods of knowledge identification and management can best be described as ad hoc. Most organizations rely on passive observation, intuition, and knowledge implicit in its personnel to decide operational interventions, and to judge when and where these interventions were effective. Such judgements can be clouded by the counterfactual nature of causality. Without a randomized controlled experiment (RCT) it becomes very hard to determine whether it was the marketing campaign, say, or the good weather, that increased sales in a certain period. Recently some organizations have embraced RCTs for identifying causal knowledge, running hundreds of experiments every year. Yet seldom are these RCTs informed by pre-existing causal knowledge. Nor are they typically integrated into a single knowledge repository. One that stores all data, inputs, and results in a single database, and that summarizes the state of organizational knowledge derived from all these experiment at any point in time. Nor do existing solutions incorporate a knowledge market where inputs to RCTs, like measurement instruments, biometric devices, or surveys used to measure key outcomes, like customer satisfaction, can be sourced effectively and cheaply. Instead most organizations have to reinvent the wheel and create these necessary inputs from scratch, or hire outside consultants. Finally, most solutions involve excessively technical language, including mathematical statistics and probability. This language is at once unintelligible to many decision makers and consumers of causal knowledge, and is ill suited to analyzing causality. This is because probability statements cannot distinguish causation from correlation.

In contrast to conventional ad hoc methods, the applicant appreciates that running RCTs is only one aspect of knowledge identification and management. Specifically, an effective knowledge identification and management strategy requires the integrated management of all aspects of the knowledge cycle, including but not limited to, eliciting, representing, validating, storing, communicating, and using causal knowledge for improved organizational performance.

The methods, systems, and articles of manufacture disclosed herein are directed towards new integrated approaches to managing the full causal knowledge life cycle. As explained in greater detailed below this approach makes explicit use of pre-existing causal knowledge; helps optimize knowledge identification strategies; makes available a Knowledge Market to leverage methods, materials, and other inputs for causal knowledge identification developed within, or outside the organization; provides a simple graphical construct—Knowledge Discovery Graphs (KDGs)—for documenting, representing, accessing, and communicating causal knowledge; and a unified knowledge repository for all inputs, data, KDGs, and conclusions stemming from an organization's knowledge identification and management activities. In addition, an integrated approach is the best way to take full advantage of the methods disclosed herein to deal with attrition and generalization. Considering these are the two biggest problems facing randomized control trials, such an integrated approach offers—for the first time—the best chance of dealing with these problems before, or after, embarking on a research program, thereby limiting wasted effort, and wrongful operational decisions. After all some of these experiments cost hundreds of thousands of dollars.

The applicant has further appreciated that none of the existing knowledge identification and management solutions incorporate effective methods to improve the robustness of RCT findings to attrition. A conventional approach of dealing with attrition is to ignore it, assuming—explicitly or implicitly—that attrition is completely at random, or random conditional on some observed characteristics. Under either of these assumptions the unobserved outcomes for elements with missing outcomes are no different from the outcomes of those elements whose outcomes are observed. (In the case of attrition at random this is only true within subgroups (or strata) defined by some observed characteristics.) This is because, as used herein, missing completely at random, or simply at random (that is, at random conditional on some observed characteristics), are statistical terms of art meaning that elements with missing outcomes have outcomes that in expectation are no different to the outcomes of elements with observed outcomes. As a result excluding the elements with missing outcomes when computing the average outcomes for the treatment and control groups does not introduce any distortions or biases. In practice both of these assumptions are often highly untenable. To wit, the second assumption is not even testable against data, so it must be held on faith. When these assumptions are false, elements with missing outcomes have outcomes that in expectation differ from the outcomes of elements with observed outcomes. As a result ignoring these elements in the computation of treatment and control group averages can introduce severe biases in the estimation of quantities of interest, like the average treatment effect.

Another conventional method to deal with attrition is to check whether the observed characteristics of elements with missing outcomes are similar to those with observed outcomes, in the hope that is they are similar in these observed characteristics then they are also likely to be similar on the missing outcomes. Yet there is nothing necessary nor sufficient about this proposition. Elements could have the same observed characteristics yet have very different outcomes, and vice versa. Another conventional method to deal with attrition is two-stage sampling, whereby a random sample of elements with missing outcomes is surveyed a second time rather intensively to get them all to respond to the survey and thus obtain a reliable estimate of the missing outcome for all elements missing outcomes. This is an effective strategy if all elements in the second stage respond, which is seldom the case. Besides, it is costly and has to be planned in advance. One more conventional method to deal with attrition is to report results, like extreme bounds, that adjust for the missing outcome data by attributing best and worst possible scenarios to these missing outcomes, so as to obtain a range of possible effect sizes. This approach trades reliability for uncertainty of the estimated effects, which is now only estimated to lie in a certain range. To wit, when attrition is common this range can be so large as to be completely uninformative. Besides, this approach can make an RCT much less informative than it need be (i.e. had attrition been analyzed properly, in ways explained below, and found not to be problematic).

In contrast to conventional methods for dealing with attrition, the techniques disclosed herein are directed towards a new method of computerized analysis to diagnose whether attrition is indeed problematic, or can be safely ignored, and whether adjustments strategies exists that can render problematic attrition unproblematic. Aspects of this methods may be applied ex ante, i.e. at the RCT design stage, or ex-post, after results and outcome data are in. The applicant has determined that attrition is a causal problem, not a statistical one. Although the true causal model is never directly observable, causation does imply correlation (though the reverse is not true). In other words, different unobserved models induce certain correlations in potentially observable data. The trick is then to use these observed patterns of correlation to infer whether the unobserved model generating them is problematic or not. Importantly, the target of inference is not the exact model generating the data, but only whether it belongs to the class of models generating problematic attrition, or not. Intuitively, the process is similar to a doctor who relies on the observable symptoms of a patient to diagnose the underlying unobserved disease, and, if possible, find a cure.

As explained in greater detail below, the approach to attrition disclosed herein has a number of advantages over conventional approaches. First, it does not rely on untestable assumptions: the diagnostic correlations are relatively easy to observe and test. Second, by establishing that problematic attrition depends on the underlying causal problem the method does not rely on completely ad hoc criteria, like the similarity of observed characteristics across elements with missing, and non-missing outcomes, focusing instead on diagnosing the underlying causal model. Third, by being able to diagnose problematic attrition, the method can provide much more precise answer than defaulting to extreme bounds, or other interval estimation methods whose estimated interval ranges are often so wide as to be completely uninformative. Indeed, it can help justify providing a point estimate for elements with observed outcomes and an extreme bound only for those units with unobserved outcomes. Fourth, the method can use 2-stage survey sampling (i.e. non-response follow up suveys) before the RCT starts (i.e. at baseline) to test whether any attrition that happens is likely to be problematic, and identify adjustment strategies that may render attrition unproblematic. It can also be used ex-post to refine the diagnosis of problematic attrition. Notably this test is valid even when, as is often the case, not all elements respond in the non-response follow up survey.

Finally, the applicant has appreciated that none of the existing knowledge identification and management solutions incorporate effective methods to test whether findings are generalizable to target populations, or subgroups thereof, ex-ante, at the RCT design stage, or ex-post, once results from an RCT are in. One conventional method of generalization requires that the elements participating in the RCT be a uniform random sample from the population of interest. This approach ensures that the estimated overall effect in the random sample is a consistent estimator for the effect of the intervention—i.e. converges to the true effect in large enough samples—were it to be applied to the full population of interest. The same is true for effects estimated within subgroups of the elements participating in the RCT. This is because, as used herein, a uniform random sample is a statistical term of art meaning that the elements selected to participate in the RCT have similar characteristics than the population of all elements from which the sample as selected. Though many existing applications rely on the assumption that the sample selected for the RCT is random, in practice selecting such a random sample is often unfeasible for logistical, ethical, cost, and other practical reasons. Yet when this assumption is false, the estimated impacts from the sample may over- or under-estimate the true effects in the population at large, or across segments of the population, resulting in potentially very costly wrongful decisions.

Another conventional technique to deal with generalization seeks to adjust for all observable differences between the sample of elements in the RCT and the target group in the population, in the hope that elements sharing similar observable characteristics will also experience similar effects. Yet there is nothing necessary nor sufficient about this proposition. Elements could have the same observed characteristics yet have very different outcomes, and vice versa, in part because they may have unobserved differences. A more subtle problem is that this approach can be too demanding, in that elements across the study sample and the target population need not be identical in all respects for the generalization to be valid, but only in causally relevant respects, as explained below. This broad brush approach can make data collection much more costly than it need be. Moreover, the applicant has further determined that this approach can in fact make the problem worse. As will be explained below, this will happen whenever similarity is sought on a collider variable. In other words, not all differences should be adjusted for. A final conventional technique is to rely on brute force. This involves repeating RCTs across different samples to determine whether an intervention that worked in one sample will work in the wider population, of segments thereof. Needles to say this is a costly, obtuse, unimaginative, and never ending enterprise.

In contrast to conventional approaches to generalization, the techniques disclosed herein are directed towards a new method of computerized analysis to design generalizable RCTs, including using convenience (i.e. non-probability) samples; to determine whether findings from pre-existing RCTs generalize to a target population or subgroups thereof; and to determine whether studies that by themselves are not generalizable can be combined with other studies into a generalized inference. Aspects of this method may be applied ex ante, i.e. at the RCT design stage, or ex-post, after results and outcome data are in. The applicant has determined that whether findings from an RCT generalize to a broader population depends on how the sample of elements participating in the RCT was selected from the population. As explained in more detail below, findings are generalizable whenever the sampling is independent of any direct, or indirect, cause of the outcome of interest. Specifically, it does not matter at all whether elements in the sample have very different characteristics from elements in the population, so long as those characteristics are neither direct (or indirect) causes of the outcome, or direct (or indirect) effects of any such causes. Often, in applications, analysts ignore both the underlying causal model, and the specific criteria used to select the RCT sample. No matter. Although the true causal model is never directly observable, and the selection criteria may be unknown, causation does imply correlation (though the reverse is not true). And, more importantly, different unobserved causal models induce certain correlations in potentially observable data. Consequently, we can use these observed patterns of correlation to infer whether the sample was selected independently from the causes of the outcome, or not. Importantly, the target of inference is not the exact causal model generating the data, nor the precise way the sample was selected, but rather whether selection was made independently of the outcome of interest. If so, the finding is generalizable to the population. If not, the method searches for conditioning strategies that can dissociate the selection form the outcome, such that the findings can be conditionally generalized.

As explained in greater detail below, the approach to generalization disclosed herein has a number of advantages over conventional approaches. First, it does not rely on untestable assumptions: the diagnostic correlations that license generalization from a sample to a population (or subgroup thereof) are relatively easy to observe and test. Second, by establishing that generalization depends on the way the sample was selected in relation to the causes of the outcome, it avoids heuristic criteria, like checking the similarity of observed characteristics across elements in the RCT sample and elements in the target population, that are neither necessary nor sufficient for generalization. Third, by establishing that what matters for generalization is not so much random sampling but sampling that is (conditionally) independent from the outcome, the method can do away with random sampling altogether. Not being constrained to random sampling allows the generalization techniques described herein to provide distinct advantages over conventional generalization techniques considering how, in actual practice, most RCTs are based on non-random samples for cost, logistical, convenience, ethical or other reasons. Fourth, in circumstances explained in greater detail below the techniques described herein can be applied iteratively across a number of studies, such that studies that by themselves are not generalizable can be combined with other studies into a generalized inference.

Embodiments of the method may be described below with reference to methods described by Fernando Martel García in “A Solution to Generalized Causal Inference”, available from the applicant; in the manuscript “A Unified Approach to Generalized Causal Inference” available at http://ssrn.com/abstract=2304970; and in the manuscript “Definition and Diagnosis of Problematic Attrition in Randomized Controlled Experiments” available at http://ssrn.com/abstract=2302735. All three documents are incorporated herein by reference.

Embodiments of the invention can be used to identify and manage causal knowledge in any field, especially with a view to improving operational performance. Such fields may include causal knowledge related to patient re-admissions in a hospital network; to employee performance or productivity in a service oriented firm; to controlling malaria incidence across developing countries, or to improving school performance scores in a geographic area. Moreover, the term population is used here as a statistical term of art to refer to any collection of elements. Such elements may be people, but also schools, retail stores, farms, villages or any other element about which we want to change some outcome or characteristic. Similarly sample is a statistical term of art that refers to any subset of elements from a population.

As used herein, an analysis of attrition or generalization is correct whenever it yields “approximately unbiased and statistically consistent estimates” of the distribution of outcomes across treatment and control conditions for the set of elements in the experimental sample, or for all elements of the population or any subset thereof, depending on the interest of the analyst. In turn, an estimator is a computer-implemented procedure, or method that is applied to a set of structured or unstructured data (e.g. data generated by an RCT, population sampling frames, and so on), and yields a set of “estimates” (e.g. estimated distributions of experimental outcomes for some set of elements). A “statistically consistent” estimator is one that, when applied to a set of input data, converges to the true value being estimated as the sample size grows larger. An “approximately unbiased” estimator is one which, on average across repeated samples of elements drawn from the same population of elements, produces an estimate that is equal to the true value being estimated. A generalized inference, as used herein, is a correct generalization from the estimate generated from some sample of elements in the population, to the true but unobserved estimate for all elements in the population, or subset thereof.

It should be understood that any aspect of the invention discussed above may be implemented alone or in any suitable combination with one another, as embodiments of the invention may implement any one or aspects of the invention. It should also be understood that though the discussion below is mostly in terms of classical frequentists approaches to statistics, this is in no way limiting, as the disclosures made herein are also applicable in other statistical frameworks, like Bayesian frameworks.

The techniques described herein may be implemented in one of various computing systems, some examples of which will be provided below. Such systems and related applications may be specially designed for implementing the various techniques and methods disclosed herein, or they may rely on general purpose computer equipment and software. Either way, such systems would involve the use of suitably-configured data processing equipment to implement a number of modules, each module providing one or more operations needed to implement the techniques and methods disclosed herein. Each module may be implemented in its own way; all need not be implemented the same way. Some of these modules may be of the type specially designed and constructed for the specific purposes of the invention, or they may be of a general purpose, widely available, and familiar to those skilled in the art of computer software.

### Integrated Knowledge Identification and Management Process and System

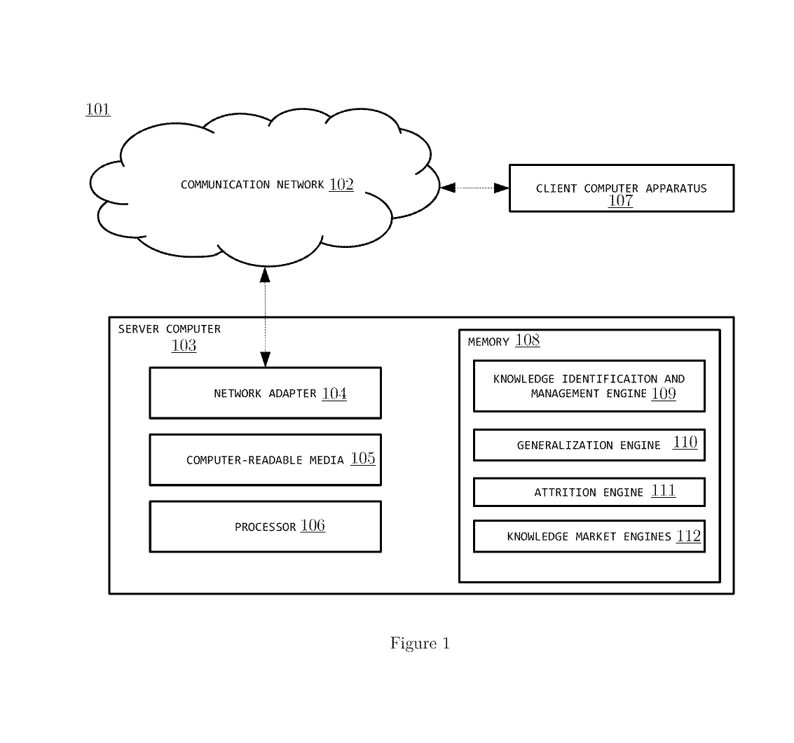

FIG. 1 depicts an exemplary server computer apparatus 103 and system 101 where certain aspects of the invention may be implemented, although other systems and configurations are possible. This depiction is for illustrative purposes only and is not intended to depict all necessary components of a computer device.

Server computer apparatus 103 may be connected to a communications network 102 via a network adapter 104. However, it should be appreciated that embodiments of the invention may operate on a simpler system not connected to a network. Server computer apparatus 103 may be any computer apparatus configured for sending and receiving data over a communications network 102. This includes, but is not limited to, mainframe computers, servers, desktops, laptops, tablets, smart phones, and personal assistants among others. Moreover, although computer apparatus 103 is shown as a single apparatus, it could be configured as a distributed network of computers able to communicate with each other in any way.

Server computer apparatus 103 includes a network adapter to facilitate communications with other devices connected to communications network 102. Such a network may be any kind of means of communication between two or more computer devices (e.g. a server and a client), including wired and wireless networks, intranets, or the Internet.

Server computer apparatus 103 also includes computer memory 108 that stores data to be processed and/or instructions for processing data by processor 106 according to certain aspects of the invention. Such programs include knowledge identification and management programs and instructions 109. Some of these are detailed below including a generalization engine 110, and an attrition engine 111. Yet other engines useful for the identification and management of causal knowledge may be uploaded by providers through client 107 via network 102, or uploaded directly to server computer 103. In addition computer server 103 also includes at least one computer-readable medium 105 for storing data to be executed by processor 106 in accordance with the various engines in memory 108. Such data need not reside physically in the server apparatus, but may be distributed over a network (e.g. network 102). These data may include structured, unstructured, or partially structured source data, including collections of texts to be processed using computational linguistics engines, quantitative data, results from surveying experts or any other machine readable data provided by the end-user, or a third party over network 102, or uploaded directly in server apparatus 103 via some computer-readable media 105.

Client computer apparatus 107 may be any computer apparatus including mainframes, desktop or laptop computers, servers, hand-held smart devices, and other electronic devices, including but not limited to biometric readers or radio-frequency identification devices that may serve readings to other clients (not shown), or server computer apparatus 103 over network 102. Although system 101 only shows one client computer apparatus, there may be a multiplicity of them. From example, in one embodiment client 107 may be a biometric device that transmits data over network 102 to server computer apparatus 103, which in turns process the data according to certain instructions consistent with the invention, and supplies the output results to another client computer apparatus (not shown), for example a desktop computer. In some instances client computer apparatus 107 may itself be configured like server computer apparatus 103.

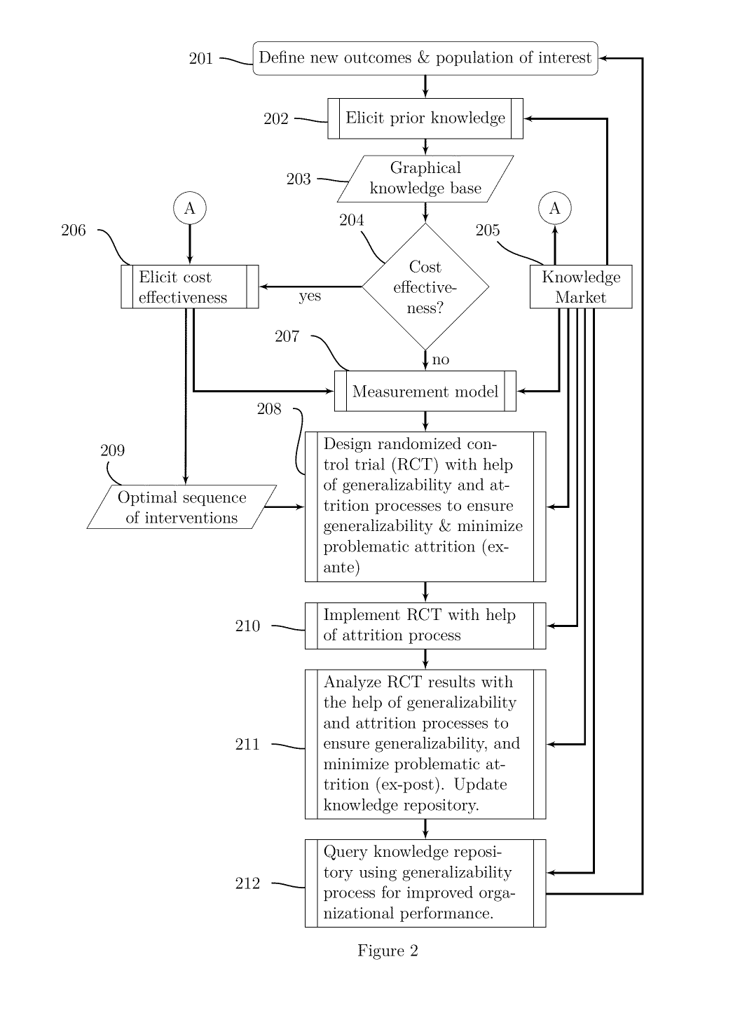

These computer apparatuses, programs, instructions, databases, and network depicted in system 101 may be used to implement techniques of the invention related to the identification and management of causal knowledge. Such techniques will be explained in greater detail below. As an overview some embodiments of server apparatus 103 may include web pages, scripts and other website elements which implement the sorts of integrated techniques for knowledge identification and management depicted in FIG. 2, as stored in the causal identification and management engine 109, and other engines in memory 108, such that a business may offer these to a client computer apparatus 107 via a website and network 102.

It should be noted that the same client 107, or indeed a different client from the same (or a different) organization, may upload additional procedures through the system's Knowledge Market 205, thus augmenting the repertoire of procedures available in knowledge identification and management engine 109, and/or memory 108, as well as to other clients (not shown) either for free or for a fee.

### Process to Set a Target Outcome and Population of Interest

The applicant has determined that a key aspect of effective, generalized, knowledge identification and management is defining clearly from the start of investigations the target outcome of interest, and the population of elements (voters, customers, employees, schools, farms, clinics, or indeed any set of elements) over which an organization or user wants to change some outcome(s). (The rationale for this will become apparent when the generalization engine is discussed below.) For this reason the integrated process depicted in FIG. 2 begins with process 201 to define a new outcome and population of interest. The applicant appreciates that too often organizations specify what outcome(s) they want to change but not the population of elements over which they want to effect this change. This is in part because random sampling from a population is often too costly or plain unfeasible, and because they lack processes to guide non-random sampling strategies that nevertheless generalize to a target population, as already discussed. This can result in highly inefficient and ineffective knowledge identification strategies, as study findings are limited to the population of elements that participated in the study only, and not to the population of elements most users really care about. Some embodiments build integrated checks against these problems by requiring that these fields be entered at the start of every new research process, in part so that novel generalization processes (described below) can be implemented at the research implementation and analysis stages among other (also described below).

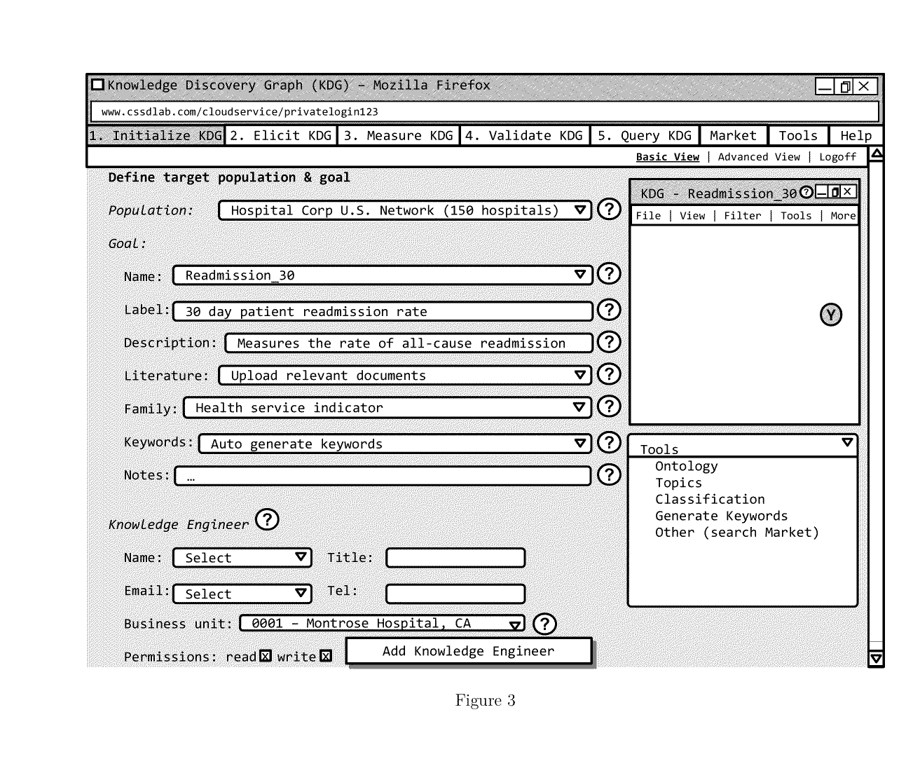

For example, with reference to FIG. 2 client 107 may instruct processor 106 to provide a web page over network 102 like the web page in FIG. 3. The user operating client 107 can input data and use said web page to operate a component of knowledge identification and management engine 109 that executes process 201 to define new outcomes of interest and a target population, to be stored in computer readable media 105. For instance, as shown in FIG. 3 the user of client 107 may be interested in reducing the 30 day patient re-admission rate in a specific network of 150 hospitals. The range of possible options in the drop down menus may have been predefined and stored in computer-readable media 105, or in another client's computer-readable media (not shown) accessed by computer apparatus 103 over network 102. This web page is exemplary and not limiting in any way, for example the web page may allow the user to enter more than one outcome of interest. It may also include options to add additional documents like manuscripts, reports, and so on that are relevant for understanding and interpreting the outcome, like what is the 30 day readmission rate, how it is defined, what are the problems in interpreting this measure, what are similar measures, terminology, idiosyncrasies about how it is defined in the industry and organization, say, and other comments or information which might be relevant for knowledge workers, and that the system can serve through network 102, and/or store as a centralized knowledge repository in computer-readable media 105. Finally, the user may enter his or her own credentials. Those skilled in the arts of software systems will appreciate how server apparatus 103 may access a client's human resource database to help the user of client 107 populate these fields, and set access permissions, among other.

### Process to Elicit Prior Causal Knowledge

Next, client 107 may access procedures in causal identification and management engine 109, designed to implement process 202 for eliciting existing knowledge about the possible direct and indirect causes of the goal in question from texts, data, or experts within, or without, the organization.

Along with many statisticians, especially those in the Bayesian tradition, the applicant appreciates that organizations would do well not to ignore whatever causal knowledge they already have before embarking into a knowledge identification process, or rolling out an intervention designed to change some outcome of interest. Such prior knowledge may be divided into two types: First, qualitative causal knowledge about causal structure (e.g. does X cause Y or, in graphical terms, should X and Y be connected by an arrow, as in X→Y in a causal diagram, or not). Second, quantitative knowledge about the magnitude of the hypothesized causal relation, such as “increasing X by one unit increases Y by two units”. Formally, this quantitative knowledge allows us to re-write the non-parametric equation Y=f_{Y}(X, ε_{Y}) represented by X→Y in more concrete terms as Y=2X+ε_{Y}, say.

Eliciting qualitative and quantitative knowledge can help an organization formulate a formal best guess of how target outcomes may be changed, with a view to using these guesses to inform the knowledge identification strategy. If experts guess that X causes Y, that it's likely to have a large effect, and that it's not very costly to manipulate compared to the other potential causes emerging from the elicitation exercise, then the organization may want to test this proposition first, and validate it using an RCT. This may help avoid wasted efforts on interventions with poor prospects of affecting the outcome, or indeed uncover interventions that may have been thought to be very effective but that in actual practice are not, again avoiding wasted effort. Intuitively, and by way of summary, the idea of this step is to simply capture all that is known about the causes of the outcome of interest into a graphical knowledge base, a combination of a Knowledge Discovery Graph, and an associated data base of structured, unstructured, or partially structured data. At a minimum this includes eliciting information about the nodes (e.g. direct and indirect causes) that ought to be included in the graph, and how they relate to each other as cause or effect (by connecting the nodes with directed edges (i.e. arrows) that describe the hypothesized relation. The results of the elicitation process (for example, completed expert surveys in one implementation) are stored in the graphical knowledge base along with the KDG summarizing the survey results. In practice the KDG can also encode other qualitative or quantitative information about the hypothesized causal structure, as discussed below.

In view of this one aspect provides a system embodied in server apparatus 103 for clients, like client 107, to share, sell, or buy such techniques over network 102 using Knowledge Market process 205 in ways that incorporate seamlessly into the integrated knowledge management strategy executed by processor 106 in accordance with instructions in memory 108, and knowledge identification and management engine 109, and that is compatible with a Knowledge Management and Discovery Graph Graphical User Interface through an application programing interface (API). Thus one aspect provides a system whereby existing elicitation engines, including text mining, data mining, and expert survey designs, can be made available to other users for free, or at a cost, from sources within or outside the organization, and in ways that integrate seamlessly into the integrated knowledge identification and management engine 109. Embodiments of the invention execute these engines in a user friendly manner on behalf of end users. Moreover, these engines often require as inputs large databases of texts, or data. These are also integrated into the system, including by purchasing access via Knowledge Market process 205, as implemented by processor 106 when executing specific instructions in knowledge identification and management engine 109 in memory 108. These structured, unstructured, or partially structured data may be stored in computer-readable media 105 in server apparatus 103, or in any other computer-readable media accessible over network 102, and accessed by processor 106 to execute techniques in accordance with the invention stored in the various engines in memory 108.

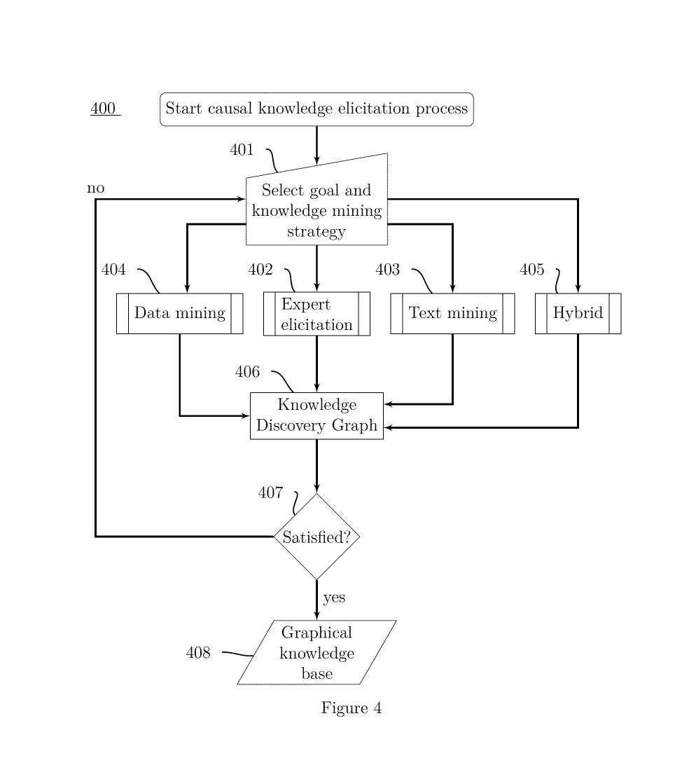

An exemplary implementation of the integrated elicitation process 202 is depicted in FIG. 4, and will now be described. The first step in integrated causal knowledge elicitation process 400, step 401, is to select the KDG and outcome for which we want to identify the causes, causes that the organization may later want to manipulate to improve said outcome. This might be the same outcome as the one entered in process 201, or a different one chosen from the same or a different Knowledge Discovery Graph, depending on the mode of use. For a new initiative it will typically be the first of these. As such, and as part of an integrated modular system, the system provides a single information management architecture. Accordingly, all mining engines available in the system, directly in memory 108, or over network 102 by processor 106 executing Knowledge Market engine 112, or indeed any engine in the system, can gain access to all the structured, unstructured, or semi-structured data about the outcome made available in step 201 of the integrated knowledge identification and management process in FIG. 2, or indeed to any data or output from any step in the process. In one implementation component-based software engineering may be used in combination with the information management architecture to ensure all engines in memory 108, or available over network 102 via the Knowledge Market, can communicate with each other, and specially with KDG objects. The modules and engines are thus modular and cohesive. What this means is that much of the information needed to guide the mining engine will already be available in the system from step 201 of the integrated knowledge identification and management process in FIG. 2. In another implementation not all engines, or modules may be required to be modular and cohesive.

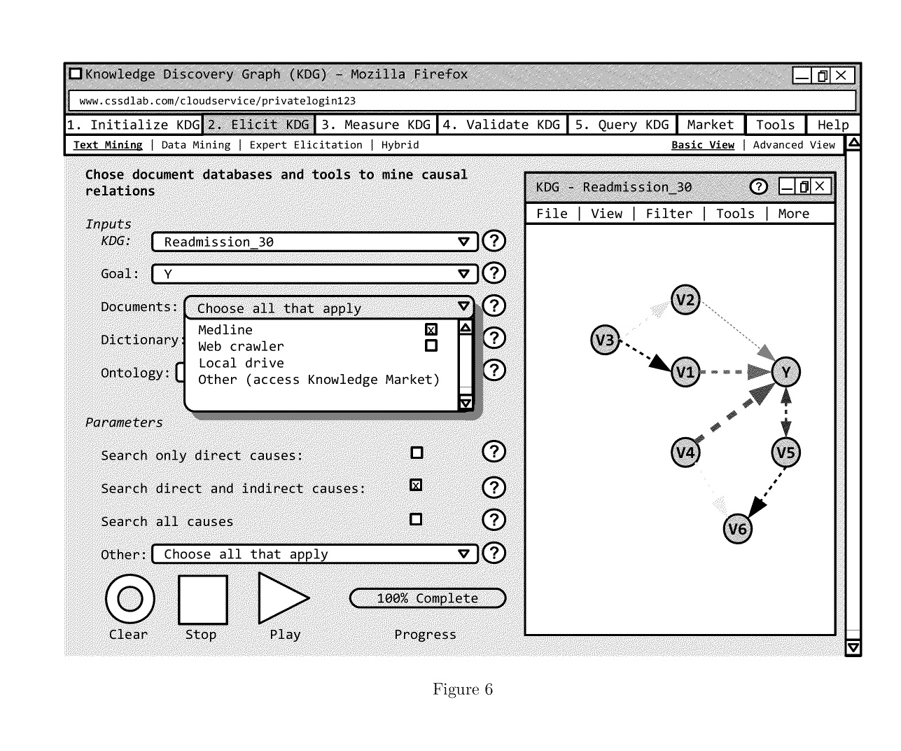

Step 401 also involves choosing the knowledge mining strategy (or strategies) to use, including mining structured, unstructured, or semi structured data using text mining processes, data mining, and surveys of expert opinions, or some combination thereof. For example, in step 401 a user may select the “30 day patient re-admission” node from an existing KDG as a goal; text mining as the mining process; and a proprietary, commercial, or freely available database of texts as inputs, or use a web crawler to retrieve relevant texts from the Internet, or from internal servers of an organization. In one use case scenario, intended for less sophisticated users, the system may only provide a default text mining engine with pre-selected defaults optimized to the typical use case scenario. For example, said default engine may instruct processor 106 to serve up a web page, like the one depicted in FIG. 6, via network 102, to client 107. The user operating client 107 can then enter additional information, and choose options about the depth, say, of the search. The displayed parameters in FIG. 6 may change depending on the inputs chosen, as required by the default engine. Once all inputs and parameters the user operating client 107 can press play in a web page like the one depicted in FIG. 6, sending instructions over network 102, to processor 106, to implement text elicitation process 403 by means of the default text mining engine in memory 108, and according to the selected inputs and options.

As a simplified illustration a simple text mining engine provided by a third party via the Knowledge Market may perform processes intended to classify a database of texts into those about 30 day patient readmission, and those not about readmission. Using the former, it can implement processes to analyze all sentences in each document, using verbs related to causality to try to parse out sentences about cause and effect from non-causal sentences. Finally, it can analyze the grammatical structure of the former to parse the cause from the effect, and commit its findings to a database, including source document, sentence, tagged structure, and data interpretable by a Knowledge Discovery Graph for display. For example, the phrase “Poor hand-washing increases 30 day readmission rates” includes a verb (increase) often associated with causal language, a cause (hand-washing), and an effect (30 day readmission). Once appropriately parsed, these data can be displayed in a knowledge graph as (hand washing)→(30 day readmission) along with supported documentation accessible by clicking on graph nodes or edges.

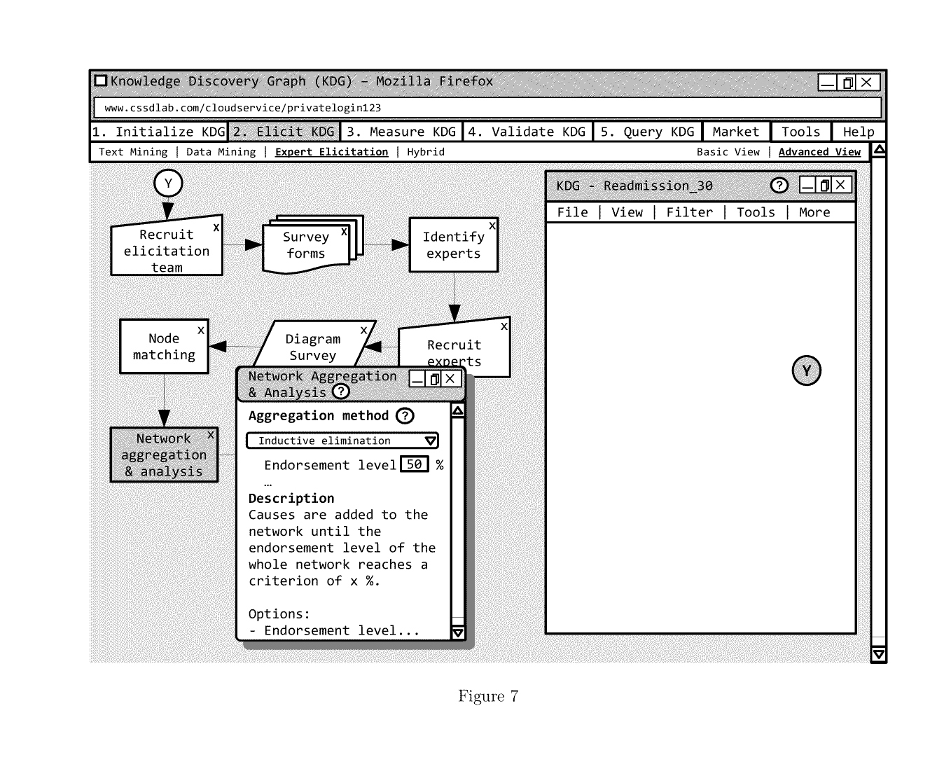

Elicitation process 400 is not limited to text mining, and includes other processes likewise implemented, including data mining process 404, expert elicitation process 402, or hybrid process 405. Nor is it limited to simple default implementation. For example, in one use case scenario an expert user skilled in the arts of expert elicitation may combine modules available in the expert elicitation engine in memory 108 (not shown) in any appropriate way, such as that depicted in FIG. 7, an exemplary web page of an advanced view of expert elicitation module. By right clicking on the web page canvass, the user operating client 107 can bring up a KDG, add a node to the canvas, as well as other modular processing components, and connect them in a process flow. This may include a module to recruit the elicitation team; for preparing survey forms, or obtaining them from computer-readable media 105, or from other sources accessible via network 102 by operating Knowledge Market engine 112; modules that identify experts from within the organization by instructing processor 106 to implement an appropriately configured text mining engine (not shown) to mine CVs stored in computer-readable media 105, organizational documents, or other information within or without the organization including social media profiles, blogs, academic journals, or other sources according to the user inputted options; modules to recruit experts including using an organizations communication systems, like email, or phone networks; modules to field a specific survey, like a diagram survey that asks recipients to draw a KDG; and so on. Right clicking on any of the modules added to the canvass brings up options for that module, such as the criteria to use in aggregating the results of a diagram survey (see FIG. 7). If more specific modules are needed, expert users could program them and load them to memory 108 or computer-readable media 105 directly or over network 102.

In step 406 processor 106 executes instructions in knowledge identification and management engine 109 to represent the output of the mining process as a KDG. Users can query the KDG in various ways, to be described below. In step 407 user have the option of implementing another pass of mining, perhaps to ask experts which of the causes identified during text mining are directly manipulable, or non manipulable (like weather, which affects retail sales but cannot normally be manipulated), and so on; or complete the knowledge mining process. In the latter case the process completes by outputting graphical knowledge base 408, including a database linked to a KDG.

In addition to eliciting causal knowledge, and as part of the integrated knowledge identification and management process in FIG. 2, client 107 has process option 204, an option to implement process 206 for eliciting cost-effectiveness. This process elicits from experts, or data, guesses about the potential cost and benefits from manipulating the causes enumerated in step 202. This process is executed by processor 106 according to instruction in causal identification and management engine 109, and user inputs and options, and is no different from the elicitation processes just described except for the different objectives. Aside form the data added to the graphical knowledge base, like the cost of shifting one cause by a unit, or a standard deviation, say, and the expected effect on the outcome, the output of this process is a list containing an optimal sequence of interventions, that takes in into account effect size, costs, and uncertainty, among other.

### Process to Abstract, Represent, and Access Information in a Graphical Knowledge Base

The output of elicitation process 202 is graphical knowledge base 203 including a knowledge database and a linked Knowledge Discovery Graph (KDG) stored in computer-readable media 105. The KDG serves two purposes. First, a KDG has its basis on well known causal diagrams. These are graphical mathematical objects that capture qualitative aspects of structural equation models describing the relation between the posited causes and their effects. For example, suppose experts suggested during elicitation process 202 that the goal of interest, call it Y, is likely caused by X, and some other unknown or unobserved causes ε_{Y}, and that X is caused by Z, and some other unknown or unobserved causes ε_{X}, such that X is a direct cause of Y and Z an indirect cause of Y (via X). We can then formulate these hypothesized causal relations in general mathematical terms as the structural equation system:

Y=F_{Y}(X,ε_{Y}); (1)

X=F_{X}(Z,ε_{X}) (2)

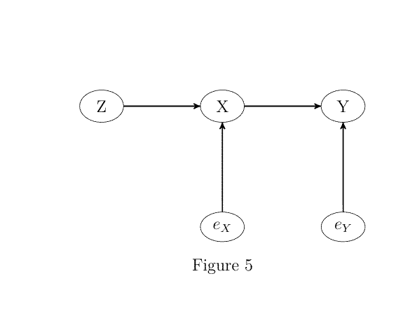

or—equivalently—as the causal diagram depicted in FIG. 5.

In FIG. 5 the connection of nodes X and Y by a directed edge →, as in X→Y, signifies that “X causes Y” and so on. Such graphs serve as an inference engine for causal identification, one that is much more user friendly than the equivalent mathematical model. Intuitively, for most purposes there is no need to work with mathematical equations as the causal diagram already captures all relevant causal relations. For example, those with some skill in causal diagrams will appreciate that if we were somehow to hold X fixed while changing Z, this will have no effect on Y, as the effect of Z on Y is fully mediated by X, and holding X fixed blocks the effect of X on Y. However, had we drawn a direct arrow from Z to Y, or, equivalently, added variable Z as an argument in Equation 1, then we would expect Z to have an effect on Y even if X were held fixed. Alternatively, if we were given data on X, Y, and Z and we believed that the true causal structure generating these data was as drawn above, then we can test a number of implications to test whether this is indeed the case. For example, we could test that all variables are correlated, and that the correlation between Z and Y is zero within levels of X (e.g. holding X constant). These are just abstract illustrations of how causal diagrams may be useful in causal reasoning and inference, and in representing, and communicating causal knowledge to a broader audience, or user base, especially one challenged by math.

The second purpose of the KDG is to serve as a graphical user interface to the knowledge database stored in computer-readable media 105 or memory 108, as well as an abstraction engine for the current state of causal knowledge in the system; providing, among other, a snapshot of the current state of causal knowledge in the knowledge identification and management system. In one implementation, when client 107 request processor 106 to serve a web page that displays a specific KDG, knowledge identification and management engine 109 may instruct processor 106 to execute instructions that determine whether any data from RCTs carried out by an organization exist in computer-readable media 105, and whether these are linked to any particular edge in the KDG. For example, in the case where no experiments have yet been carried out at all, knowledge identification and management engine 109 may instruct processor 106 to represent the graph edges (e.g. the arrows) using broken edges (- - →) when serving the requested KDG web page to client 107 over network 102; to signify these causal relations have been established from an elicitation exercise but have not yet been confirmed by experiment. The latter may be represented by continuous edges. By a similar procedure the degree of confidence from data, experts, or texts mining, as measured for example by a probability measure that the edge exists in Nature, can be represented by the color scale, with unlikely causal relations represented in light gray and almost certain ones in black. Similarly the effect strength of a cause on its effect may be represented by the thickness of the edge. The face color of the node may be white if data corresponding to that cause or effect exists in the system, and dark gray if no measures are available. Similarly directly manipulable causes may have green rings around them, amber if indirectly manipulable, and red if non-manipulable. And so on.

In addition to explicit color coding, all elements in a KDG are clickable to reveal other information stored in the knowledge database stored in computer-readable media 105 or memory 108. For example in one implementation clicking on an edge in a KDG element (for example, the one displayed in FIG. 6) sends instructions from client 107 over network 102 to processor 106, to execute instructions in knowledge identification and management engine 109, to access computer-readable media 105 and process the information therein stored to serve client 107, over network 102 a web-based window with information pertinent to that edge. This may include how that edge was generated, be it by text mining, experiment or some other method available in knowledge identification and management engine 109, what processes, data sources (and date accessed), experimental knowledge identification studies (and associated materials and methods), and/or whichever other options and inputs were selected by a user to generate the edge in question. This serves as an audit and/or replication trail. In addition, the web page may also provide data about the expected (if from a mining engine), or actual (if from an RCT) effect of the source of the edge on the end of the edge (so called parent and child). This may be displayed as a table, in suitable statistical graphics, or as a structural equation. In a similar fashion, any node can also be clicked on to access data pertinent to that node, including definitions, labels, comments, relevant literature in the knowledge management and discover system, and any actual data measurements, including associated measurement instruments (e.g. surveys, biometric devices, or any other measurement instrument). These sorts of information are exemplary and in no way limiting: The system may display more or less information in any suitable format, including tables, statistical graphics, or graphs, among other.

### Process to Quantify a Conceptual Causal Model, and Make it Amenable to Empirical Analysis

Step 207 of the integrated causal knowledge identification and management process depicted in FIG. 2, involves the quantification of a KDG, that is associating measurements, or measuring instruments with which such measurements may be obtained with each node in a KDG, or at least with those nodes of immediate interest. For example, in some implementation a graphical knowledge base generated by text mining in step 202 may only contain qualitative information of the sort (hand washing)→(30 day readmission), along with supporting documentation (e.g. a sample of sentences, tags, and documents showing how this conclusion was arrived at, see previous subsection for more details). Specifically, it may be lacking actual quantitative measures of hand washing behaviour, and of 30 day readmission rates across the target population of hospitals or clinics, say. Obtaining measures, and/or measurement instruments for some or all nodes in a KDG, and other related data (such as data on possible causes or effects of the causes of the outcome of interest), can be useful for designing RCTs that are both, as informative as possible about an effect of interest for any given sample size, and that generalize over the population of interest, as explained below. This means we can deploy smaller, and cheaper experiments that nevertheless are informative for a broad population, dramatically boosting return on investment.

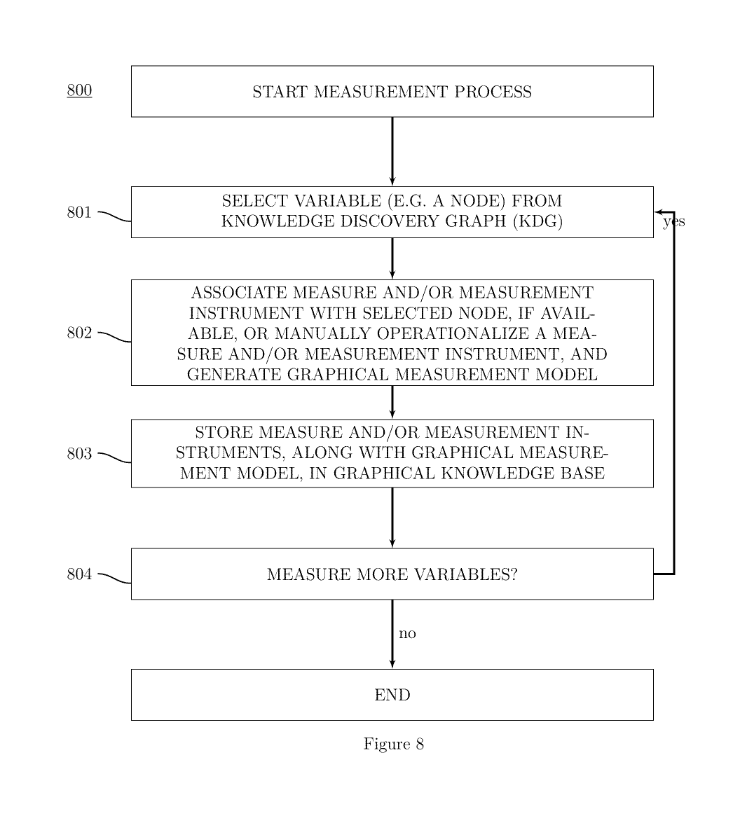

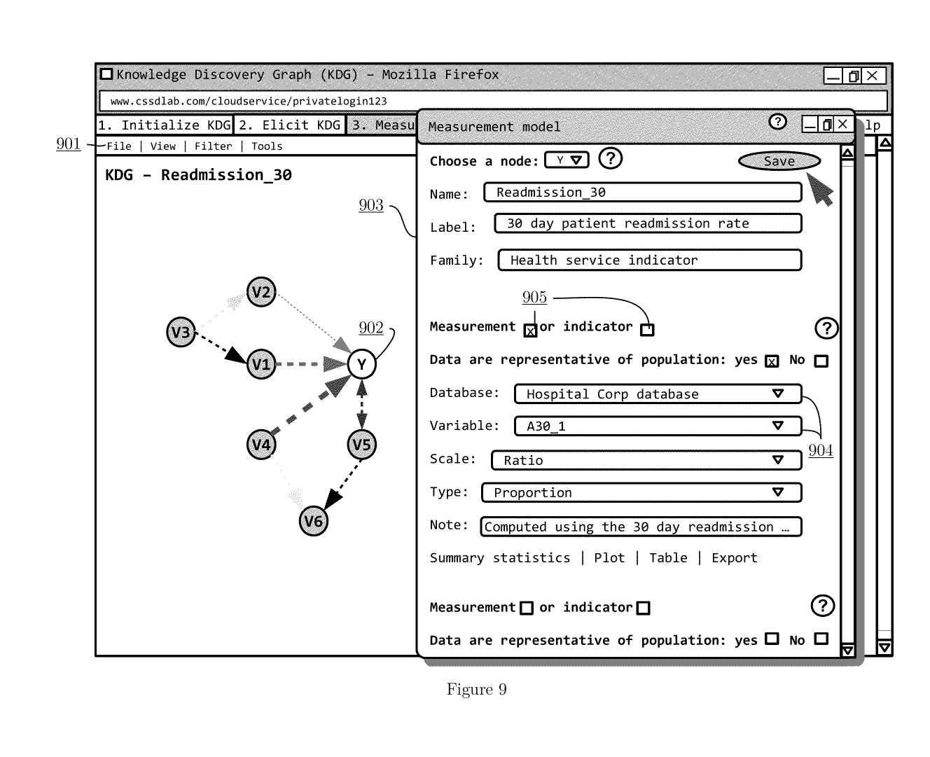

An exemplary implementation of integrated measurement process 207 is depicted in FIG. 8, and will now be described. The first step in integrated measurement process 800, step 801, is to select a KDG and a node from that KDG that is lacking some associated measurements, or measurement instruments (or whose measures or measurement instruments we want to edit). To accomplish this processor 106 in server apparatus 103 may serve a web page to client 107 over network 102, an exemplary version of which is illustrated in FIG. 9. For example, the user of client 107 can use some human computer interface, like a computer mouse, to click on file option 901, open up a KDG stored in computer-readable media in client 107, or in computer-readable media 105 in server apparatus 103, or indeed from any other computer-readable media available over network 102, including the Internet and the Knowledge Market operated by server apparatus 103. Next the user can right click on a node from that KDG, like node 902 to bring up window 903 with measurement options. By operating drop down menus 904 the user of client 107 can select any database, and variable therein, stored in computer-readable media in client 107, or in computer-readable media 105 in server apparatus 103, or indeed from any other computer-readable media available over network 102, including the Internet, and append it to the relevant node.

In an illustrative implementation such measures come in two types: measures or indicators, as indicated in selection boxes 905. A measure is a direct measurement of the relevant node. For example, if the outcome of interest in node 902 where the yield of a population of potato farms, then that can be measured directly as tonnes of potatoes per hectare year, say. Yet other outcomes are seldom directly observable. As an illustration most psychological states, like depression, are latent. Instead, psychologists have to rely on indirect measures, or indicators, of the latent concept. At times several indicators may be used for measuring a latent concept, or node. Graphically, the difference between measurements and indicators is that measurements do not add any nodes to the graph, whereas indicators do. For example, if node 902 represents the 30 day readmission rate across a network of hospitals, this is something that can typically be measured directly. So all that happens is that node 902 is linked to the selected data element, as explained above. However, if node 902 refers to something like employee satisfaction, which is typically not directly observable, we might use a number of indicators (or proxies) to measure it, like the results of two separate surveys. These indicators are added as additional nodes to the KDG, and linked to latent node 902 using directed edges. For example, if a latent node Y is measured by indicators X and Z, then we might represent this in the KDG by adding directed edges as follows X←- -Y- - →Z. Indeed, indicators may also be linked to other nodes in the KDG to capture the idea that the indicator may be a proxy for more than one variable in the KDG (and thus an imperfect measurement of any single node).

At times desired measures are so specific they are not generally available, and measurement instruments and measures have to be put together by the user as part of the knowledge identification and management process. For example, the user may want to create a very specific survey to be filled by participants in the RCT after the intervention has taken place, and used to measure its effect. No matter. In these cases, a user operating client 107 has the option of instructing processor 106 over network 102 to serve web pages, scripts and other website elements necessary to design a measurement instrument, like a survey. Engines for designing measurement instruments may also be obtained via the Knowledge Market. For very specific circumstance, like using dedicated biometric devices, radio frequency identifiers (RFID), GPS devices, or other apparatuses useful as measurement instruments for some outcome of interest, a specific engine can be programmed and loaded to memory 108 directly, or via network 102 and the knowledge market module (not shown) in knowledge identification and management engine 109. Those familiar with the arts of computer programming can appreciate how, by exploiting a single information architecture, or modular software, or an application programing interface, or any combination thereof such dedicated measurement engine may operate with the rest of integrated causal knowledge identification and management system in the same way as knowledge market engines 112. However, in most cases users will likely find what measurements and measurement instruments they need in specific models of knowledge identification and management engine 109, or via the Knowledge Market, thus saving significantly on development costs.

### Process to Validate Aspects of a KDG Using Randomized Controlled Experiments (RCTs)

An elicited KDG only represents best guesses form observational data mining, text mining, or experts. Even if some texts, like academic journal articles, may be based on previous experiments, typically these have not been designed with generalizability in mind so whether an intervention will work, or not, in the target population of interest is a guess. Besides, often the specifics of the interventions being considered by an organization differ from those reported in previous studies, so previous findings may not be easily extrapolated. One option is to run a cheap pilot test to see whether an implied causal relation in the KDG will hold if an intervention were to be applied to the target population. If so resources can be deployed to deliver the intervention to the whole target population, otherwise those same resources can be saved and other pilots carried out until a cost effective intervention is found.

To validate aspects of a KDG using randomized controlled trials the integrated knowledge identification and management system implements three processes: Study design process 208, study implementation process 210, and analysis and update process 211. These will now be described in detail.

### Study Design Process 208

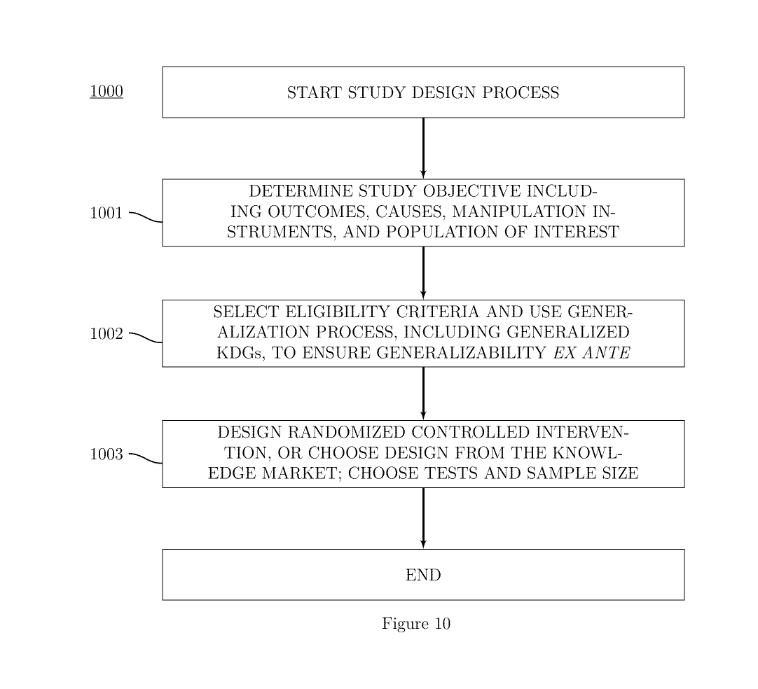

An exemplary implementation of integrated study design process 208 is depicted in FIG. 10. The first step in integrated design process 1000, step 1001, is to select the outcomes of interest, namely those an organization may want to change down the road; and the target population, namely the population of elements over which the organization would like to intervene, and for which it wants the study findings to be applicable. Often the outcome and the population of interest will be the same as those selected when initializing the KDG in process 201, but they need not be. In addition to specifying an outcome and a population of interest it is also necessary to specify the hypothetical cause whose effectiveness we want to test and validate, or, if the cause is not directly manipulable, the manipulation instrument, if any, used to influence it. For example, suppose a health insurer wanted to know whether fitness reduces some cancer. Typically a health insurer cannot manipulate policy holder's fitness directly: It cannot force people onto the treadmill. What it can do is randomize an “instrument”, like information and/or pecuniary incentives encouraging people to achieve a certain level of fitness. To the extent that the instrument succeeds in encouraging people to get onto the treadmill, it is a way for the insurer to indirectly manipulate the fitness of the insured population. If the RCT reveals that cancer is reduced amongst those encouraged by the instrument, then in future research the insurer may want to investigate more effective ways of manipulating the fitness of the insured population.

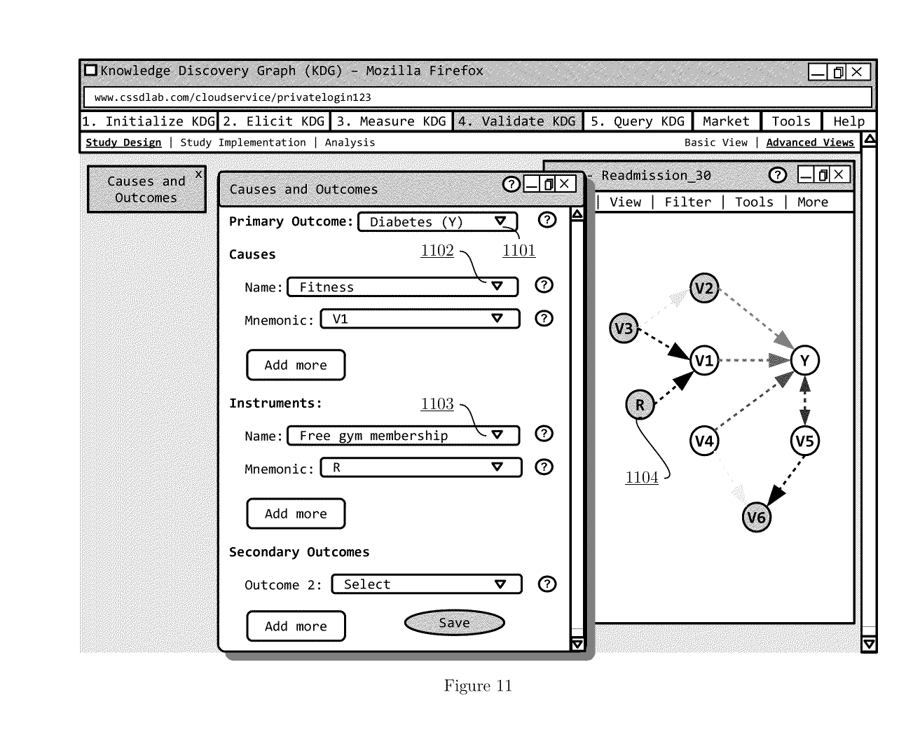

To implement this aspect of study design process 208 processor 106 in server apparatus 103 may serve a web page, scripts, and other web elements to client 107 over network 102, an exemplary version of which is illustrated in FIG. 11. In an exemplary implementation, the user of client 107 can use some human computer interface, like a computer mouse, to select an outcome from drop down menu 1101 displaying options stored in computer-readable in client 107, or in computer-readable media 105 in server apparatus 103, or indeed from any other computer-readable media available over network 102, including the Internet. The user may also create a new outcome to add to the KDG and graphical knowledge base. Said user can also select the cause of interest using drop down menu 1102, selecting a variable from the knowledge database created in step 207, or indeed by adding new data and nodes to the graphical knowledge base. If the cause is not directly manipulable, the user operating client 107 can use drop down menu 1103 to add the instrument to the knowledge base. On the basis of these inputs processor 106 may instruct knowledge management engine 109 to add node 1104 to the KDG, along with any other relevant information entered.

The second step in integrated design process 1000, step 1002, is to select eligibility criteria, and use generalization engine 110 to ensure the proposed study findings will provide estimates that are “approximately unbiased and statistically consistent estimates” for the target population. Intuitively, the goal is to ensure ex ante (i.e. at the design stage, before the study is implemented) that the estimated causal effects from the pilot study provide a good approximation of what might happen where the intervention to be carried out over the full population of interest. This step is described in greater detail below.

The third step in integrated design process 1000, step 1003, is to design a randomized controlled intervention. In an exemplary implementation this includes defining the number of intervention groups; the allocation ratio of elements to each group, and whether this allocation is done in clusters; the time frame over which outcomes will be measured; what tests and/or estimators will be used to judge the success of the intervention; and the sample size and blocking strategy, if any, to ensure the test can be informative (e.g. technically has enough “power”). This also includes crafting plans to deal with attrition using attrition engine 111.

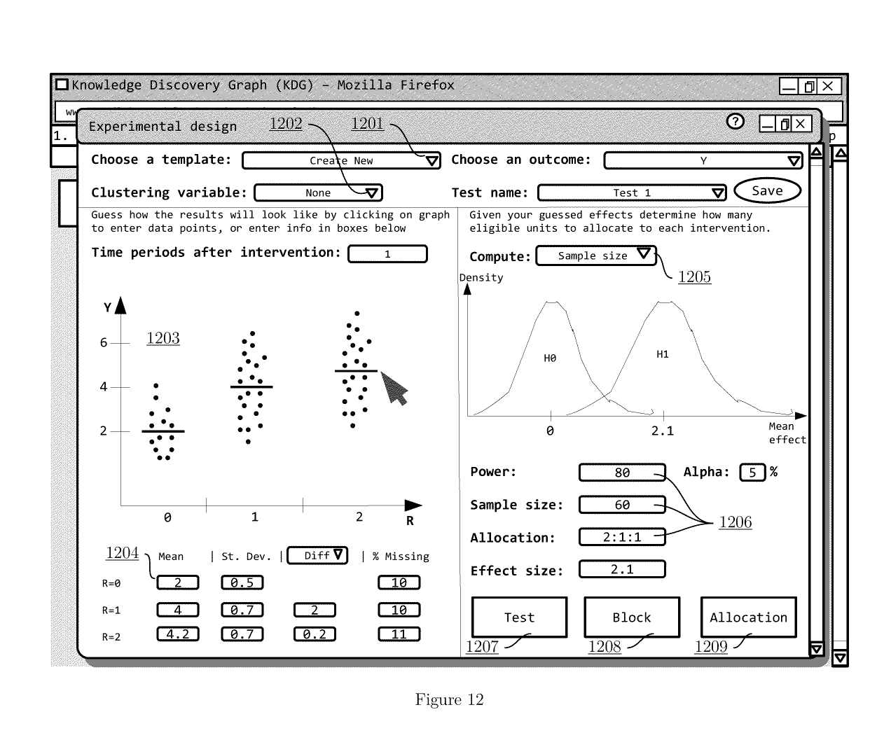

To implement this aspect of study design process 208 processor 106 in server apparatus 103 may serve a web page, scripts, and other web elements to client 107 over network 102, an exemplary version of which is illustrated in FIG. 12. In an exemplary implementation, the user of client 107 can use some human computer interface, like a computer mouse, and drop menu 1201 to create a new design or, more conveniently, select a pre-existing experimental design template, one stored in computer-readable media in client 107, or in computer-readable media 105 in server apparatus 103, or indeed from any other computer-readable media available over network 102, including the Internet, or available through the Knowledge Market. For example, the simplest of templates is the parallel design in which elements selected to participate in the RCT are allocated to one or more groups, each group being allocated a different intervention. The interventions will include the intervention of interest, at one or more doses, as well as one or more control interventions, such as a placebo. Other exemplary designs include, but are not limited to, factorial and crossover designs, as well as templates designed for specific business, or organizational purposes. The latter would be particularly helpful for user not well versed in the arts of experimental design.

Depending on the template chosen the web page depicted in FIG. 12 may display different input fields, in order for the user to complete the template and for processor 106 to perform necessary calculations for the experimental design, like determining the sample size, and the optimal allocation ratio. In an exemplary implementation, this may include web element 1202 to determine whether the treatment allocation is clustered, and what is the clustering variable. It may also include web element 1203 providing a graph of what outcome data might look like after the RCT is complete. The idea is for the user to graph the hypothetical results by creating fake data, and, specifically, by adding dots to web element 1203. In this way the user can give a sense of the distribution of outcomes across experimental condition (in the cases shown these are conditions R=0 through R=2, where zero might be the control condition, and R=1 and R=2 may represent different dosages of the treatment). Processor 106 can the use this information to compute means and standard deviations, and other quantities of interest, like the difference between treatment and control conditions as displayed in web elements 1204. Alternatively, the user may enter these data directly in fields 1204. Intuitively, this exercise is needed because, if we are going to implement a study to find a causal effect, or, by analogy, the proverbial needle in a haystack, then it can be useful to guess how big the needle is likely to be. The larger the needle, the fewer resources we might need to commit to finding it, or, in the case of RCTs, the larger the expected effect of the intervention, the smaller the sample size that may be needed, other things equal.

Having determined the sample size, the user can use web element 1205 and elements 1206 and 1209 to input a desired Type I error rate (typically set at an alpha of 5 percent), chose a level of desired power, and then instruct processor 106 to solve for the sample size, and the optimal allocation ratio. Or, alternatively, enter an available sample size and solve for the power, and any logical combination thereof. To perform these calculations the use also needs to select a desired test, for example a t-test, and the specific quantity of interest that will be tested. These options can be accessed using web element 1207. Also, another way of increasing power is to use matching or blocking strategies. These are statistical terms of art that involve dividing the elements selected to participate in the RCT into similar groups along relevant dimensions, and specially dimensions suspected of being causes of the outcome, or proxies for said causes. By performing the experiment within groups thus defined we are likely to get more precise estimates for any sample size, meaning that in some cases, the sample size can be reduced while maintaining power. Using web element 1208 the user can instruct processor 106 to execute third-party blocking modules in knowledge identification and management engine 109 that automatically search for optimal blocking strategies, or the user can enter one blocking strategy manually.

### Study Implementation Process 210

Unlike predictive analytics, or other passive learning strategies that take observed data and use those data to make predictions, knowledge mining and identification requires users to actually intervene in the world; i.e. to change something about the way an organization operates, say, and use that as an opportunity to tease out causal effects, learn how the world works, and optimize performance. And like any other organizational activity such interventions need planning and management. Yet in the context of knowledge management and identification it is very important that implementation activities be closely integrated with the experimental design and analysis. Poor implementation, or implementation not in accordance with the experimental design and protocol, can render the whole RCT uninformative, wasting effort and resources.

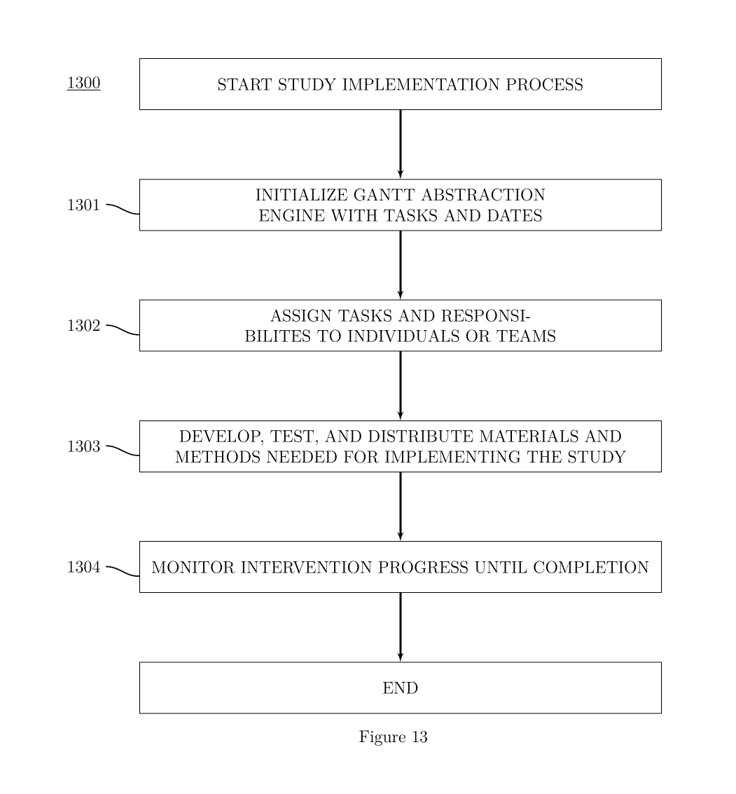

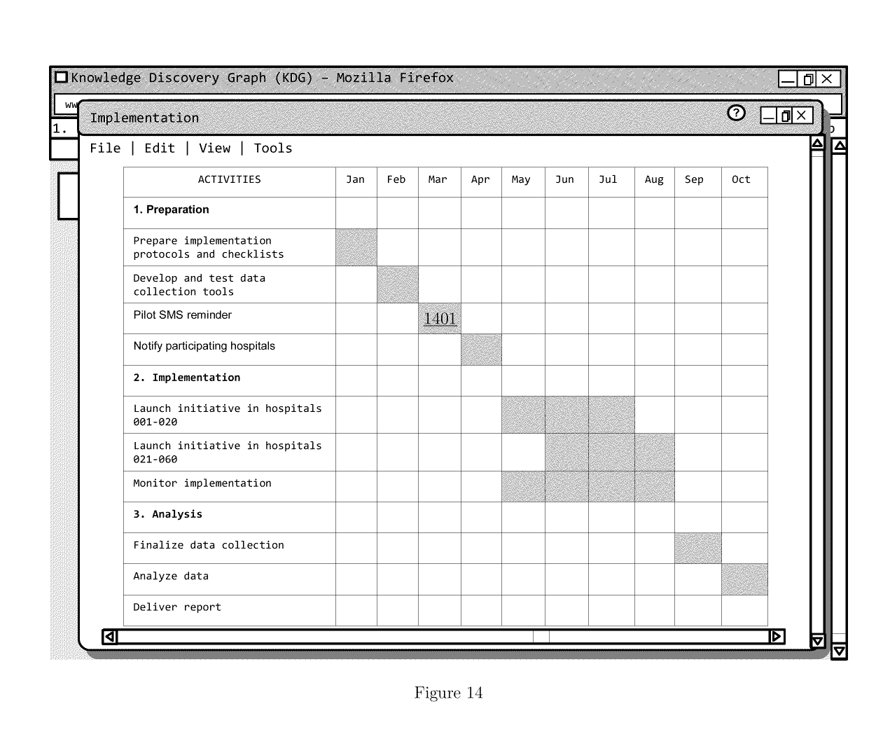

After implementing integrated design process 208 the integrated knowledge identification and management system in FIG. 2 provides the user with the option of implementing the integrated study implementation process 210. An exemplary implementation of integrated study design process 210 is depicted in FIG. 13, which will now be described. The first step in the integrated study implementation process 1300, step 1301, is to initialize the Gantt abstraction engine. As with the KDG the Gantt abstraction engine serves two purposes: First, as a Gantt chart, to indicate activities and times when these activities should be implemented. Second, as a graphical user interface and abstraction engine for the planning, and management of implementations. In one exemplary instance of this process, processor 106 in server apparatus 103 may serve a web page, scripts, and other web elements to client 107 over network 102, an exemplary version of which is illustrated in FIG. 14. The page provides options for the user to create a Gantt chart listing implementation activities in the rows, and planned dates in the columns. Such charts may be created anew, or the user can use templates optimized for standard organizational knowledge identification activities. Such templates may be stored in computer-readable media in client 107, or in computer-readable media 105 in server apparatus 103, or indeed from any other computer-readable media available over network 102, including the Internet, or available through the Knowledge Market.

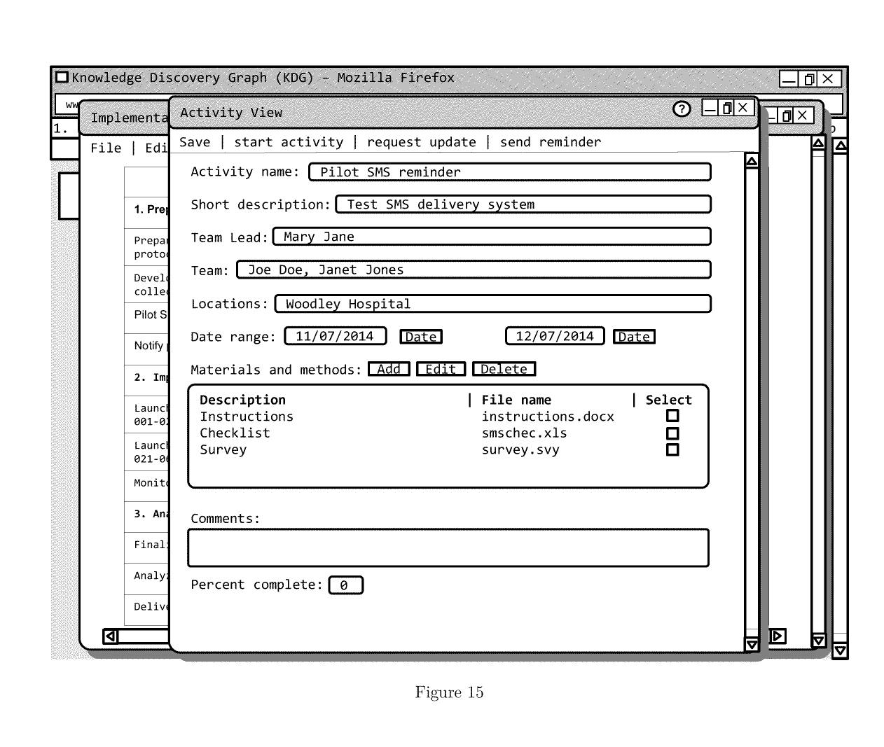

The second step in integrated study implementation process 1300, step 1302, is to assign tasks and responsibilities to individuals or teams. In one exemplary implementation the user of client 107 can click on any cell, such as cell 1401 to enter or view additional data elements related to an activity. For example, processor 106, executing instructions from knowledge identification and management engine 109 may provide the user operating client 107 with a web element over network 102 like the one depicted in FIG. 15. Such a web element provides options to designate a team lead responsible for the activity, team members, locations where the activity is to be carried out, and dates for implementation activities. Those skilled in the arts of computer programing would appreciate how calendar activities may be exported to, or imported from, user's or organizational calendars, and how reminders may be added.

The third step in integrated study implementation process 1300, step 1303, is to provide the individuals or teams responsible for implementation tasks with the requisite materials and methods, including instructions, checklists, and other equipment. As in the previous step this may be accomplished also by a web element like the one depicted in FIG. 15, which provides options to add material and methods necessary for implementation activities. Such a web element can also be used to enter progress in the relevant activity. Such progress can be displayed in the Gantt chart using a variety of graphical options, such as shading activity cells according to percent complete. This completes the fourth step, step 1304, in integrated study implementation process 1300

### Analysis and Update Process 211

The analysis of experimental results may take into account the experimental design, otherwise results may be grossly misleading (as might be the case if the intervention was clustered but the clustering is ignored in the analysis). Having an integrated system ensures the design and analysis are in sync. In addition, the analysis needs to take into account any unplanned missing data in the outcome measure, and the generalizability of the pilot results to the target population of interest. The best way to accomplish these is to ex-ante include generalization into the design of the RCT, along with safeguards for attrition, as mentioned above, which provides yet another reason for an integrated system (these will be described in much more detail below). Failing this, the generalization and attrition processes can also be used ex-post. Their use will be explained in the relevant sections below, here an overview is provided. Once the user is satisfied with the analysis, she can commit it to the graphical knowledge base, updating the knowledge graph, and associating the update with the experimental data generated by the study; data regarding the design and implementation; and data on other practical details of the study implementation. The latter two data aspects serve as an audit trail.

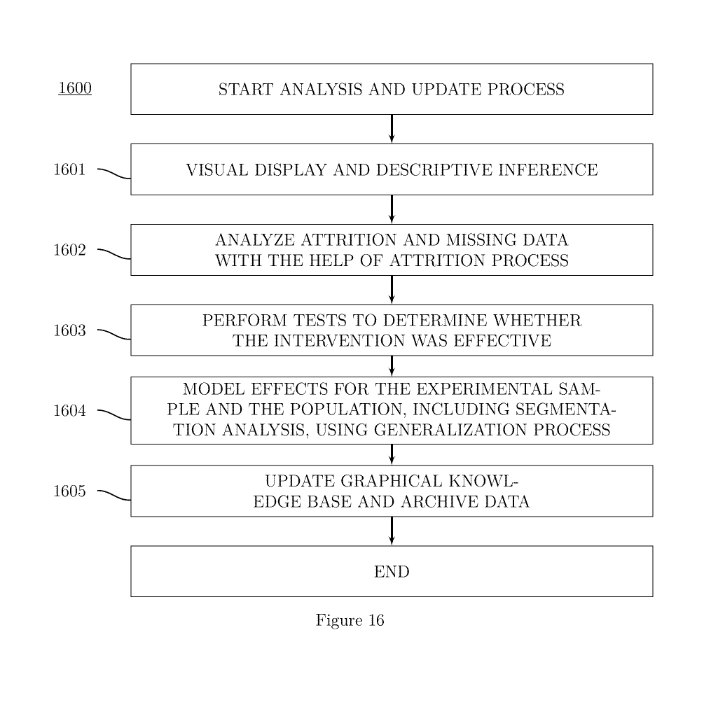

After implementing integrated implementation process 210 the integrated causal knowledge identification and management system in FIG. 2 provides the user with the option of implementing integrated study analysis and update process 211. An exemplary implementation of this process, i.e. process 211, is depicted in FIG. 16, which will now be described. The first step in the integrated study analysis and update process 1600, step 1601, is to plot histograms, box plots, scatter, or density plots, as befits the type of measurement, for the outcomes of interest across treatment arms. As part of the integrated knowledge identification and management process, this will often include the same display as was used in design step 1003, an exemplary illustration of which was provided in FIG. 12. Depending on the underlying design, the displays may be adjusted for clustering, blocking, and so on. Measures of central tendency and dispersion, like the mean and the standard deviation may also be provided by treatment group.

A second step in integrated study analysis and update process 1600, step 1602, is to determine whether missing data on the outcome of interest, if any, is likely to be problematic, and if so explore possible solutions, or whether the missing data is unproblematic, or can be dealt with using the provided attrition processes. This will be explained in sections below.

A third step in integrated study analysis and update process 1600, step 1603, is to test whether the intervention was effective according to the criteria specified in integrated design process 1003. In one exemplary implementation this may include testing the sharp null of no effect on any element against the alternative of some effect (e.g. change in location, scale, or other distribution parameter describing the outcomes). These tests can tell us whether the treatment has an effect, but they are silent as to the magnitude and variability of the effect.

To get a sense of the magnitude of the effect—and its uncertainty—a fourth step of integrated study analysis and update process 1600, step 1604, involves generating estimates of causal effects and confidence intervals, assuming non-interference and a model of causal effects like linear regression, hierarchical models, non-parametric splines, and any other model module available in knowledge identification and management engine 109, or via the Knowledge Market. The model is checked for fit by performing model diagnostics including, but not limited to, testing normality of residuals, homoscedasticity, plotting residuals against predicted outcomes, cross validation, and comparing the actual experimental data to fake data generated from the estimated model. An important aspect of modeling is segmentation analysis, or studying how the effect of the intervention varies by characteristics of the elements as measured prior to the intervention. For example, is the effect larger for patients with at least high-school education compared to those with less than high school education? Does it vary by age? And so on. As discussed in the section below on generalizability, such analyses, though typically correct for those elements that participated in the experiment, can over- or under-estimate the effect on the population of interest. For example, it might be that older people benefited the most in the RCT, but benefit the least in the population outside the RCT, which can easily result in suboptimal business decisions. In an integrated system this possibility can be checked by the generalizability process, which, as is explained below, can be used to detect whether a particular segmentation analysis can be extrapolated with confidence to the population of interest or not.

A final step in integrated study analysis and update process 1600, step 1605, is to update the graphical knowledge base and archive the data. Once the user operating client 107 is satisfied with the conclusions and the model exercise, he can accept these results (or nor) and instruct processor 106 to execute instructions in knowledge identification and management engine 109 with a view to updating the KDG by, for example, replacing the broken arrow connecting the intervention cause to its effect with a continuous one, to indicate that the edge in question has been validated by an RCT. The instruction also instruct processor 106 to update the graphical knowledge base associated with the KDG with the experimental results, models, and all data related to the design and implementation of the study.

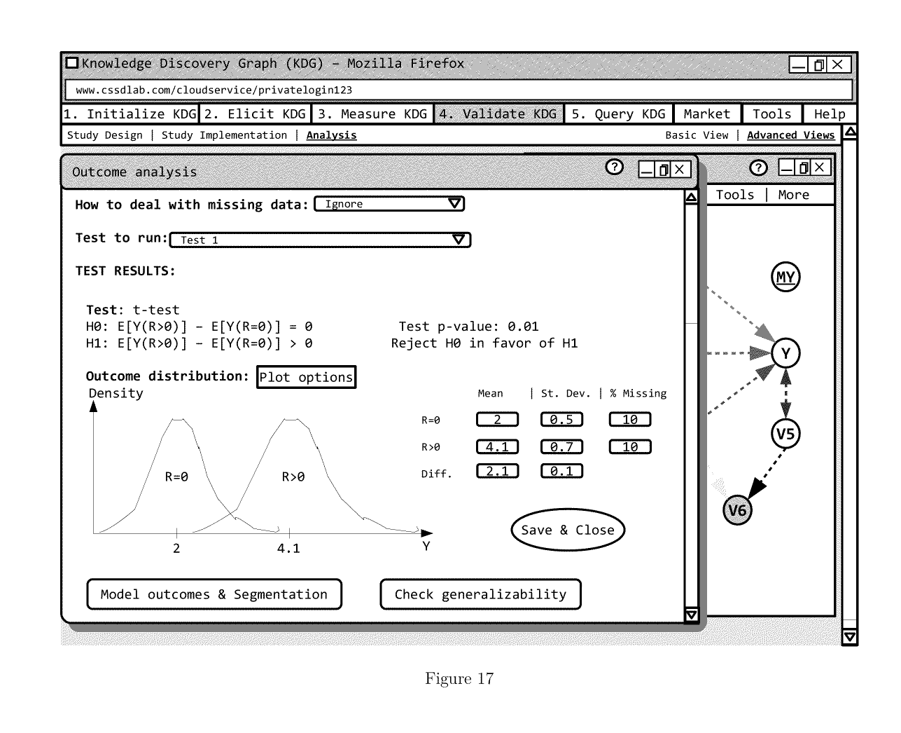

In one exemplary instance of processes 1601, 1602, 1603, 1604, and 1605 processor 106 in server apparatus 103 may serve a web page, scripts, and other web elements to client 107 over network 102, an exemplary version of which is illustrated in FIG. 17.

### Process to Query Graphical Knowledge Databases

Over time an organization may conduct any number of studies to test various aspects of a KDG; perhaps in the search of more effective instruments, or other causes that are effective in changing the outcome of interest, and as part of a process of continuous improvement in organizational performance. An organization may also create any number of KDGs to investigate other aspects of relevance for organizational performance. As already mentioned all the data generated in the research process, from the elicitation, to the study results, an including data on the design and implementation of all the studies, is maintained in a graphical knowledge base. These data can be used to check the integrity of study findings, and to perform simulations for evidence-based decision making. Finally, aspects of these data can be used in customized reports. One benefit of an integrated knowledge management system is having all these data available and cross-linked in a single database, as opposed to distributed in various desktops computers across an organization, where data is often erased as personnel move.

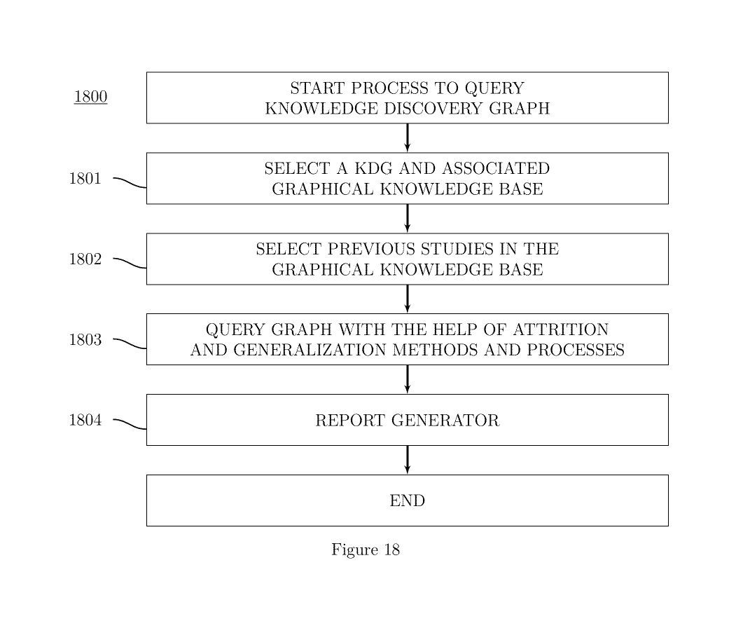

At any point in the integrated knowledge identification and management process depicted in FIG. 2 the user can implement integrated process 212 to query a graphical knowledge base (assuming one already exists). An exemplary implementation of this process, i.e. process 212, is depicted in FIG. 18, which will now be described. The first step in integrated process 1800 to query existing graphical knowledge bases, step 1801, is to select a KDG of interest and associated graphical knowledge base. Moreover, the user may also link together any number of KDGs that are connected by overlapping nodes (i.e. have variables in common), being careful to adequately combine their respective populations of interest. The second step, step 1802, is to select studies of interest associated with the selected KDGs. As mentioned above each KDG is associated with a graphical knowledge base. That knowledge base may contain any number of studies associated with the KDG, like studies investigating the effectiveness of various instruments, or of various causes, or some combination thereof. Depending on the user's objective he may be interested in one, some, or all the studies associated with the KDGs. The third step in integrated process 1800 to query existing graphical knowledge bases, step 1803, is to query the KDG with the help of the attrition, and generalization methods described below. An exemplary illustration of such queries include, but is not limited to: (i) Estimating what would be the effect on the target population from the findings in a pilot study; (ii) Estimating what would be the effect in a sub-sample from the population; (iii) Segmentation analyses that try to estimate what would be the effect within segments of the target population given the findings for those segments in the pilot study; (iv) all the aforementioned analyses in cases where there are missing outcome, or attrition. These processes, and their implementation in the integrated knowledge identification and management system, will be explained in the sections below. The fourth step in integrated process 1800 to query existing graphical knowledge bases, step 1804, is to export all, or only certain aspects, of the graphical knowledge database and associated queries to other file systems; or to share the data with other users; or to provide aspects of the analysis to users of the Knowledge Market; or to generate reports, including using templates available in the Knowledge Market.

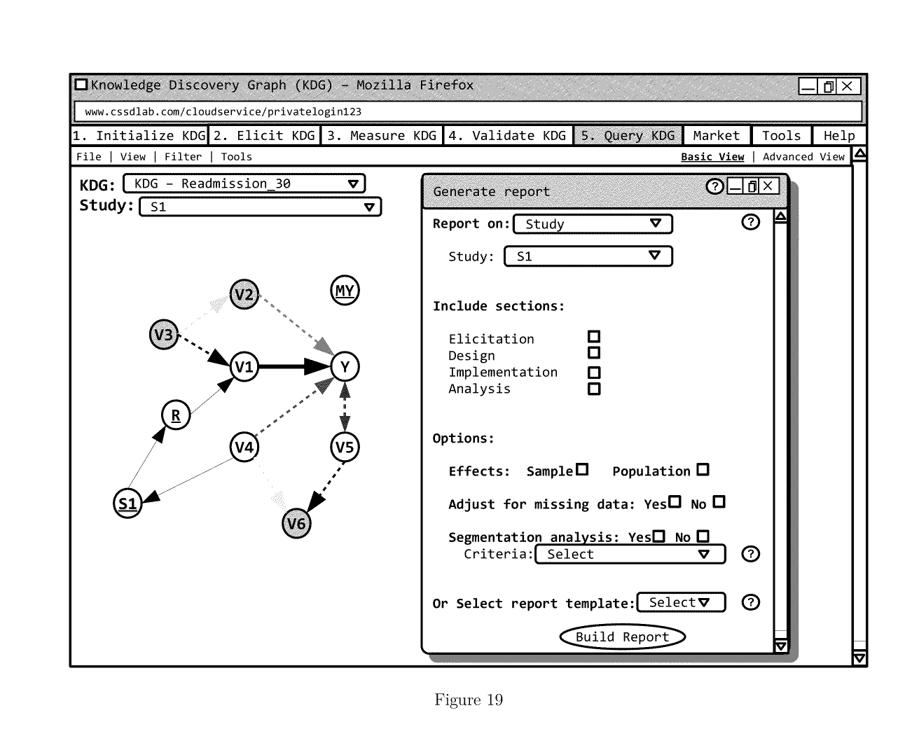

In one exemplary instance of processes 1801, 1802, 1803, and 1804 processor 106 in server apparatus 103 may serve a web page, scripts, and other web elements to client 107 over network 102, an exemplary version of which is illustrated in FIG. 19.

### System and Method for Diagnosing and Remedying Problematic Attrition in RCTs

### Understanding, Diagnosing, and Remedying Problematic Attrition

### Understanding What Causes Problematic Attrition

Attrition is the first Achilles' Heel of the randomized experiment: It is fairly common, and it can completely unravel the benefits of randomization. No matter. Using the systems and methods disclosed herein it is possible to detect problematic attrition, and to search for covariate conditioning strategies that may render problematic attrition unproblematic under standard experimental assumptions of randomization, excludability, and non-interference—even if the true underlying causal diagram generating the outcome and the missing data is unknown. Formally, all we are assuming is that the underlying causal diagram belongs to the class of simple attrition directed acyclic graphs, or SADAGs, which are defined as follows:

### Definition 1 (SADAG).

A SADAG is a causal diagram where: (i) observed outcomes 0 are determined by the following equation (an exclusion restriction):

$$O = \{ \begin{matrix}Y , & if R = 0 \\ Missing , & if R = 1 ,\end{matrix} \qquad ( 3 )$$

where O is the outcome observed by the researcher, Y is the latent outcome observed by Nature or elements participating in the experiment; (ii) latent outcomes Y for any element i are independent of treatment assigned to any other element j, j≠i (non-interference); (iii) a single treatment Z taking two or more values is applied in a randomized fashion (no arrows can point into Z, a randomization assumption); and (iv) attrition R does not cause Y (this later assumption is not strictly necessary but it is reasonable, and helps simplify the exposition and make sense).

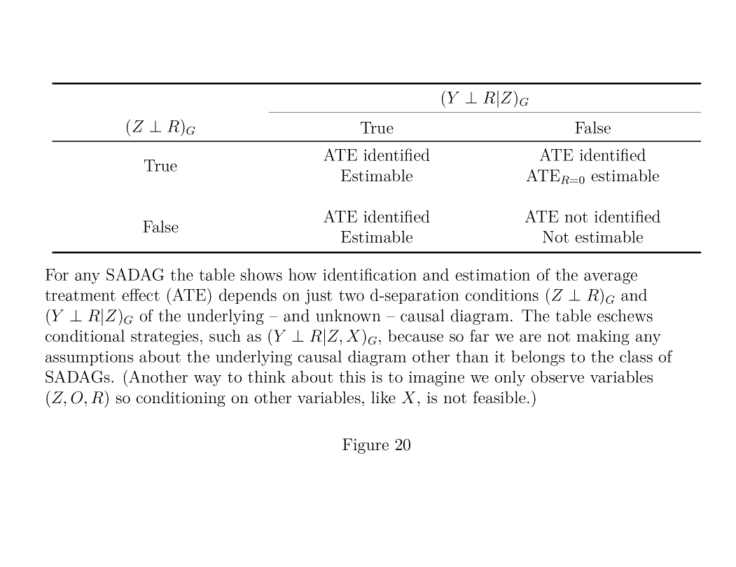

SADAGs restrict attention to attrition in RCTs, where we are willing to uphold standard experimental assumptions like randomization, excludability, and non-interference. To be clear, we are not restricting the infinite number of possible causal diagrams that could have generated the data to one specific diagram—the true underlying causal diagram in any application remains unknown—but only to the class of SADAGs. This restriction is motivated by the fact that experimenters are already willing to make a basic set of assumptions, including randomization, excludability, and non-interference, irrespective of attrition. Even so, the restrictions are relatively minor: the number of underlying causal diagrams that meet SADAG criteria is still infinite. Under this limited set of assumptions, which are standard in experimental studies, all possible known and unknown underlying SADAGs could in principle be classified into those where attrition is, and is not, problematic. Specifically, this can be done on the basis of the two d-separation conditions, as shown in the table in FIG. 20, where attrition is shown to be problematic if Y and R are not d-separated conditional on Z (formally [symbol] (Y⊥R|Z)_{G}); and Z and R are not d-separated (formally [symbol] (Z⊥R)_{G}). The term d-separation is a term of art for those skilled in the arts of causal diagrams.

### Diagnosing Problematic Attrition

Having shown how all unknown SADAGs can classified, or partitioned, into the four cells in the table shown in FIG. 20, the next step for the applied researcher is figuring out a way to determine where in these cells the SADAG generating the data at hand falls. This is of interest because it essentially determines whether the data at hand are informative for estimating some quantity of interest, or not, under standard experimental assumptions. In this regard the applicant further appreciated that under the further assumption of “faithfulness” the underlying unknown SADAG can be classified into problematic or unproblematic with regards to attrition on the basis of observed data—that is without knowing the exact causal diagram that generated the data. This is because faithfulness is a term of art for those familiar with causal diagrams such that, if the assumption holds, it follows that (X⊥Y|Z)_{G} [symbol] (X⊥Y|Z)_{P} for any set of variables X, Y, Z (set Z possibly empty); where (X⊥Y|Z)_{P} captures the probabilistic notion of conditional independence, and (X⊥Y|Z)_{G} the graphical notion of d-separation. Intuitively, it means that two variables are independent if, and only if, they are d-separated in the underlying causal diagram generating the observed probability distribution. As a result, we can make inferences about d-separation in the unobserved underlying SADAG from the observed distribution of data it generates. That is, we can test whether the underlying structure of the unknown model generating the data satisfies (X⊥Y|Z)_{G} by testing the observable implication that X and Y are conditionally independent given Z, or (X⊥Y|Z)_{P} (notice change of subscripts).

Since our interest is to learn about the unknown structure of the underlying SADAG, we will talk of testing (X⊥Y|Z)_{G}, even if the test itself is carried out by testing the equivalent statement (X⊥Y|Z)_{P} using the observed data, as discussed previously. Moreover, the latter can be tested using any number of non-parametric or parametric conditional independence tests, or any other statistical test to the same effect. Indeed, the choice of specific test will depend, inter alia, on the specific application, including the nature of the data (e.g. ordered, categorical, continuous, etc.), and whether parametric restrictions like linearity are assumed. Finally, when the structure of the underlying SADAG is known, then we can simply check the graph directly to see if the condition is true. Those skilled in the arts will realize that for complicated graphs this is best done using techniques designed for this task.

To establish whether attrition is problematic (as defined above) we proceed in two steps. First, we can test the null that treatment has no effect on attrition, against the alternative that it causes attrition. If the null is rejected we conclude that our application likely falls in the second row of the table in FIG. 20, otherwise we conclude that the evidence is not strong enough to reject the null of no effect. This test is unproblematic. To wit, attrition can be regarded as any other experimental outcome of interest, as would be the case if attrition were caused by death in tests of a new drug. Second, we can test the null that the outcome and attrition are independent conditional on the treatment, against the alternative that they are not independent. If the null is rejected we conclude that that our application likely falls in the second column of the table in FIG. 20, otherwise we conclude that there is not enough evidence to reject the null. This test is also unproblematic in the sense that all we are testing for is the presence of associations, not causation. Finally, if both nulls are rejected we conclude that our application is a case of problematic attrition (bottom right cell of the table in FIG. 20). In this case the ATE is not identified without additional assumptions. These tests may be performed in sequence, at once, or in a combination thereof (e.g. using sequentially partitioned hypotheses).

In practice, testing whether the treatment and attrition are independent (e.g. (Z⊥R)_{G}) is unproblematic; yet testing whether attrition and the outcome are independent conditional on the treatment (e.g. (Y⊥R|Z)_{G}) is complicated by the fact that the outcome is labelled missing whenever R=1, so the test cannot be performed. One possibility is to ignore this second test altogether, and rely only on the first test. If the null hypothesis that (Z⊥R)_{G} is rejected we know the underlying unknown SADAG belongs to one of the two cells in the bottom row of the table in FIG. 20, where attrition is potentially problematic. But if we fail to reject the null hypothesis then we have reason to believe that the underlying unknown SADAG belongs in one of the two cells in the top row of the table in FIG. 20. If so we can be reasonably confident that P(Y|Z=z, R=0) is a consistent and approximately unbiased estimator of P(Y|do (Z=z), R=0) if the underlying SADAG lies in the top right cell of the table in FIG. 20, or a of P(Y|do(Z=z)) if it lies in the top left cell. At the very least we can provide a point estimate of P(Y|do(Z=R=0), and an extreme bounds interval estimate of the ATE for those elements with unobserved outcomes. This can be a lot more informative than providing an extreme bounds estimate for all elements.

A second possibility is to devise a measurement strategy that can enable a test of (Y⊥R|Z)_{G}. For example, one can prepare for attrition by having a sampling plan for non-response follow up at the endline and/or baseline surveys used to measure the outcome of interest. Taking the example of non-response follow up in the endline survey only, this procedure involves surveying intensively a random sample of those elements that did not respond during the first survey stage. Assuming all elements respond in the second stage, and that these responses are governed by Equation 3 (with the proviso that R now refers to attrition in the second stage, and that it equals 0 for all elements), then P(Y|R=1, Z=z)=P(Y|S₂, Z=z), where variable S₂ indicates whether an element received the second survey (and S₂=1) or not (S₂=0). With P(Y|R=1) and P(Y|R=0) in hand it now becomes possible to test whether indeed (Y⊥R|Z)_{G}. However, at this point the test is only useful to diagnose attrition but is not necessary: if we can estimate P(Y|R=1, Z=z) using P(Y|S₂, Z=z), then we can compute P(Y|do(Z=z))=P(Y|Z=z)=Σ_{rεR}P(Y|Z=z, R=r)P(R=r|Z=z).

In practice, however, the second survey is very likely to also suffer from missing data. No matter. Under the assumption that the answers to the second survey were generated by the exact same mechanism that generated the answers to the first, then we can use the observed data in the first and second surveys to test the hypothesis that (Y⊥R|Z)_{G} (this assumption can be relaxed substantially but complicates the presentation, the really important assumption is that the second survey does not change the underlying outcomes Y, or, in some circumstances, only changes them monotonically). Specifically, under the null hypothesis that (Y⊥R|Z)_{G} in both surveys, and the assumption that the underlying mechanism generating the data is the same, it follows that P(Y|Z=z, R₁=1)≡P(Y|Z=z, R₁=0), where R₁ measures attrition in the first survey. In words, in the first survey the distribution of observed outcomes P(Y|Z=z, R₁=0) is the same as the distribution of the unobserved responses P(Y|Z=z, R₁=1) under the null assumption that attrition is independent of the outcome Y. By the same logic, it also follows that P(Y|Z=z, R₁=1)≡P(Y|Z=z, R₁=1, R₂=0). In words, the distribution of unobserved outcomes in the first survey P(Y|Z=z, R₁=1) is the same as the distribution of outcomes for elements whose outcomes were not observed in the first survey (R₁=1) but are observed in the second survey (R₂=0), namely P(Y|Z=z, R₁=1, R₂=0). If so, it follows that, under the null hypothesis, P(Y|Z=z, R₁=0) P(Y|Z=z, R₁=1, R₂=0) which is testable since both distributions are fully observed. In words, under the null hypothesis that (Y⊥R_{iε1,2}| Z)_{G}, the distribution of observed outcomes in the first survey P(Y|Z=z, R₁=0) is the same as the distribution of outcomes for elements whose outcomes were reported as missing in the first survey (R₁=1) but are observed in the second survey (R₂=0), namely P(Y|Z=z, R₁=1, R₂=0).

As before, the precise choice of test procedure for testing the null hypothesis that P(Y|Z=z, R₁=0) P(Y|Z=z, R₁=1, R₂=0) will depend on the most likely alternative hypothesis but those versed in the arts of statistics will appreciate that the sort of tests used in testing differences between distributions, like Kolmogorov type tests, and relative distribution methods might be useful. They will also appreciate that since most of the differences, if any, are likely to appear in the tails of the distributions, tests related to extreme value theory, significance tests for quantile regressions, or Wang-Allison tests to name a few may be more powerful. Those skilled in the arts would also appreciate that the follow-up sampling could be adaptive. That is, as responses to the follow up survey come in we can update—in real time—the probability that (Y⊥R_{iε1,2}|Z)_{G}, and stop sampling after some pre-determined threshold of confidence is reached. This could results in significantly cheaper non-response follow up measurement strategies.

### Remedying Problematic Attrition

Having shown how measurement and testing strategies can be combined to diagnose whether the unknown SADAG that generated the data is problematic or not, the next step is to decide whether anything can be done in case attrition is found to be problematic (ie. if tests that (Z⊥R)_{G} and (Y⊥R|Z)_{G} are both rejected). The applicant realized that there are a number of possibilities, depending on what assumptions we are willing to make, and what measures are available.
1. The true underlying SADAG is assumed to be known:
   (a) If we knew the true underlying SADAG that generated the data, and had measures for the relevant variables, we could look for a variable, or set of variables, X that d-separates Y and R; formally (Y⊥R|Z, X)_{G}. If such variables exists in the SADAG, and they are observed and measured, it follows that P(Y|do(Z=z))=Σₓ P(Y|Z=z, X=x)P(X=x|Z=z), and where P(Y|Z=z, X=x)≡P(Y|Z=z, X=x, R=0).
   (b) Else, if no such variable exists, or no measurements are available we could look for a variable, or set of variables, X such that (Z⊥Y|X, R=0)_{G} under the null of no effect (i.e. deleting from the SADAG all arrows out of Z that start a directed path connecting Z to Y). The reason for conditioning on R=0 is that we had already established in the previous step that no set X of variables existed such that (Y⊥R|Z, X)_{G}, in which case the only way we can move out from the bottom right cell of the table in FIG. 20, is by moving to the cell immediately above it. At this point all we can hope to estimate is P(Y|do(Z=z), R=0).
2. The underlying SADAG is unknown but outcomes are available from non-response follow up surveys.
   (a) As discussed above we can use the diagnostic tests for (Y⊥R|Z, X)_{G} to search amongst baseline or endline surveys and follow-up surveys for a set of variables X such that the test is no longer significant conditional on X. Those skilled in the arts of statistical analysis will appreciate that there are a variety of search processes, including structure learning processes, and regularization strategies to improve the reliability of whichever procedure is chosen. Also, experts in causal diagrams will appreciate that in deterministic systems differences in outcomes Y imply differences in causes. Hence, one place to begin looking for X is to look at those variables whose distribution differs the most across elements that responded in the first, and the elements that responded in the second stage survey; and that are highly correlated with the outcome and the attrition. Also, in case data are also missing in the non-response follow-up survey, then we can test for (Y⊥R|Z, X)_{G} by testing the null hypothesis that P(Y|Z=z, R₁=0, X=x)≡P(Y|Z=z, R₁=1, R₂=0, X=x).
   (a) If the above strategy fails to uncover any X that renders the test insignificant, it would be tempting to look for an X such that (Z⊥R|X)_{G} but note that this is not enough. What is needed is an X such that (Z⊥Y|X, R=0)_{G} under the null of no effect (i.e. deleting from the SADAG all arrows out of Z that start a directed path connecting Z to Y). Since the SADAG is unknown this strategy is not feasible. To wit, the condition that (Z⊥Y|X, R=0)_{G} under the null of no effect is not even testable.
3. The underlying SADAG is unknown and non-response follow up surveys are not available.
   (a) In this case one possibility is simply to use the inferences about what set of variables X d-separates Y from R from a previous study. Specifically, the study may have been selected from the same population (though not necessarily using the same criteria), used the same outcome survey, implemented non-response follow up surveys, and found a set of variables X such that (Y⊥R|Z, X)_{G}. Note the studies need not implement the same intervention. Assuming the underlying attrition mechanism is the same (with the possible exception of differences in the way Z and R are connected in the different experiments), then we can assume that X will also d-separate Y from R in the new study. (Incidentally, this is why it is a good idea to diagnose attrition even in the case where there is no attrition in the follow up survey: Learnings can be useful in other experiments.)

An exemplary system and method for diagnosing and remedying problematic attrition will now be disclosed.

### Method and System for Preventing, Diagnosing and Remedying Problematic Attrition

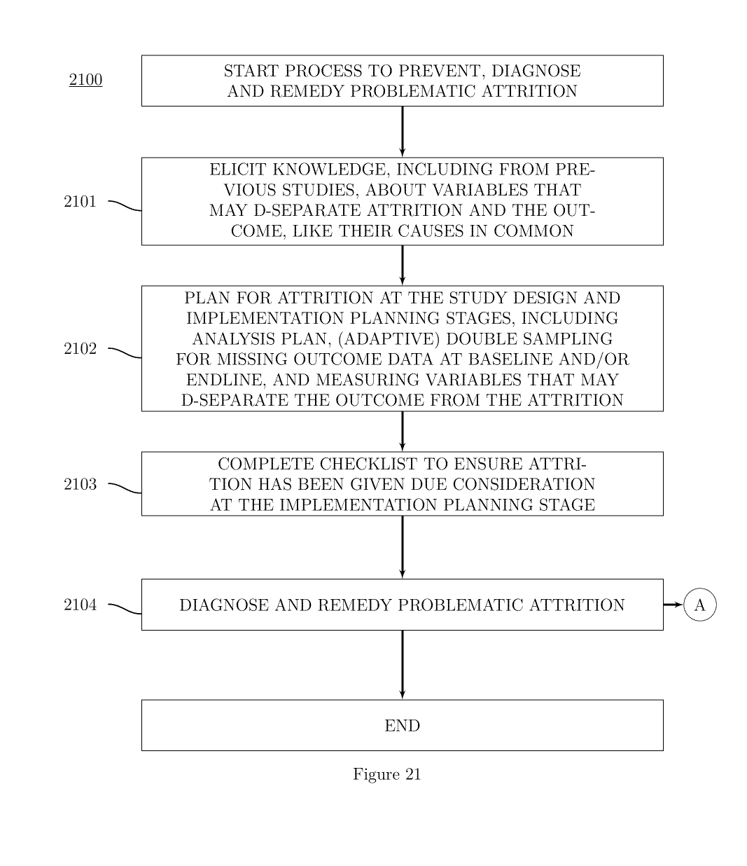

Effectively dealing with problematic attrition requires an integrated strategy. One that builds in safeguards to prevent problematic attrition in the design, measurement, and implementation of RCTs; and that exploits these safeguards at the analysis stage to diagnose and remedy problematic attrition if necessary. An exemplary implementation of the process for diagnosing and remedying problematic attrition is depicted in FIG. 21, and will now be described. The system and method herein disclosed may be implemented in connection to an integrated causal knowledge identification and management process, like the one depicted in FIG. 2, including, but not limited to, Steps 208, 210, 211, 212; and implemented in a system like the one depicted in FIG. 1. However, the system and method herein disclosed may also be implemented independently from an integrated causal knowledge identification and management system.

The first step in attrition prevention, diagnosis and remedy process 2100, step 2101, is to elicit prior knowledge about the common causes of the attrition and the outcome. Such common causes are a necessary aspect of problematic attrition, and key to remedying it. Hence it behooves those about to engage in an RCT to think ahead what variables may cause both attrition and the outcome, and if possible to measure them in Step 207 of the integrated causal knowledge identification and management process depicted in FIG. 2. One possibility is to use the elicitation modules in knowledge identification and management engine 109 in server apparatus 103 to include questions about common causes of the outcome and the attrition in Step 202 of the integrated causal knowledge identification and management process depicted in FIG. 2. In addition, users can search previous studies associated with the same KDG, or with other KDGs, stored in computer-readable media 105, or in any other such media accessible over network 102, that examined the same outcomes of interest (ideally using the same survey or measurement instruments), and that implemented some of the techniques disclosed below to find out possible common causes (or proxies thereof) of the outcome and the attrition. For example, if a previous study found that (Y⊥R|Z, X)_{G}, then it would be a good idea to ensure data on X are included in the present study.

The second step in attrition diagnosis and remedy process 2100, step 2102, is to include measures against problematic attrition in both the design and analysis of the study, or Steps 208, and 211, of the integrated knowledge identification and management process depicted in FIG. 2. Specifically, one such measure includes deciding how attrition will be analyzed at the study design stage (Step 208), including what data and tests will be used. In addition, a second such measure may call for non-response follow-up surveys at baseline or endline surveys at the implementation stage (Step 210). In one implementation the user may design an implementation whereby, as results from the non-response follow-up survey at baseline, a module for Bayesian adaptive testing in knowledge identification and management engine 109 instructs processor 106 to execute instructions designed to test the hypothesis that (Y⊥R|X)_{G} in real time using input data provided by field enumerators using network connected clients, like hand held devices, that share non-response follow-up survey results in real time over network 102 with processor 106. If after a number of responses there is little evidence against the null hypothesis, processor 106 may execute instructions to inform field surveyors to stop the survey, and perhaps instructions to cancel any planned non-response follow up survey at endline. Alternatively, if the evidence against the null is strong, processor 106 may execute instructions to inform field surveyors to stop the survey, and perhaps instructions to confirm any planned non-response follow up survey at endline. A third measure to prepare for attrition is to ensure variables revealed as possible causes of both the outcome and the attrition at the elicitation stage, are included in the measurement strategy in Step 207 of the integrated causal knowledge identification and management process depicted in FIG. 2.

The third step in attrition diagnosis and remedy process 2100, step 2103, is to provide the administrator, or chief knowledge engineer (see FIG. 3), with the possibility to require a checklist related to attrition be completed before any study implementation activities can begin. This checklist may ask which if the aforementioned measures have been included in the design and implementation plans, and request explanations for why such measures may not have been included. One advantage of an integrated knowledge identification and management system is precisely the ability to build into the study process such safety measures.

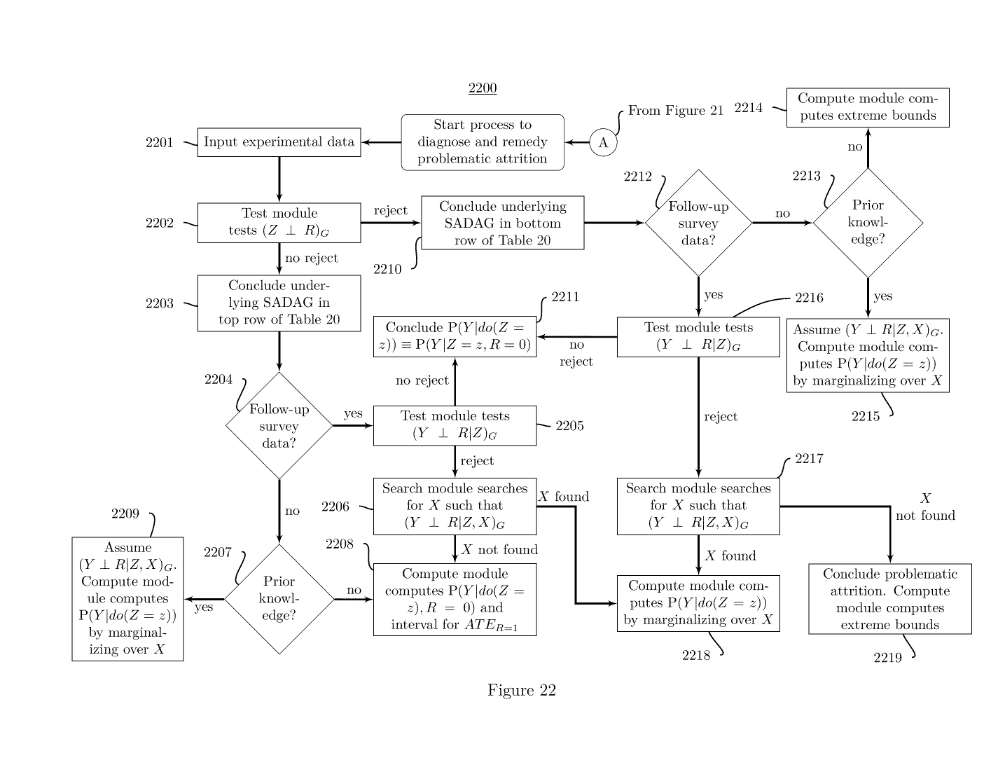

The fourth step in attrition diagnosis and remedy process 2100, step 2104, is to analyze the experimental data collected after implementing the RCT. Specifically, the goal of this process is to diagnose, and remedy any problematic attrition, if at all possible. In one exemplary implementation processor 106 may execute instructions related to attrition analysis in attrition engine 111, that may implement exemplary attrition diagnostic and remedial process 2200 in FIG. 22. As explained in the previous section this process begin with Step 2201 to input the data generated by the RCT intervention. Next, in Step 2202 processor 106 executes a test module in attrition engine 111 to test the null hypothesis (R⊥Z)_{G}. If the test is not rejected at the chosen level of significance, a record is written in Step 2203 to computer-readable media 105 to the effect that the underlying unknown SADAG generating the attrition and outcome is in one of the two cells in the top row of the table in FIG. 20. Specifically, this means P(Y|do(Z=z)) is identified, but only P(Y|do(Z=z), R=0) may be estimable, as discussed above. Next, in Step 2204, processor 106 executes instructions to check whether follow-up survey data were collected and are available in the graphical knowledge base associated with the KDG in computer readable media 105, or in any such media over network 102. If such data are not available, in Step 2207, processor 106 executes instructions to check whether prior knowledge was added to the graphical knowledge base associated with the KDG in computer readable media 105, or in any such media over network 102. If not, processor 106 executes instructions in Step 2208 to compute P(Y|do(Z=z), R=0), and an interval estimate, such as an extreme bound, for P(Y|do(Z=z), R=1). If yes, processor 106 executes instructions in Step 2209 to compute P(Y|do(Z=z) using the prior knowledge and the data in the graphical knowledge base, including marginalization over some variable or set of variables X.

If follow-up data were available, in Step 2205 processor 106 executes instructions to test (Y⊥R|Z)_{G}. (Note that if data are also missing in the non-response follow-up survey then, as discussed above, we can test that (Y⊥R|Z)_{G} by testing the null that P(Y|Z=z, R₁=0) P(Y|Z=z, R₁=1, R₂=0).) If the test is not rejected, in Step 2211 processor 106 executes instructions to compute P(Y|do(Z=z)) in the knowledge that P(Y|do(Z=z))≡P(Y|do(Z=z), R=0). If the test is rejected, in Step 2206 processor 106 executes instructions to search the graphical knowledge base associated with the KDG for a variable, or set of variables, X such that (Y⊥R|Z, X)_{G}. Under the assumptions that the underlying SADAG is the same in the non-response follow-up survey, and that all non-respondents in the first survey respond in the second survey, then we can simply replace the missing values in the first survey, with those in the second survey to perform the conditional independence tests guiding the variable search. Those skilled in the statistical arts will know that the reliability of this search can increase by using a regularizer, or validation technique. Moreover, this search might begin by looking at variables that differ the most across elements that responded the first survey, and those that responded the second survey, and that are highly correlated with the outcome and the attrition. (Note that if data are also missing in the non-response follow-up survey then, as discussed above, we can test that (Y⊥R|Z, X)_{G} by testing the null that P(Y|Z=z, R₁=0, X=x)≡P(Y|Z=z, R₁=1, R₂=0, X=x).) If such a variable or set of variables is not found, processor 106 executes the same instructions as in Step 2208, described above. By contrast, if such variables are found, in Step 2218 processor 106 executes instructions to compute the right quantity of interest by marginalizing over set X.

If the test in Step 2202 had been rejected at the chosen level of significance, a record is written in Step 2210 to computer-readable media 105 to the effect that the underlying unknown SADAG generating the attrition and outcome is in one of the two cells in the bottom row of the table in FIG. 20. Specifically, this means that attrition could be problematic, as discussed above. Next, in Step 2212, processor 106 executes instructions to check whether follow-up survey data were collected and are available in the graphical knowledge base associated with the KDG in computer readable media 105, or in any such media over network 102. If such data are not available, in Step 2213, processor 106 executes instructions to check whether prior knowledge was added to the graphical knowledge base associated with the KDG in computer readable media 105, or in any such media over network 102. If not, processor 106 executes instructions in Step 2214 to compute extreme bounds for the ATE. If yes, processor 106 executes instructions in Step 2215 to compute P(Y|do(Z=z) using the prior knowledge and the data in the graphical knowledge base, including marginalization over some variable or set of variables X.

If follow-up data were available, in Step 2216 processor 106 executes instructions to test (Y⊥R|Z)_{G}. (Note that if data are also missing in the non-response follow-up survey then, as discussed above, we can test that (Y⊥R|Z)_{G} by testing the null that P(Y|Z=z, R₁=0)≡P(Y|Z=z, R₁=1, R₂=0).) If the test is not rejected, processor 106 executes instructions in Step 2211 referred to above. If the test is rejected, in Step 2217 processor 106 executes instructions to search the graphical knowledge base associated with the KDG for a variable, or set of variables, X such that (Y⊥R|Z, X)_{G}. (Note that if data are also missing in the non-response follow-up survey then, as discussed above, we can test that (Y⊥R|Z, X)_{G} by testing the null that P(Y|Z=z, R₁=0, X=x)≡P(Y|Z=z, R₁=1, R₂=0, X=x).) If such a variable or set of variables is not found, in Step 2219 processor 106 executes instructions to compute extreme bounds. By contrast, if such variables are found, in Step 2218 processor 106 executes instructions to compute the right quantity of interest by marginalizing over set X.

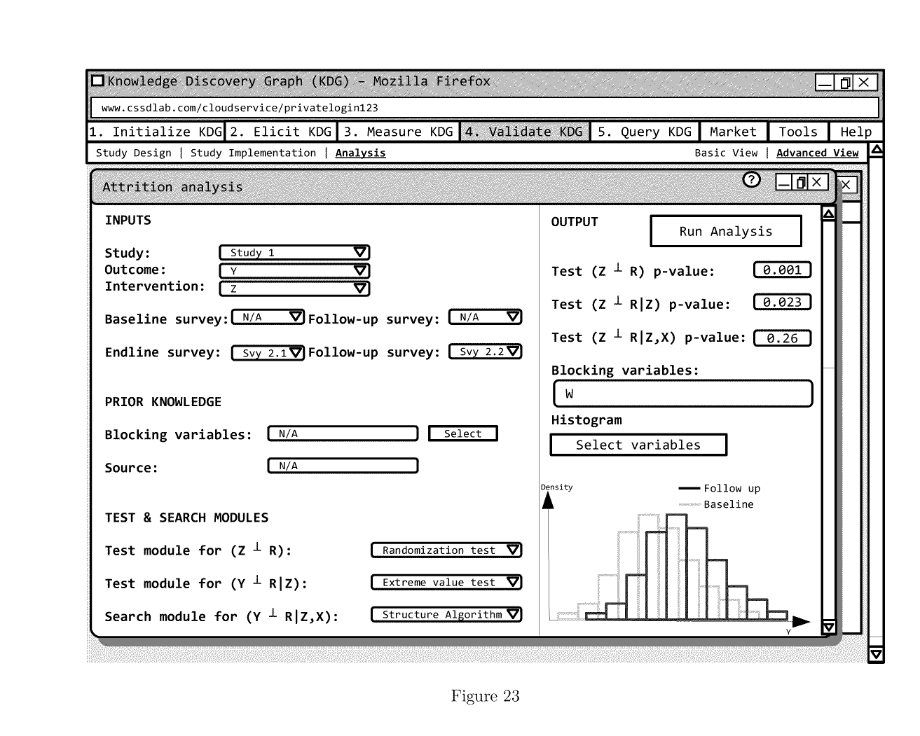

In one exemplary instance of process 2100 processor 106 in server apparatus 103 may serve a web page, scripts, and other web elements to client 107 over network 102, an exemplary version of which is illustrated in FIG. 23. Specifically, those skilled in the arts of statistical analysis would appreciate that at several steps in process 2200 generic modules may be used, including test and search modules. Users operating client 107 may use drop down menus to select the desired test and search modules, among other, including from the Knowledge Market via knowledge market engine 112. These search modules are not limited in any sense, and may include constraint-based, score-based, Markov blanket-based, and feature-selection techniques, and combinations thereof. Also included are non-parametric and parametric conditional independence tests and measures of association.

### System and Method for Generalization of Experimental Findings

### Understanding, Diagnosing, and Remedying Non-Generalizability

Generalization is the second Achilles' Heel of the randomized control experiment. Most current approaches to generalization rely on random sampling from a well defined population, which is seldom feasible, or on heuristic ways to adjust a non-random sample that provide no guarantees whatsoever regarding their effectiveness. No matter. Using the systems and methods disclosed herein it is possible to determine ex-ante, that is at the experimental design stage, whether findings from the study under consideration will generalize to the population of interest (or subsets thereof) and, if not, how sampling might be adapted to ensure this is the case whilst respecting the logistical or other constraints on sampling as much as possible. It is also possible to determine ex-post whether findings from pre-existing RCTs generalize to a target population or subgroups thereof. And to determine whether planned (e.g. ex-ante), or already executed studies (e.g. ex-post) that by themselves are not generalizable can be combined with existing results from other studies (or planned results from future studies) into a generalized inference for the population of interest (or any subset thereof).

A significant element of this technique is the applicant's determination that whether findings from an RCT generalize to a broader population depends on how the sample of elements participating in the RCT was selected from the population. Specifically, a sufficient condition for a study's findings to be generalizable is for the sampling to be independent of any direct or indirect cause of the outcome of interest (simple random sampling is a special case of independent sampling). This will be the case whenever the variable indicating selection into the study is d-separated from the outcome of interest, as explained below. Consequently, whether elements in the study sample have very different characteristics from elements in the population is irrelevant for generalization purposes, so long as those characteristics are neither direct or indirect causes of the outcome, or direct (or indirect) effects of any causes of the outcome. That is, so long as those variables are also d-separated from the outcome of interest. In fact, as is explained below, current heuristic approaches that try to adjust for all observable differences between elements in the sample and the population or subset thereof may introduce bias in an otherwise generalizable finding. This is because, as is explained below, not all differences should be adjusted for. Furthermore, the applicant also realized that whether a given sample was drawn from the population independent of the causes of the outcome is testable—even if the underlying model and sampling criteria are unknown.

To understand, prevent, diagnose, and remedy generalization problems, and to aid in the design of generalizable studies that rely on non-random samples from the population, the applicant has introduced Generalization Directed Acyclic Graphs, or g-DAGs for short. The defining feature of g-dags is the inclusion of information about the study in the causal diagram itself, including how subjects were recruited and randomized. This is convenient, informative, and justified. First, an experimental study is a deliberate attempt by researchers to intervene in Nature, and how the intervention takes place has consequences for what can be concluded from the study. A g-DAG provides a simple, visual, and direct way of recording key aspects of the intervention. Second, to make proper statistical inferences about a population from a sample of data, we should include in our (non-parametric) causal model all the information about how the study sample was selected. Third, by combining the selection into the study and the population-level causal model for the outcome, a g-DAG can be used as an inference engine for determining when generalization from a non-random sample to the population of interest (or any sub-sample thereof) is feasible, and how. This will be explained with reference to a simple example where it is assumed, for simplicity, that the underlying causal model and sample selection are known (e.g. the g-DAG is known). Next, this unrealistic assumption will be relaxed to show how generalization may be diagnosed in cases where the underlying g-DAG is unknown. For simplicity, what follows makes the standard experimental assumptions of randomization, excludability, and non-interference, together with standard causal Markov assumptions, and faithfulness. These can be relaxed, but they are assumptions that experimentalist make routinely (whether implicitly or explicitly), and they simplify the exposition. A brief explanation follows.

### Understanding What Determines Generalizability of Experimental Findings

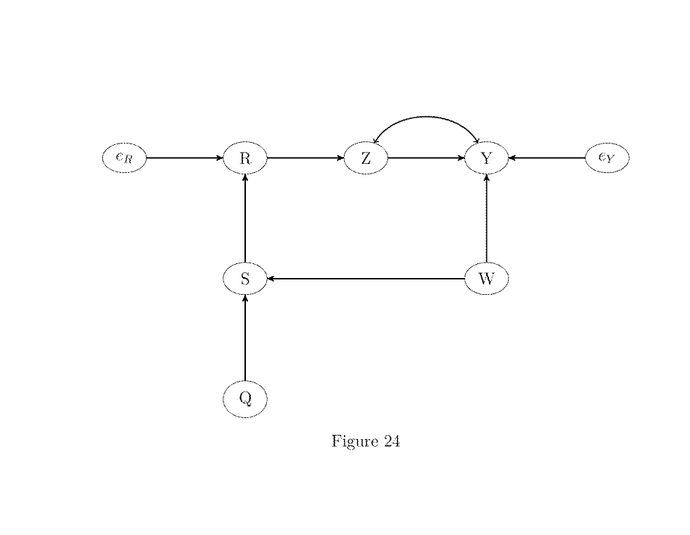

Consider the population g-DAG in FIG. 24 and assume, for the time being, we have data on all nodes of the g-DAG for all elements of the population (e.g. a full census). As drawn the g-DAG combines into a single causal diagram the hypothesized population level mechanism generating the outcome (i.e. the graph defined by variables Z, Y, W, and e_{Y}), with information regarding how elements were selected into the study and assigned to treatment (i.e. the additional nodes Q, S, R, and e_{R}). Specifically, Y is the outcome of interest, W is a direct cause of the outcome, and Z is another direct cause whose effect on the outcome we want to estimate. Variable e_{Y} captures all other unknown causes of Y. In this context an RCT for studying the effect of Z on Y is motivated by the bi-directed edge connecting Z and Y. The latter is a confounding path, and, as a result, the observed quantity P(Y|Z=z) is not a consistent and approximately unbiased estimator of the causal quantity P(Y|do(Z=z)). To ensure that P(Y|Z=z)≡P(Y|do(Z=z)) in the presence of a confounder we need to intervene directly on Z, for example using a RCT. Accordingly, the g-DAG combines information about the causes of the outcome, with details of how elements from the population are recruited into the study and assigned to one or more treatment conditions. The g-DAG in FIG. 24 illustrates the case of one study and one treatment. For this study variable S indicates which elements from the population are to be included in the study (S=1), and which are to be excluded (S=0). For example, the g-DAG below shows that selection of elements into the study is on the basis of variables W and Q. Specifically S=f_{S}(W, Q), where the selection equation f_{S} could be any function, for example the piecewise function S=1 if, and only if, W>w and Q=q, and S=0 otherwise. Such non-random sampling may have been motivated by logistical, ethical, or cost considerations. Importantly a g-DAG encodes how the causes of the outcome are related to the variables in the selection equation f_{S}(.), if at all. In the present example the g-DAG shows that selection criteria W is also a cause of outcome Y. Variable R captures the treatment assignment, such that R=1 if an element is a participant in the study (i.e. S=1), and it is assigned to treatment (Z=1); and it is R=0 if an element is a participant in the study and it is assigned to control (Z=0). If an element from the population is not included in the study R=N.A. In a RCT the assignment to treatment and control is determined by a known chance mechanism under the control of researchers, like a coin toss represented by e_{R}. To simplify the exposition only, assume full compliance such that:

$$Z = \{ \begin{matrix}1 , & if R = 1 , \\ 0 , & if R = 0 , \\ f ( U ) , & if R = N . A . ,\end{matrix} \qquad ( 4 )$$

where f(U) is any function summarizing the impact of all other causes of Z other than R, including causes in common with Y (as captured by the bi-directed arc).

As just described the RCT is carried out on a convenience sample from the population, one that is not completely at random (e.g. by tossing a coin, say). Under standard experimental assumptions (and assuming full compliance for simplicity), we have that P(Y|do(Z=z), S=1)≡P(Y|Z=z, S=1)≡P(Y|R=z, S=1). That is, the observed outcomes in the study are consistent and approximately unbiased for the causal effect of the treatment amongst elements participating in the study (e.g. for which S=1). Yet the question of generalizability is whether we can generalize from the observed outcomes in the study, to the causal effect in the full population of elements. Namely, we want to know whether P(Y|Z=z, S=1) is consistent and approximately unbiased for the causal quantity of interest for the full population of elements, namely P(Y|do(Z=z)). The applicant has realized that whether the findings from this study generalize to all elements in the population depends on a simple d-separation condition: (Y⊥S)_{G}_{_{S}}, where the subscript G_{S} refers to the g-DAG where all arrows emanating from S have been deleted. For example, in the g-DAG in FIG. 24 W is a confounder for the population effect of R on Y, as it opens a back-door path between R and Y (note: under perfect compliance P(Y|do(Z=z))≡P(Y|R=z)). This is not a problem for estimating the causal effect amongst elements in the study because conditioning on S=1 blocks this backdoor path, but it becomes a problem whenever the conditioning is removed to compute the population causal effect. This is because a back-door path is a term of art in causal diagrams such that the causal effect of a variable on another is not identified whenever they are connected by an unblocked back-door path. (One exception is when there graph meets the so called front-door identification criterion. However, those familiar with the art of causal diagrams will know that this solution requires making additional assumptions not warranted by the design of the experiment. With additional assumptions studies can be combined in this fashion, as discussed below.

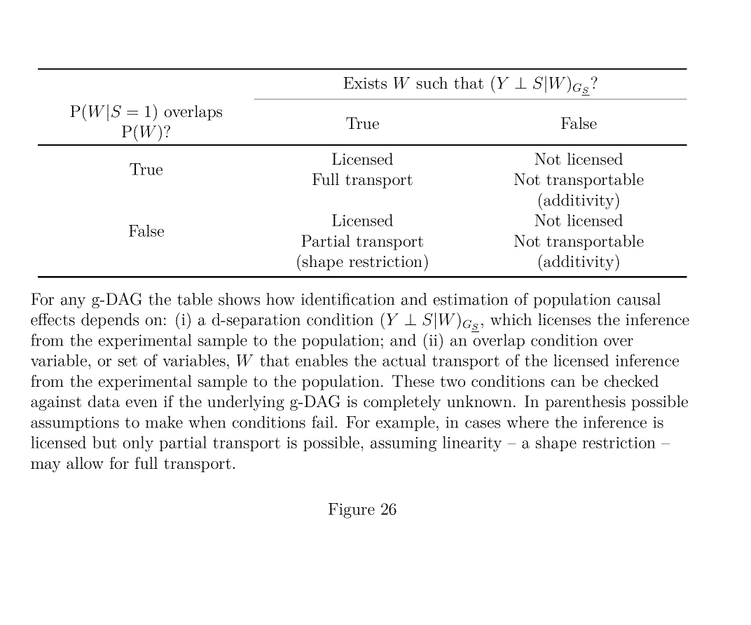

To get some intuition first consider why P(Y|Z=z, S=1) may not be a consistent nor approximately unbiased estimator for the population causal effect P(Y|do(Z=z)). One possibility is that variable W is a moderator for the effect of Z on Y, such that elements with higher values of W experience stronger effects compared with elements with lower values of W. Now, since elements were included in the sample on the basis of W, as in selecting elements whenever W>w say, it follows that elements in the study sample likely have higher values of W compared to the population as a whole, and so are likely to experience stronger effects. As a result, the estimated effect in the sample is likely to overestimate the full effect in the population such that P(Y|Z=z, S=1)≠P(Y|do(Z=z)). Second, the applicant realized that the problem is not non-random sampling, so much as the fact that the sample was not selected independently of the direct or indirect causes of outcome Y, and, by implication, of the possible moderators of the effect of Z on Y. (By definition all moderators have to also be direct or indirect causes of Y.) For example, if selection had been only on the basis of Q>q say, sampling would be non-random but independent of the outcome, and so the findings from the study would generalize meaning P(Y|Z=z, S=1)≡P(Y|do(Z=z)). Specifically, the distribution of W would be the same in the sample as in the population. Therefore, one key criteria for generalization is whether the selection of elements into the study is independent of the direct or indirect causes of Y. If so, selection is independent of all possible moderators of the effect of Z on Y. Third, from this it follows that P(Y|do(Z=z))≡P(Y|Z=z, S=1) whenever (Y⊥S)_{G}_{_{S}}, or, more generally, whenever (Y⊥S|X)_{G}, such that P(Y|do(Z=z), X=x)≡P(Y|Z=z, X=x, S=1). In words, the sample causal effect is equivalent to the population causal effect within strata defined by X whenever Y and S are d-separated by X in the modified g-DAG where all arrows emerging from S have been deleted. Finally, whereas d-separation (Y⊥S|X)_{G}_{_{S}}, ensures that the population causal effect is identified, that is, it licenses the transport of the identified effects to the broader population, it does not on its own ensure that the inferences can be fully transported. For estimating the population causal effect we need a second criteria, namely that P(X|S=1) overlaps P(X). The latter ensures inferences can be transported to the full population. These findings are summarized in the table in FIG. 26, which details the conditions needed for licensing and transporting inferences from a sample to a population (licensing is necessary for transport).

The approach disclosed herein combines experimental data from the study sample with information from the population distribution. In the example g-DAG in FIG. 24 this may include information on the distribution of Y and W in the sample, along with information on the distribution of Y and W in the population. The latter may come from a full census, or from a random sample of the population. For example, in the g-DAG in FIG. 24 P(Y|do(Z=z))=Σ_{w}P(Y|do(Z=z), W=w)P(W=w|do(Z=z)), where the last two terms can be computed from a combination of the experimental data and population data. First, because (Y⊥S|W)_{G}_{_{S}}, it follows that P(Y|do(Z=z), W=w) P(Y|do(Z=z), W=w, S=1)≡P(Y|R=z, W=w, S=1). Second, because (W⊥Z)_{G}_{_{S}}, it follows that P(W=w|do(Z=z))≡P(W=w) (in general selection into the study group precedes treatment, so Wₜ is independent of do(Zₜ₊₁=z)). Consequently, the effect of the treatment on the full population of elements can be computed as P(Y|do(Z=z))=Σ_{w}P(Y|R=z, W=w, S=1)P(W=w) assuming P(W|S=1) overlaps P(W), otherwise we can only compute the population effect for those strata of W for which there is overlap between the sample and the population.

Moreover, as will be explained below, data from the population is not only useful for computing population causal effect, but also to perform diagnostics tests about the generalizability of findings from planned or existing studies. Notably this includes situations where the underlying g-DAG is unknown. For example, a health management organization might want to know whether the results from a previous study testing a novel smoking cessation intervention in a different region might be applicable to the HMO's sample of patients in another region, including the likely effect size in this sample. As is often the case the previously published results may not detail the population sampling frame, nor recruitment criteria. Graphically this means we do not know the causes of node S indicating selection in the g-DAG in the original study. No matter. As explained below, we can use data on the population from which these two samples were drawn to test the conditions in the table in FIG. 26 that allow the transfer of knowledge from one region or sample to the other. If the test is met, we can compute the estimated effect size for the target population as illustrated above.

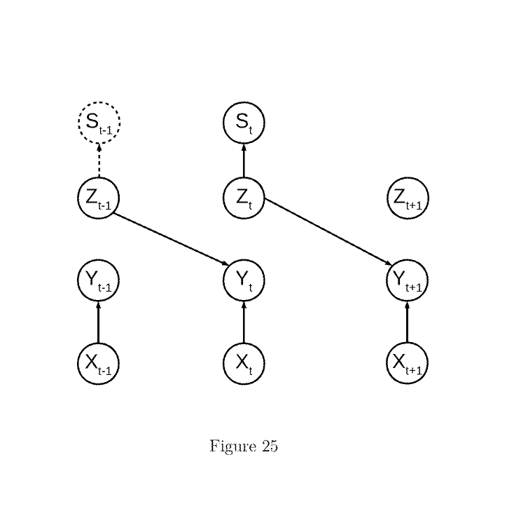

Finally, all that has been said thus far also applies to dynamic models. These only add additional nodes to the g-DAG as shown in FIG. 25. The figure shows that the outcome Yₜ is a function of Xₜ and Zₜ or Yₜ=f_{Y}_{ₜ}(Xₜ, Zₜ₋₁). It shows how three time periods worth of data on these variables are related to each other. Assume the simple case where we are planing an experiment at time t, have baseline data for times t and t−1, and hope to measure the outcome of the experiment in the following time period t+1. In this case the right test to check for generalizability of results at time t+1, is to test (Sₜ|Yₜ₊₁)_{G}, and, if the test is rejected, try to find some variable such that the independence holds. The problem is that at time t, the outcome at t+1 is not observed so we cannot test this. Moreover, if instead we test (Sₜ⊥Yₜ) then we get the wrong answer as the test will not be rejected in expectation. What to do? The answer to this is simple. If we are selecting the data at time t and want measure the outcome at time t+n, then we need baseline data for at least the periods t−n to t so we can test (Sₜ₋ₙ⊥Yₜ)_{G}. Under the assumption of structural stability this is equivalent to testing (Sₜ⊥Yₜ₊ₙ)_{G}. For example, in FIG. 25 the right approach if we want to select the elements at time t and measure the outcome at time t+1, is to gather baseline data for the periods t and t−1, pretend we selected the sample at t−1 (hence the discontinuous line around Sₜ₋₁), and test (Sₜ₋₁⊥Yₜ)_{G}. Given the data at hand this is testable, and by iterating we will find in large samples that (Sₜ₋₁⊥Yₜ|Zₜ₋₁)_{G}. So if at time t we wanted to select elements into the study on variable Z, then for the study to be generalizable we should select these elements on the basis of Zₜ₋₁. Note that if selection at time t had instead been a function of Zₜ₋₂, and we only had baseline data for periods t and t−1, then we would reject the test that (Sₜ₋₁⊥Yₜ)_{G} and would fail to find a conditioning strategy that passed the test, which is what we expect. Clearly if the time frame of selection is not known, the more historical baseline data we have, the better chance we have of finding a solution to any non-generalizability diagnostic.

### Diagnosing and Remedying Non-Generalizability Ex-Ante

With enough data from the experimental sample and the population the conditions in the table in FIG. 26 can be checked—even if the underlying g-DAG is unknown. This follows from the faithfulness assumption discussed in relation to attrition above, whereby (Y⊥S|W)_{G}_{_{S}} [symbol] (Y⊥S|W)_{P}_{_{S}}, where the former refers to the graphical notion of d-separation, and the latter to the probabilistic notion of conditional independence. (Note that by using baseline data, i.e. data collected before the randomization takes place, it follows that (Y⊥S|W)_{P}_{_{baseline}}≡(Y⊥S|W)_{P}_{_{S}} under the assumptions that the underlying causal structure is time invariant. In words, suppose that variable Y (e.g. smoking) in the population is independent of variable indicating selection into the study S, conditional on W (e.g. income) at baseline. Then (conditional on the same g-DAG) Y is also independent from S conditional on W at endline under the (counterfactual) scenario that would have been observed had the elements recruited to the study not received any intervention (e.g. like a smoking cessation program).)

For example, condition (Y⊥S|W)_{G}_{_{S}} is testable ex-ante if the elements selected into the study can be located in a population census (i.e. a complete listing of all elements in the population), and the census includes baseline data on the outcome of interest Y. For example, we can test the null that P(Y|S=1, W=w)≡P(Y|S=0, W=w). With census data for Y but not W we can test the more restrictive condition (Y⊥S)_{G}_{_{S}}: we have record for Y and S for all elements in the population, including elements in the experimental sample so we can test the null that P(Y|S=1)≡P(Y|S=0). Suppose a test of the null that (Y⊥S)_{G}_{_{S}} is rejected. If we have baseline data from the census on other variables W beyond Y and S, then we can search amongst those variables in case there exists W such that (Y⊥S|W)_{G}_{_{S}}. If so, we can compute the population causal effect as illustrated above.

Often we only have observations on the distribution of Y, and/or W for a random sample from the population, not from the full census (where W is a set of variables in the random sample). No matter. If we also have baseline data on Y and W for the selected experimental sample then we can test (Y⊥S)_{GS}. Specifically, if the latter is true, it follows that P(Yₚₒₚ)≡P(Yₛₐₘₚₗₑ), where P(Yₚₒₚ) refers to the random sample from the population, and P(Yₛₐₘₚₗₑ) refers to the baseline distribution of outcomes amongst elements in the experimental sample. This equivalence is testable. If the test rejects the null that P(Yₚₒₚ)≡P(Yₛₐₘₚₗₑ), we conclude that Y and S are not unconditionally d-separated in the unknown underlying g-DAG. At this point, if we have data on other variables Win the random sample from the population (Wₚₒₚ), and in the baseline measures for the experimental sample (Wₛₐₘₚₗₑ), then we can search for a variable, or set of variables, W such that P(Yₚₒₚ|Wₚₒₚ=Wₛₐₘₚₗₑ)≡P(Yₛₐₘₚₗₑ|Wₛₐₘₚₗₑ=Wₛₐₘₚₗₑ), where by definition P(Wₚₒₚ) stochastically dominates P(Wₛₐₘₚₗₑ). If a test of the latter equivalence is rejected for all Wₛₐₘₚₗₑ, then we conclude that there does not exist in the available dataset a variable W such that (Y⊥S|W)_{G}_{_{S}}, so the underlying unknown g-DAG lies on the right column of the table in FIG. 26, and the results from the study will not be generalizable to the population on the basis of available data.

### Diagnosing and Remedying Non-Generalizability Ex-Post

Thus far we have been considering ex ante situations, where we want to check whether findings from a proposed experimental sample can be generalized to a population on the basis of baseline data for the proposed sample, and data from a random sample from the population (or a census). Now consider ex-post situations, where we want to learn whether given experimental results are generalizable to the population. First, if the experiment included baseline data on the outcome and other variables, and if a random sample is also available from the population, then we can proceed exactly as before, pretending this is an ex-ante situation. Second, if the experimental data only includes endline data on the outcome Yₛₐₘₚₗₑ, plus some covariates Wₛₐₘₚₗₑ then the d-separation condition is still testable under the assumption that the control condition Z=0 refers to the absence of intervention, or a known ineffective placebo, and not an alternative treatment that might affect the outcome (as is common in comparative effectiveness designs). For example, in terms of Equation 4 this would be the case if Z=f(U) if R=0. If this is the case, and assuming full compliance for simplicity, then we can test P(Yₚₒₚ) P(Yₛₐₘₚₗₑ|R=0). (The assumption that Z=f(U) refers to absence of intervention and ensures that the distribution is compatible with G_{S}.) If that test is rejected then we can search for a variable, or set of variables, in the set Wₛₐₘₚₗₑ such that P(Yₚₒₚ|Wₚₒₚ=wₛₐₘₚₗₑ)≡P(Yₛₐₘₚₗₑ|R=0, Wₛₐₘₚₗₑ=wₛₐₘₚₗₑ). If no such variables exist then we conclude the underlying unknown g-DAG lies on the right column of the table in FIG. 26, and the results from the study will not be generalizable to the population on the basis of available data. If these tests were not rejected then we can compute the population causal effect as explained above. Here we have used the case where data form a random sample from the population is available. The case where data are available from a census and the elements in the control group in the experimental sample can be mapped to said census is analogous to the case discussed above, except we now test the null that P(Y|S=1, Z=0, W=w) P(Y|S=0, W=w).

The applicant has also realized that this approach can be extended to analyze any number of situations, not just the case of generalizing from a sample to a population. For example, consider the case where the organization is interested in segmenting experimental findings to optimize the roll-out of the intervention to the population. A typical segmentation study analyzes how the estimated causal effects from an RCT correlate with observable characteristics of study participants (be they individuals, retail stores, or any other kind of participant), with a view to rolling out the intervention to those elements where, based on their characteristics, larger effects are expected. For example, a segmentation analysis may reveal that elements in the study with a certain value x of baseline variable X experience the greatest effect. Hence it may be decided that the intervention will only be applied to elements in the target population for which X=x (e.g. X may be gender, and x may indicate “female”).

Those skilled in the arts of statistical and graphical analysis will realize that this is trying to extrapolate from P(Y|do(Z=z), X=x, S=1) to P(Y|do(Z=z), X=x). Now, within the experimental sample, and by standard experimental assumptions, P(Y|Z=z, X=x, S=1) is a consistent and approximately unbiased estimator for P(Y|do(Z=z), X=x, S=1), the within segment sample causal effect, yet the question is whether it is also a consistent and approximately unbiased estimator for the segmented causal effect in the population P(Y|do(Z=z), X=x). The answer depends on whether (S⊥Y|X)_{G}_{_{S}}, or, failing that, whether there exists some variables W such that (S⊥Y|X=x, W)_{G}_{_{S}}. For example, (S⊥Y|X)_{G}_{_{S}} will be false whenever X is a collider in an otherwise unblocked path between the sample indicator and the outcome. This is because collider is a term of art such that conditioning on a collider in an otherwise unblocked path between any two variables introduces a dependency between these two variables. As a result the within sample segmented causal effect may over- or under-estimate the segmented population causal effect. Besides discovering this potential problem with segmented analysis, the applicant has also discovered that whether segmented analyses generalize is testable, as above. For example, in the case where baseline data are available on the study sample and on a random sample from the population problematic segmentation can be checked by testing whether P(Yₚₒₚ|X=x)≡P(Yₛₐₘₚₗₑ|X=x), or, more generally, P(Yₚₒₚ|X=x, Wₚₒₚ=Wₛₐₘₚₗₑ)≡P(Yₛₐₘₚₗₑ|X=x, Wₛₐₘₚₗₑ=wₛₐₘₚₗₑ) (for simplicity only this assumes overlap on X).

The previous example of segmentation analysis is also illustrative of how generalization and attrition methods may be combined. In general it is best to first take care of attrition, and only then consider generalization. For example, if the attrition analysis suggests that the underlying SADAG is in the top right cell of the table in FIG. 20, then the situation is equivalent to the segmentation analysis just described, except the segmentation is now on the basis of elements with observed outcomes, or, equivalently, elements for which R=0.

Besides generalizing from a sample to a target population, or from a segmented analysis in a sample to a segment of the population, diagnostic tests and estimation procedures may also be applied for licensing and transporting findings from one sample to another sample from the same population. Moreover, when the underlying g-DAG is at least partially known, individual studies that by themselves do not generalize to a population or sample thereof, can be combined into a generalized inference for the population or sample thereof. Those methods are included here by reference.

### How to Optimize the Generalizability of Convenience Samples

The applicant has realized the above insights on the diagnosis of generalization can be used to help the constrained optimization of non-probability sampling for generalizability. The generalization of inferences from studies that use probability samples from the population (where all elements in the population have some positive chance of being selected) is a well understood and trivial problem. In practice, however, such random probability samples are exceedingly rare. Typically, the selection of elements from the population to participate in a study is constrained by a number of logistical, ethical, statistical power, or cost considerations, so convenience non-probability sample (where some elements have zero chance of being selected into the population) are very common. As a result elements are selected into the study with little or no regard for generalizability. Consequently the findings from the study are, in principle, only applicable to the elements from the population that participated in the study but not to the elements of the population that did not participate in the study.

What g-DAGs show is that whether non-probability sampling is an issue or not depends on whether the variable indicating selection into the study (S) is (conditionally) independent from the outcome Y such that (S⊥Y|W)_{G}. By way of illustration suppose a Health Management Organization decides to test a novel smoking cessation program in its population of patients by recruiting into the study only people with blue eyes. This is clearly a non-probability sample. No matter. As illustrated above, if the variable measuring eye color is independent from the outcome at baseline (e.g. smoking status), then the selected sample is as good as a random probability sample. Thus, the non-probability sample notwithstanding, the findings from this study will generalize to the population of patients of the HMO as if it were a uniform random sample.

Whereas the previous section discussed how the generalizability of such convenience samples may be diagnosed, here four methods are provided for adapting the selection criteria in ways that (a) respect as much as possible the original criteria, and (b) guarantee generalization (license and transport, in terms of the table in FIG. 26). For example, suppose a national retail bank wants to pilot test a customer service training program with a view to improving customer satisfaction in some select locations before implementing it all over its national network. These locations are selected on the basis of management convenience, and number of employees. For example, the criteria may limit participation to retail banks located in the same region as the head quarters participating in the pilot (e.g. variable Region=region), with more than 5 employees (e.g. W>5). Suppose also the bank has customer satisfaction reports from a random sample of all its retail banks nationwide. Now consider two difficulties. First, if (Region⊥Y)_{G}_{_{S}} is not true (i.e. Region and Y are d-connected in graph G_{S}), then generalization is licensed but not transportable as per the table in FIG. 26 (P(Regionₛₐₘₚₗₑ) cannot not overlap P(Regionₚₒₚ) since only one region is included). Second, if (Region⊥Y)_{G}_{_{S}} is true and (W⊥Y)_{G}_{_{S}} is true, or it isn't but P(Wₛₐₘₚₗₑ) overlaps P(Wₚₒₚ), then the estimate from one region may be consistent and approximately unbiased for the causal effect in the population. However, this estimate may not be a very good approximation given that the sample covers only one region, which may introduce chance correlations between S and Y (small sample “bias”). If (Region⊥Y)_{G}_{_{S}} these chance correlations disappear as more regions are added to the sample.

The above example shows that is the variables that went into the selection function are known, then by the table in FIG. 26 generalization is licensed but findings may not be fully transportable for lack of overlap. The latter is a problem whenever selection into a study involves inequalities in some selection criteria X, such as X≧x, or X=x, or, more generally, X [symbol] x, where [symbol] ε{≧, ≦, =≠}; and whenever these criteria are binding, such that some elements in the population have a zero chance of being selected into the sample, then P(Xₛₐₘₚₗₑ) cannot overlap P(Xₚₒₚ) so only partial transport is possible. Such criteria are typical of convenience sampling. Using g-DAGS, the applicant realized that there are two general methods for ensuring the generalizability of such convenience samples, as well as convenience samples where the selection criteria are loosely specified if at all (for example, the criteria may be confidential, so the knowledge worker designing the study may have been provided with the final list of selected locations only, excluding any information of how they were chosen). These two methods will now be disclosed. Both methods assume baseline data on the outcomes Y and some other variables W—including the variables used for selecting the sample if possible—are available for the proposed sample, and for a random sample from the target population (or a census).

1. The first method involves partitioning the variables W that went into the selection into those that overlap the corresponding population distribution W and those that do not W′. As noted, when the selection variables are known, the only thing standing in the way of generalization is lack of overlap. The latter limits generalization to a partial transport. Having identified the selection variables W′ that do not overlap the corresponding population distribution, the next step is to search for variables within the sample that overlap the corresponding variables in the population, and d-separate W′ from Yin the underlying partially unknown g-DAG (partially because we do know the selection equation, and other aspects of the study under the control of researchers). If the g-DAG were known we could identify these variables, call them X directly from the graph. In practice the g-DAG is only partially known, and specifically, the causes of the outcome are only known with uncertainty. No matter. First, we can simply test whether (W′⊥Y)_{G}_{_{S}} by testing an implication of this proposition, namely ∀w′ₛₐₘₚₗₑεW′ₛₐₘₚₗₑ, it must be the case that P(Yₛₐₘₚₗₑ|Wₛₐₘₚₗₑ=Wₛₐₘₚₗₑ, W′ₛₐₘₚₗₑ=w′ₛₐₘₚₗₑ)≡P(Yₚₒₚ|Wₚₒₚ=wₛₐₘₚₗₑ). If this test is not rejected we have evidence that W′ can be ignored for generalization purposes, so the lack of overlap is a non-issue. Second, if the test is rejected then W′ cannot be ignored for generalization and the lack of overlap is an issue. In this latter case we can search for some variables X such that (i) (W′⊥Y|X)_{G}_{_{S}}; and (ii) P(Xₛₐₘₚₗₑ) overlaps P(Xₚₒₚ). The latter is directly observable. The former can be checked by testing the observable implication ∀xₛₐₘₚₗₑ εXₛₐₘₚₗₑ it must be the case that P(Yₛₐₘₚₗₑ|Wₛₐₘₚₗₑ=Wₛₐₘₚₗₑ, Xₛₐₘₚₗₑ=xₛₐₘₚₗₑ)≡P(Yₚₒₚ|Xₚₒₚ=xₛₐₘₚₗₑ). If this test is not rejected we have some evidence that the selection variables W′ that lack overlap can be replaced (formally blocked) with variables X that do overlap the population; and use these to compute the population effects in place of W′. This method has the advantage that the sample of elements chosen for the study remains intact. All that changes is how population effects are computed. It can also increase the power of the study, as the X variables are closer to Y than the W′ variable, so stratifying the RCT design by these variables likely increases power.

2. The second method is applicable when the first method fails. In this case, for generalization to happen, the study sample will have to be changed. The method tries to achieve generalization while, at the same time, remaining as close as possible to the original intent of the proposed selection. The method works by sampling new elements from a census, or a random sample from the population, in ways that try to mimic as much as possible the proposed sample. First, create a variable S′ for the random sample from the population, and let S′=0 for all elements in the random sample. Second, use a matching procedure to match the elements in the proposed study sample with their counterparts in the random sample on the basis of the desired selection criteria (e.g. Region=region and W=w). Third, set S′=1 for the closest matches amongst the random sample from the population for the elements in the proposed study sample. Fourth, rank all available baseline variables X in the proposed sample according to how well they overlap the corresponding variables in the random sample from the population, with those that overlap the most receiving the highest rank. Fifth, use a standard statistical routine to fit a propensity score for S′ on the basis of X, with a regularizer that punishes the use of Xs of low rank. This yields a new selection equation S=f′_{S}(X). Finally, we use the latter to draw a large number of random samples from the population sample (or census), and compute how often the selected sample selection variables overlap their population counterparts. If we are satisfied with the operating characteristics, we use that estimated sampling function to generate a study sample. Otherwise we can tweak the regularization until the selection function works as desired.

The basic idea in the second method is to mimic the original selection function without having to rely on variables like Region that complicate overlap. Instead, we train a selection function that tries to select elements in the region by figuring out what variables make that region special, and then using those variables—which are more evenly distributed—to get us there. The advantage is that using this method the selection criteria are known, and, in large enough samples, overlap is assured, whilst yielding a sample as close as possible to the proposed sample. The disadvantage is that the actual sample will differ from the proposed sample, and it will likely include elements from other regions. However, that is the price for generalization. More generally, those skilled in the statistical arts will appreciate that the method may be adapted to include sampling costs, convenience measures (e.g. distance to headquarters), etc with a view to generating a sample selection function that meets two goals: (i) Select a sample as close to the proposed original sample, at minimal cost etc, and (ii) ensure the generalizability of the selected sample.

3. The two previous methods assumed that the point of departure was a proposed convenience sample. Alternatively, the third method consider situations were we might be given criteria like “sample elements with high W”, in which case the best way to proceed is to make the probabibility of selection a function of the criteria. Once again, if these probabilities are too sensitive to the criteria, then overlap is not guaranteed in smaller samples. For a given desired sample size, the approach is to iteratively sample from the population using the proposed sampling function, checking overlap across all samples, and reducing the weights attached to the criteria that, in the selected samples, most often fail to overlap their population counterparts. Advantageously, this may be automated according to the methods described herein.

4. The fourth method covers situations where no constraints are placed on the sampling. From the point of view of generalization the temptation is to select the sample on variables completely uncorrelated with Y, such that (Y⊥S)_{G}_{_{S}}. However, from the perspective of maximizing the power of the study (i.e. the probability of detecting an effect when in fact there is one) the best option is to reduce as much as possible the variance in Y, while increasing the expected size of the effect by selecting elements on suspected moderators of the effect of the intervention on the outcome in ways that might boost the expected effect. This translates into selecting elements from the population on the basis of possible direct causes of Y, whilst giving more weight to those causes expected to account for most of the variance, and/or moderating effects. As before, the selection function can be tweaked until it yields the greatest power in the smallest sample size, whilst ensuring overlap.

### Methods and Systems for Generalization

Effectively dealing with generalization requires an integrated knowledge identification and management strategy. One that places the population of interest at the center of all investigations from the start of research activities. One that builds in safeguards in the design of RCTs to ensure ex ante that the findings from the experiment will generalize to the target population, specially when convenience non-probability samples are used for logistical, cost, ethical considerations, or other reasons. One that exploits these safeguards at the analysis stage to correctly compute the desired population causal effects. And one that has built-in test and blocking modules to license and correctly transport generalized findings from a sample to a population, or from a sample to another sample from the sample population, including findings from segmented analysis, and to combine studies that by themselves are not generalizable into a generalizable inference (in this last instance assuming aspects of the underlying g-DAG are known). Exemplary implementation of these various processes are described below.

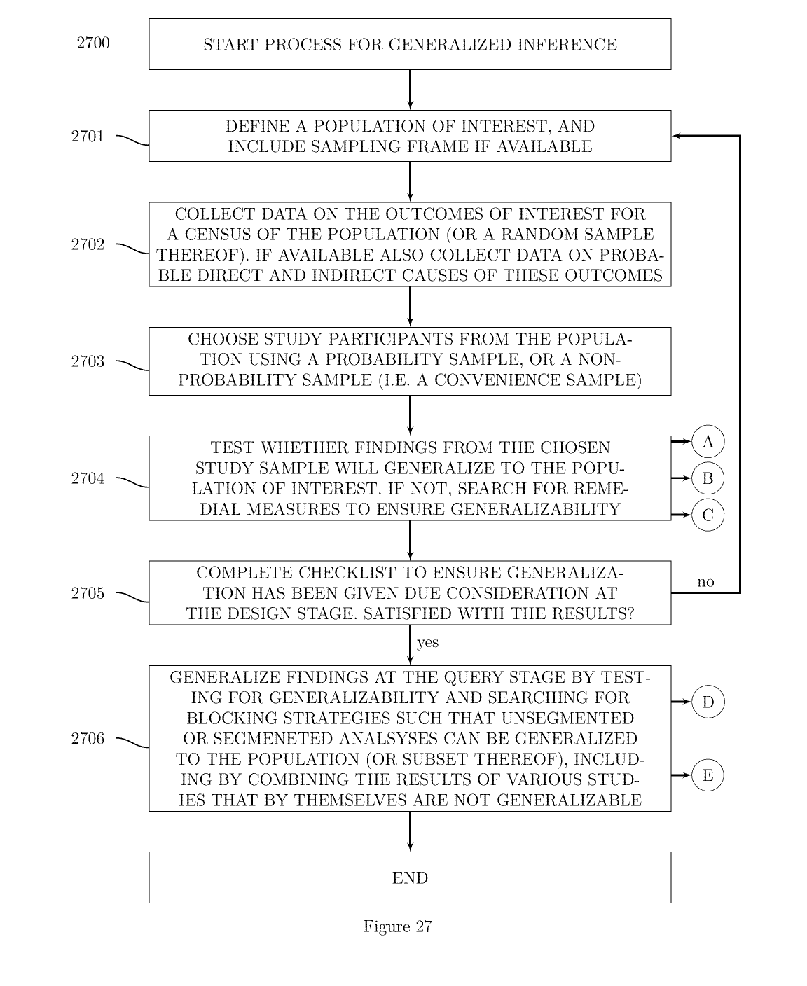

An exemplary implementation of the process for ensuring that findings from a planned study generalize to the population of interest is depicted in FIG. 27, and will now be described. The system and method herein disclosed may be implemented in connection to an integrated causal knowledge identification and management process, like the one depicted in FIG. 2, including, but not limited to, Steps 201, 202, 203, 207, 208, 211, 212; and implemented in a system like the one depicted in FIG. 1. However, the system and method herein disclosed may also be implemented independently from an integrated knowledge identification and management system.

The first step in integrated generalization process 2700, step 2701, is to enter into a graphical knowledge base a definition of the population of interests, and, if possible, a complete listing of the members of the population (like policy holders in an insurance pool of interest, or retail stores in a target retail network, and so on). In an exemplary implementation this step may have already been completed in connection to an integrated causal knowledge identification and management process, like the one depicted in FIG. 2, as part of Step 201. (Indeed, one advantage of an integrated system is the possibility of requesting such data by default from the start of operations.)

The second step in integrated generalization process 2700, step 2702, is to enter into a graphical knowledge base baseline data on the outcome of interest from a population census, or, failing that, from a random sample from the population. As described above, such data can be used to diagnose the generalizability of causal effects from study samples to other targets of interest. In addition, data on possible direct or indirect causes of the outcome of interest from a census or random sample from the population are also desirable. As described above, such data can be used to resolve problems of non-generalizability. Additional data may be added to the graphical knowledge base, even if not directly represented graphically in the KDG under consideration. For example, such data may include data on variables that are descendants of the direct and indirect causes of Y. These variables may be used as proxies for the direct and indirect causes of Y whenever these are difficult or expensive to observe and measure. In one implementation these variables may already have been identified in Step 202 and measured in Step 207, in connection to an integrated knowledge identification and management process, like the one depicted in FIG. 2. Further, these data may be stored in a graphical knowledge base in computer readable media 105, from where they can be read by generalization engine 110.

The third step in integrated generalization process 2700, Step 2703, is to choose study participants. Here elements from the population may be recruited on the basis of probability or non-probability (i.e. convenience) samples, including by enumerating them by their individual identification. As noted above probability samples are rare in practice due to cost, logistics, ethics, statistical, and other considerations, which substantially complicates generalization. No matter. The user is allowed to chose elements from the population using both probability and non-probability sampling criteria. Often the people responsible for the selection criteria are different from the knowledge workers designing the study, and so the latter must adapt to the requirements of the former.

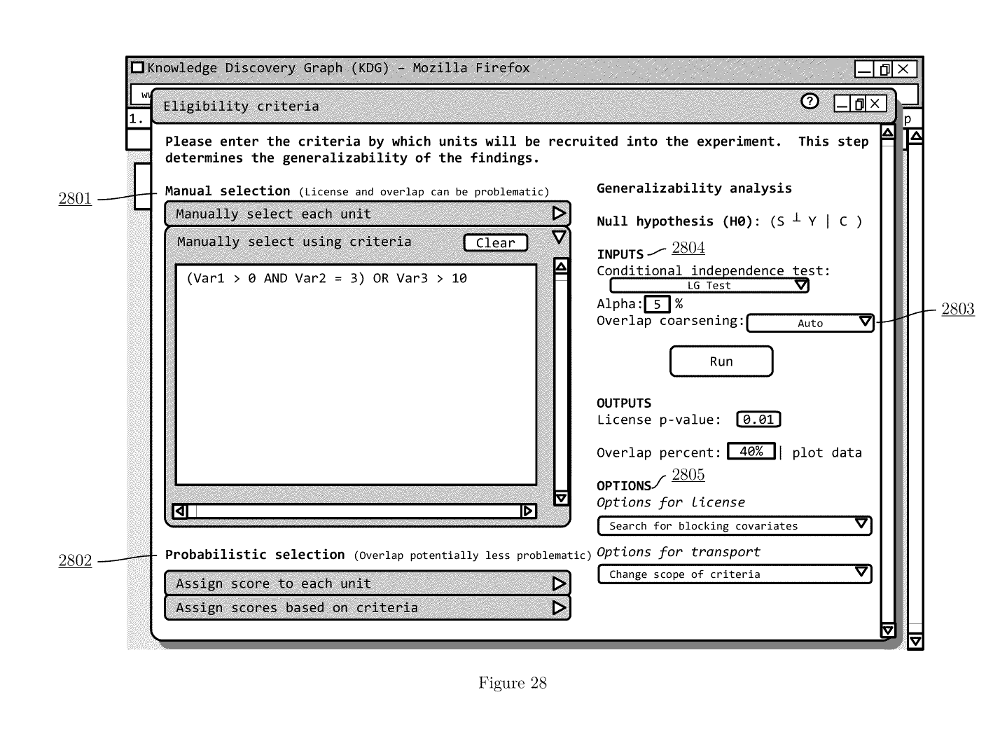

For example, in one exemplary instance of process 2700 in FIG. 27 client 107 may instruct processor 106 to provide a web page over network 102 like the web page in FIG. 28. The user operating client 107 can input data and use said web page to operate a component of generalization engine 110 that executes process 2703 to select elements from the population to participate in the study, to be stored in computer readable media 105. For instance, as shown in FIG. 28 the user of client 107 has options to select a convenience sample manually using the web element 2861, or to select elements using probability sampling, including by assigning importance scores used for weighted probability sampling, using web element 2802. This web page is exemplary and not limiting in any way, for example the web page may allow the user to enter pre-defined criteria stored in computer readable media 105.

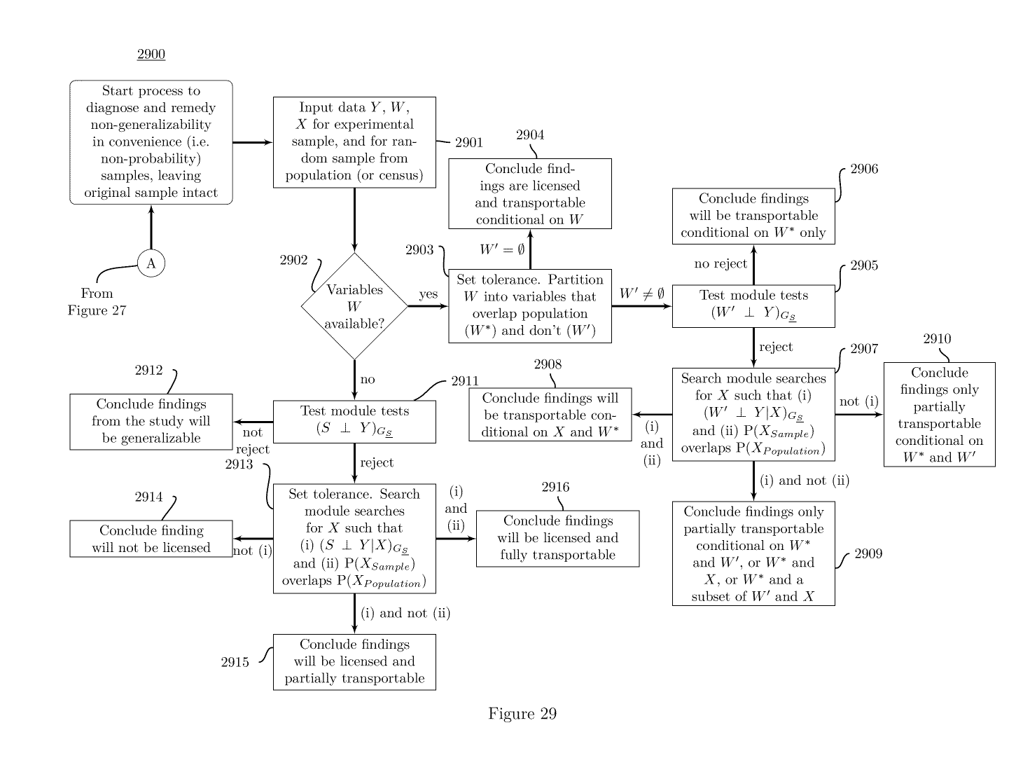

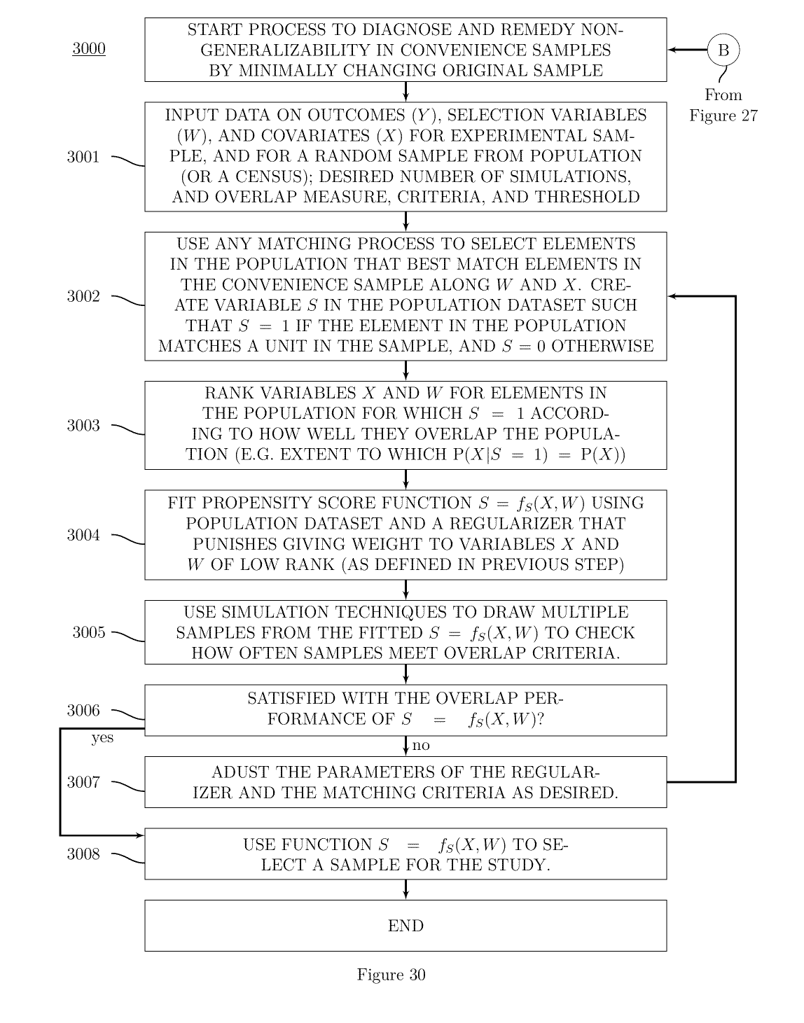

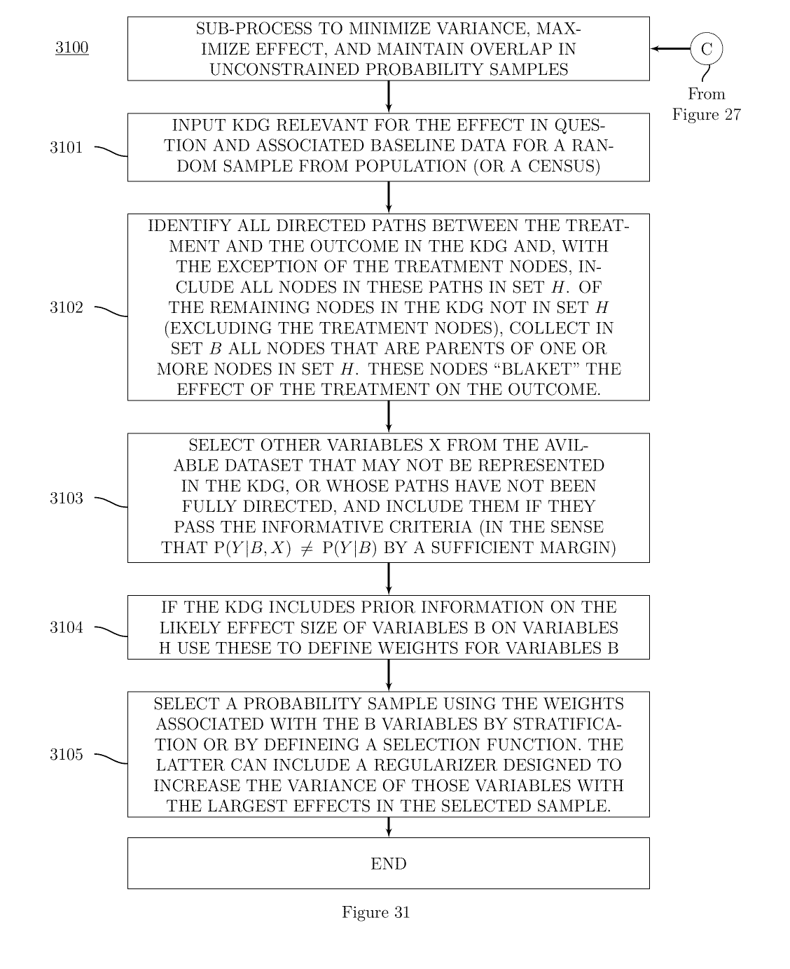

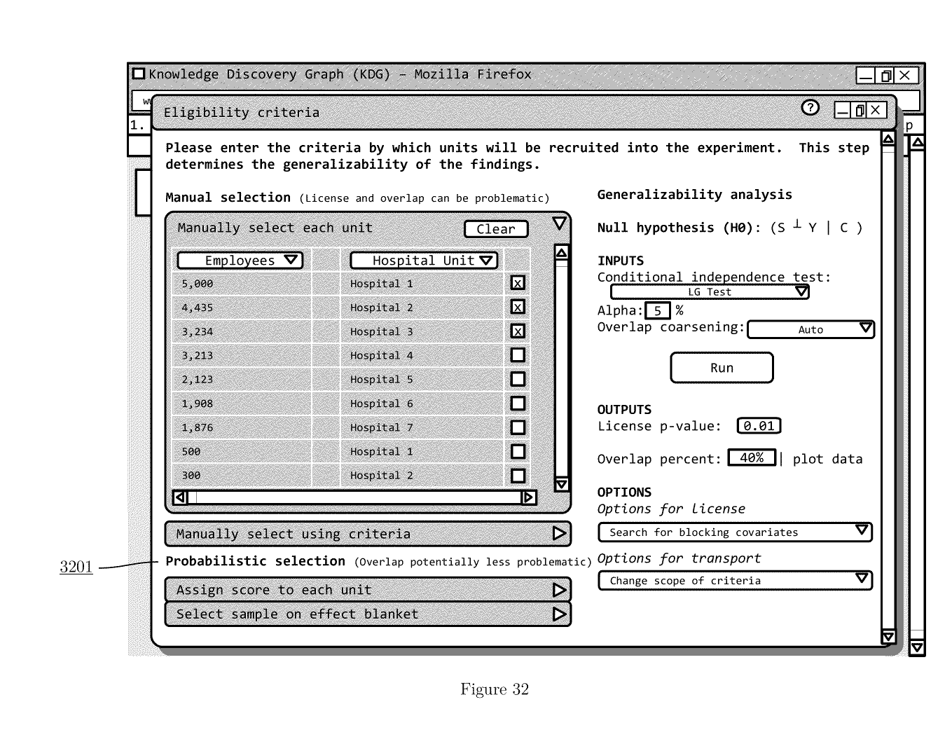

The fourth step in integrated generalization process 2700, Step 2704, tests whether findings from the study sample recruited using the selection criteria defined in the previous step will generalize to the population of interest, and if not tries to find a solution. This process is specially useful to ensure findings from convenience samples will generalize to the population, though it can also check the overlap characteristics of probability samples using simulation, and adapt them as necessary. This process includes three sub-processes. The first two are directed to convenience non-probability samples, the third to probability samples. These will now be explained.
1. Sub-process to diagnose and remedy non-generalizability in convenience samples that leave the original sample intact.
   In one exemplary implementation processor 106 may execute instructions related to generalization analysis in generalization engine 110, that may implement exemplary sub-process 2900 in FIG. 29 to diagnose and remedy non-generalizability in convenience samples that leave the original sample intact. This process takes as inputs, in Step 2901 baseline data for the selected sample—and for a random sample from the population of interest (or a census)—on the outcomes of interest Y, the selection variables W if known, and any other variables X that may seem relevant to the analysis and may ave been collected in previous steps.
   Next, in Step 2902 processor 106 executes a query module to check whether selection variables W were included in Step 2901. This might not have been possible if elements in the study were selected by their individual identifiers only. If variables W were included in Step 2901, in Step 2903 processor 106 executes instructions in generalization engine 110 to set the tolerance level for checking overlap. This involves a form of data coarsening for regularization purposes. In one implementation this level may be set at a default level but also modified by the user via web element 2803. Based on this tolerance level processor 106 executes instructions to partition the selection variables W into those that overlap their population equivalents (W*), and those that do not (W′). If the set of variables that do not overlap is empty (W′=), in Step 2904 processor 106 writes a record to computer readable media 105 to the effect that the selection criteria ensure generalizability. This is because we (i) know what variables were used in the selection, and (ii) we have found they overlap the corresponding variables in the population. If the set of variables that do not overlap is not empty (W′≠), in Step 2905 processor 106 executes instructions to test (W′⊥Y)_{Gs}. If the test is not rejected, in Step 2906 processor 106 writes a record to computer readable media 105 to the effect that the findings will be transportable conditional on W* only. This is because selection on W′ is not informative for the outcome Y so it can be ignored in the generalization process, while W* may or may not be informative but has full overlap, and that is a sufficient condition given that it is a selection variable.
   If the test in Step 2905 had been rejected at the chosen level of significance, then in Step 2907 processor 106 executes instructions to search for other variables X in the available dataset that meet two conditions: (i) (W′⊥Y|X)_{Gs}, and (ii) P(Xₛₐₘₚₗₑ)=P(X_{Population}). The intuition is to screen-off variables W′ from Y by means of X. If so we can use X, which overlaps the population, in place of W′, which does not. If such a set of variables is found for all variables in W′, then in Step 2908 processor 106 writes a record to computer readable media 105 to the effect that findings will be transportable conditional on X and W*. If only some subset of variables is found that meet condition (i), and of these only some or all pass condition (ii), then a number of outcomes are possible. Specifically, processor 106 executes instructions to partition the set of variables W′ into those that can be screened by some variable X, and those that cannot. Among those that can be screened, if X overlaps the population, then replace the relevant W′ with X in the selection set. If X does not overlap the population but has better overlap than W′ then replace the relevant W′ with X in the selection set. Otherwise keep W′ in the selection set. Once all variables in W′ have been processed in Step 2909 processor 106 writes a record to computer readable media 105 to the effect that findings will only be partially transportable conditional on the set of variables chosen. Finally, if no variables are found that meet condition (i), then in Step 2910 processor 106 writes a record to computer readable media 105 to the effect that findings are only partially transportable conditional on the original set W.
   If in Step 2902 it was discovered no selection variables W had been provided, then in Step 2911 processor 106 executes instructions to test whether (S⊥Y|X)_{Gs}. If the test is not rejected at the chosen level of significance, then in Step 2912 processor 106 writes a record to computer readable media 105 to the effect that findings will be generalizable. This is because, as explained above, selection is independent from the outcome. However, if the test was rejected at the chosen level of significance, then in Step 2913 processor 106 executes instructions to search for other variables X in the available datasets for the sample and the population that meet two conditions: (i) (S⊥Y|X)_{Gs}, and (ii) P(Xₛₐₘₚₗₑ)=P(Xₚₒₚᵤₗₐₜᵢₒₙ)—The intuition is to screen-off variable S from Y by means of X, so selection is conditionally independent form the outcomes of interest. Moreover, if this same set of variables X also overlaps the population, then the inference form the sample to the population is both licensed and fully transportable. Now consider the possible cases. First, if no set of variables is found that meets condition (i), then findings from the study sample are not licensed for the population, in which case condition (ii) is irrelevant. If so, in Step 2914 processor 106 writes a record to computer readable media 105 to the effect that findings from the study will not be licensed for the population on the basis of the available data. Next, if a set of variables is found that meets condition (i) but not all variables in this set meet condition (ii), then in Step 2915 processor 106 writes a record to computer readable media 105 to the effect that findings from the study will be licensed but only partially transportable to the population of interest. Next, if a set of variables is found that meets condition (i) and all variables in this set also meet condition (ii), then in Step 2916 processor 106 writes a record to computer readable media 105 to the effect that findings from the study will be licensed and fully transportable.
   For example, in one exemplary instance of process 2700 in FIG. 27 client 107 may instruct processor 106 to provide a web page over network 102 like the web page in FIG. 28. The user operating client 107 can input data and use said web page to operate a component of generalization engine 110 that executes process 2704 to choose specific tests, and tolerance levels, in connection to the testing and searching modules in diagnostic process 2900. For instance, as shown in FIG. 28 the user of client 107 has options to use web elements 2804 and 2805 to select non-parametric or parametric conditional independence tests with which to test the null hypothesis, as well as various options to perform searches for blocking covariates, or compare overlap (say between variables W′ and X, as discussed above). Those skilled in the arts of statistical analysis will recognize that the optimal test for testing the null hypothesis will depend on the specific situation, and in particular on the nature of the data (e.g. binary, continuous, and so on). This web page is exemplary and not limiting in any way, for example the web page may allow the user to enter additional data and variables X stored in computer readable media 105 or in any client computer 107 accessible via network 102. It may also pre-select optimal tests and inputs according to the data entered to more fully automate the process. And it may configure the process for situations where there are numerous outcomes of interest.
2. Sub-process to diagnose and remedy non-generalizability in convenience samples by minimally changing the original sample.
   In one exemplary implementation processor 106 may execute instructions related to generalization analysis in generalization engine 110, that may implement exemplary sub-process 3000 to diagnose and remedy non-generalizability in convenience samples by minimally changing the original sample shown in FIG. 30. This process takes as inputs, in Step 3001, baseline data for the selected sample—and for a random sample from the population of interest (or a census)—on the outcomes of interest Y, the selection variables W if known, and any other variables X that may seem relevant to the analysis and may have been collected in previous steps. At this step the desired number of simulations to be used for checking overlap, as well as the overlap measure and minimum threshold are set by the user operating client 107.
   Next, in Step 3002 processor 106 executes a matching module of choice in generalization engine 110 to find elements in the random sample from the population (or census) that best match elements in the convenience sample (i.e. have the most similar values of X and W). It then creates a new variable S in the population sample (or census) such that S=1 for elements in the population selected by the matching process as good matches, and S=0 otherwise. (If using a census be sure to exclude from the census the elements in the convenience sample before matching.) Next, in Step 3003 processor 106 executes a generic ranking module in generalization engine 110 that ranks all the variables X and W for members of the random sample from the population for which S=1 according to how well these variables overlap the population. The idea is to avoid selection as much as possible on variables that, amongst this group, have very poor overlap.
   Next, in Step 3004 processor 106 executes instructions in generalization engine 110 to fit a binary probit or logit models, or any other such model of choice to variable S, using a regularizer, a term of art in statistics and machine learning related to methods of model selection, in this case designed to give less weight to variables in X and W of low rank. The outcome of this step is an estimated sample selection equation S=f_{S}(X, W). Next, in Step 3005 processor 106 executes instructions in generalization engine 110 to run sampling simulations. For example, in one implementation the estimated sample selection equation is used to draw the pre-determined number of samples (with replacement) from the random population sample from the population or census. For each sample the overlap measure is calculated, a record is made of whether it exceeds the minimum desired criteria, and the percentage of all samples exceeding the minimum is computed. If in Step 3006 the percentage of samples exceeding this criteria exceeds the minimum threshold defined above, processor 106 executes instructions to store the estimated function in computer readable media 105. Otherwise, in Step 3007 it executes instructions to adjust the parameters of the regularizer and or matching criteria, to ensure better overlap, and the process iterates back to Step 3002. Iterations continue until a default level is reached, at which point the iterations stop and a warning is given to the user of client 107 that a selection function with the desired criteria could not be found and the last estimated function is written to computer readable media 105. In the next Step 3008 the saved function is used to select the final sample of elements from the random sample of elements from the population (or census) to be used in the RCT.
   For example, in one exemplary instance of the sub-process to diagnose and remedy non-generalizability in convenience samples, process 3000 in FIG. 30, client 107 may instruct processor 106 to provide a web page over network 102 like the web page in FIG. 28. The user operating client 107 can input data and use said web page to operate a component of generalization engine 110 that executes sub-process 3000 to diagnose and remedy non-generalizability in convenience samples, and select elements from the population to participate in the study, to be stored in computer readable media 105. This web page is exemplary and not limiting in any way, for example the web page may allow the user to select to keep a x percent of the original convenience sample, and then select the remaining 100-x percent using the process above to ensure overlap. This may be accomplished using the options in web element 2805.
3. Sub-process to minimize variance, maximize effect, and maintain overlap in unconstrained probability samples
   In one implementation this process refers to the case where the knowledge worker is given a free rein in determining the criteria for selecting a sample that will generalize to the population. This is the textbook case of sample selection, where normally a simple random sample, or stratified sample would be selected. However, using g-DAGs the applicant has determined that the best way to reduce variance, maximize the expected effect size, and increase statistical power while ensuring generalizability is to select the study sample on the basis of variables representing nodes in the KDG of interest that “envelop” all nodes in the directed paths connecting the treatment to the outcome.
   In one exemplary implementation processor 106 may execute instructions related to generalization analysis in generalization engine 110, that may implement exemplary sub-process 3100 to minimize variance, maximize effect, and maintain overlap in unconstrained probability samples, as shown in FIG. 31. This process starts with Step 3101 to select the KDG and associated graphical knowledge base associated with the causal effect under study, as well as the relevant population data from which the study sample is to be chosen. Next, in Step 3102 processor 106 executes a graphical analysis module in knowledge identification and management engine 109 to identify the all directed paths between the effect and the outcome in the KDG, and to identify the set of blanketing nodes B. Next, in Step 3103 processor 106 executes tests and search modules in generalization engine 110 to identify other variables X not in set B (or H) that are identified as very informative for Y. Next, in Step 3104 processor 106 executes instructions to assign weights to the variables in B according to prior information on likely effect sizes in the graphical knowledge management database stores in computer readable media 105. Next, in Step 3104 processor 106 executes a sampling module in knowledge identification and management engine 109 to select a probability sample according to the elicited criteria.
   For example, in one exemplary instance of sub-process 3100 depicted in FIG. 31 client 107 may instruct processor 106 to provide a web page over network 102 like the web page in FIG. 32. The user operating client 107 can input data and use said web page to operate a component of generalization engine 110 that executes sub-process 3100 to select probability samples that minimize variance, maximize effect, and maintain overlap, and select elements from the population to participate in the study, to be stored in computer readable media 105. For example, the web page may allow the user to select a sample based on the effect blanket by using web element 3201.

The fourth step in integrated generalization process 2700, step 2705, is to complete a checklist to ensure adequate measures have been taken to ensure sample findings can be generalized to the population of interest. In an exemplary implementation this step may be completed in connection with Step 208 of the integrated knowledge identification and management process depicted in FIG. 2. If the results of the previous analysis suggests that findings from the study will not be generalizable to the population of interests, then the user needs to decide whether to continue with the project as is, or whether to go back to Step 2701 and rerun the process to either: (i) change the population of interest, or give up on generalizing some outcomes but not other outcomes included in variables Y; (ii) choose new sampling criteria that ensure generalizability, this may include topping up the convenience sample with a probability sample to ensure overlap; or (iii) measure other variables X such that generalizability can be assured on the basis of these new variables. If despite these recursive steps the findings cannot be generalized, then the user can decide to continue with the study in the full knowledge of its limitations. In one instance some of these limitations may be overcome in connection with Steps 211 and 212 of the integrated knowledge identification and management process depicted in FIG. 2 by making (iv) parametric assumptions like linearity or additivity at the analysis and modeling stage.

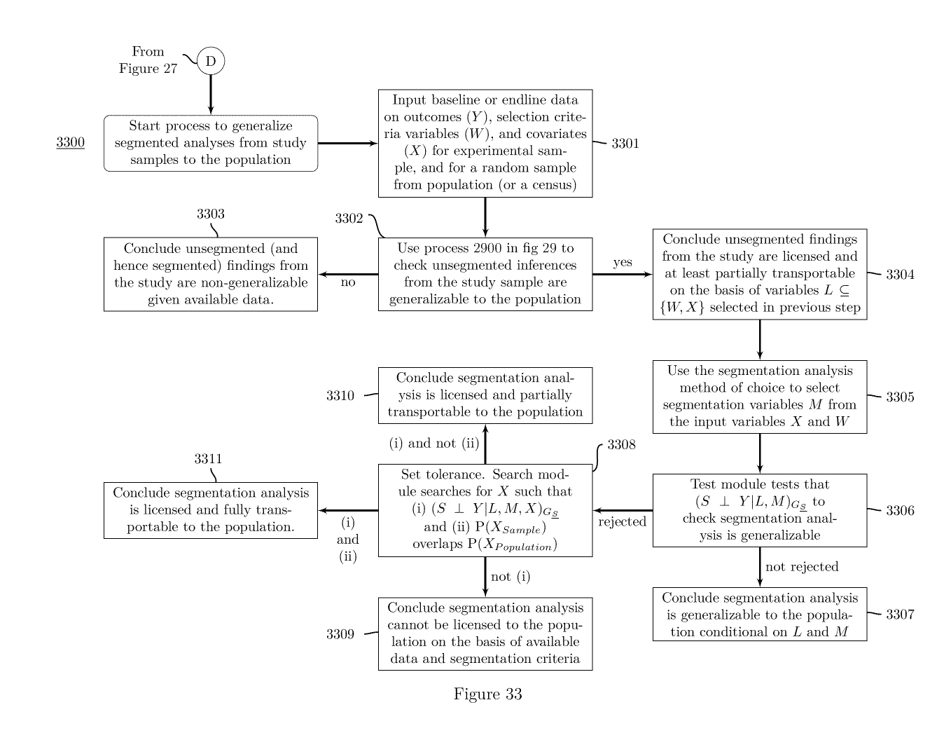

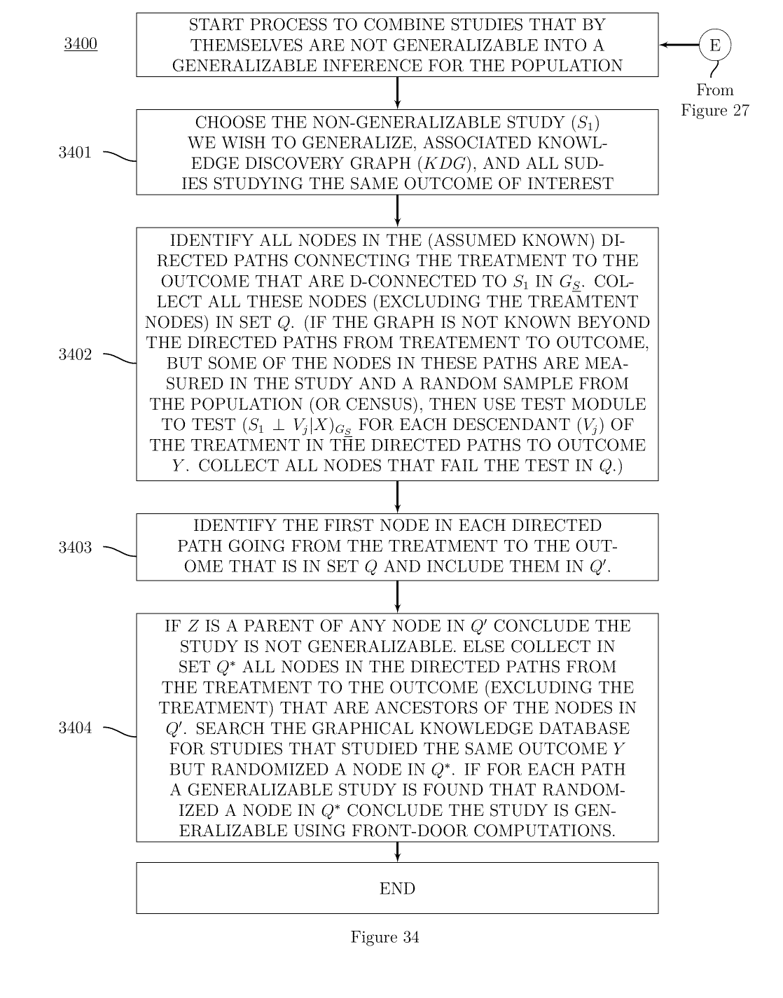

The fifth and final step in integrated generalization process 2700, Step 2706, is to use the collection of studies in a graphical knowledge base to answer generalization queries. If the studies under consideration were designed ex-ante with a view to generalization, this should be no major problem. Otherwise, or for more intricate queries, the testing and blocking searching strategies disclosed above can be also used to answer ex post generalization queries. In fact, the situation is somewhat analogous to the problem of determining ex ante whether a convenience sample will generalize to the population, in that ex post we have no choice to change the sample, or sampling criteria. The main difference is that ex post we may have both baseline and endline data, which opens up additional testing opportunities. This process includes four sub-processes. These will now be explained.
1. Sub-process to generalize from a study sample to a population of interest
   In one implementation this process is not different that the ex-ante generalization, except Y now can include data form baseline, endline, or both. As disclosed above this means that at least two different test are available to test the same null. These may be combined for increased power.
2. Sub-process to generalize segmentation analyses from a study sample to a population
   In one exemplary implementation processor 106 may execute instructions related to generalization analysis in generalization engine 110, that may implement exemplary generalizable segmentation analysis process 3300 in FIG. 33. This process starts with Step 3301 to input baseline data (if available), the endline data, and information of how elements from the population were recruited into the experiment (if available) from the RCT study we want to extrapolate from, and for a random sample from the population (or census). Next, in Step 3302 processor 106 executes sub-process 2900 in FIG. 29 to check unsegmented inferences from the study sample are generalizable to the population. This step is useful in cases where we are not sure the study we want to extrapolate from is generalizable. This may happen if the data for the study were provided by a third party without guidance as to how the sample was selected. If the sampling is know and is generalizable then this step can be skipped. If sub-process 2900 determines the unsegmented findings from the study are not generalizable, a record is written in Step 3303 to computer-readable media 105 to the effect that segmented findings from this study are not generalizable. Else, in Step 3304 processor 106 writes a record to computer-readable media 105 to the effect that unsegmented findings from the study are licensed and at least partially transportable on the basis of variables L c {W, X} selected by sub-process 2900 in FIG. 29.
   Next, in Step 3305 processor 106 implements instructions to carry out the segmentation analysis using any segmentation module available in knowledge identification and management engine 109, or in the knowledge market, or indeed any other segmentation module uploaded to knowledge identification and management engine 109 by client 107 over network 102, and available in memory 108. This may include (but not limited to) boosting, LASSO, and so on. The outlook of such an analysis is typically a set of segmentation variables M that purport to explain most of the variation in the estimated causal effects. Typically these variables are then used to target the rollout of the tested intervention to those elements in the population whose values of M predict a large effect. As discussed in greater detail above this analysis can be misleading whenever M includes a collider between the selection and the outcome. Hence, in Step 3306 processor 106 executes a test module in generalization engine 110 to test the null that (S⊥Y|L, M)_{G}_{_{S}}, using the test procedures described above. If the test is not rejected at the chosen level of significance, a record is written in Step 3307 to computer-readable media 105 to the effect that the segmentation analysis is generalizable to the population conditional on L and M.
   If the test in Step 3306 had been rejected at the chosen level of significance, then in Step 3308 processor 106 executes instructions to search for other variables X in the available datasets for the sample and the population that meet two conditions: (i) (S⊥Y|L, M, X)_{G}_{_{S}}, and (ii) P(Xₛₐₘₚₗₑ)=P(Xₚₒₚᵤₗₐₜᵢₒₙ). The intuition is to screen-off variable S from Y by means of X, specifically by blocking the collider path activated by conditioning on W so selection is conditionally independent form the outcomes of interest. Moreover, if this same set of variables X also overlaps the population, then the segmentation inference form the sample to the population is both licensed and fully transportable. Now consider the possible cases. First, if no set of variables is found that meets condition (i), then findings from the study sample are not licensed for the population, in which case condition (ii) is irrelevant. If so, in Step 3309 processor 106 writes a record to computer readable media 105 to the effect that segmented findings from the study will not be licensed for the population on the basis of the available data and segmentation criteria. Next, if a set of X variables is found that meets condition (i) but not all variables in this set meet condition (ii), then in Step 3310 processor 106 writes a record to computer readable media 105 to the effect that segmented findings from the study will be licensed but only partially transportable to the population of interest. Next, if a set of variables X is found that meets condition (i) and all variables in this set also meet condition (ii), then in Step 3311 processor 106 writes a record to computer readable media 105 to the effect that findings from the study will be licensed and fully transportable.
   Those skilled in the statistical and graphical analysis arts will realize that if results from the segmented analysis are not licensed one possibility is to use the search module in Step 3308 to search iteratively for W′⊂W that allows for licensing and at least partial transport, wile retaining some of the benefits of targeting the intervention to segments where it is expected to have the largest effect.
3. Sub-process to generalize from a study sample to another sample from the population
   In one implementation this process is not different from the previous process of segmentation, whereby the criteria used for selecting the second target sample are used in place of M. And the important overlap conditions are that (i) P(L|S₁) and P(L|S₂) overlap; and (ii) P(M|S₁) and P(M|S₂) overlap.
4. Sub-process for combining studies that by themselves are not generalizable into a generalizable inference for the population.
   In one implementation this sub-process can be used when the results of a study cannot be generalized to the population, and no blocking strategies that d-separate the study selection variable S from the outcome Y are available.
   In one exemplary implementation processor 106 may execute instructions related to generalization analysis in generalization engine 110, that may implement sub-process 3400 in FIG. 34 for combining studies that by themselves are not generalizable into a generalizable inference for the population. The process starts with Step 3401 to select the non-generalizable study we wish to generalize to the population, along with the associated KDG and all other studies studying the same outcome in computer-readable media 105. The KDG is important because this method assumes that all directed paths from the treatment to the outcome are know, though it does not require that all of the mediators along those paths are measured or known, though that may translate in missed opportunities. Next, in Step 3402 processor 106 executes a structure search module in generalization engine 110 to collect these in set Q all the nodes in the directed paths connecting the treatment to the outcome (excluding the treatment but including the outcome) that are associated with S₁ in the mutilated graph G_{S}, assuming the graph is known. Else, if the graph is not known beyond the directed paths from treatment to outcome, but some of the nodes in these paths are measured in the study and a random sample from the population (or census), then processor 106 executes a test module in generalization engine 110 to test (S₁⊥Vⱼ|X)_{G}_{_{S}} for each descendant (Vⱼ) of the treatment in a directed path to outcome Y, where X are covariates. Collect all nodes that fail the test in Q.
   Next, in Step 3403 processor 106 executes instructions to identify the nodes in set Q that have no ancestor nodes in the set, only descendant if any, and collects them in set Q′. Note that ancestor and descendant are terms of art in graphical analysis that describe the relations between nodes. Intuitively we are selecting, by directed path, the nodes in Q nearest to the treatment X. Next, in Step 3404 processor 106 executes instructions to check whether treatment Z is a parent of any element in set Q′, in which case processor 106 writes a record to computer readable media 105 to the effect that findings from the study will not be licensed for the population on the basis of the available data and studies. Else, processor 106 executes instructions to collect in set Q* all nodes in the directed paths from the treatment to the outcome (excluding the treatment) that are ancestors of the nodes in Q′. It then searches the graphical knowledge database for studies that studied the same outcome Y but randomized a node in Q*. If for each path a generalizable study is found that randomized a node in Q* conclude the study is generalizable using front-door computations. Processor 106 writes a record to computer readable media 105 to the effect that findings from the study are generalizable, and computes the desired population level effect.
   Those skilled in the statistical and graphical analysis arts will realize that the above is a simple example of what is possible. Specifically, we restricted attention to auxiliary studies that studied the same outcome variable Y only. If we included studies that also studies the effect of some mediators on other mediators along the directed paths connecting the treatment X and the outcome Y, then there are other more intricate possibilities.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

### REFERENCES

Martel García, Fernando. 2013a. A Unified Approach to Generalized Causal Inference. Working Paper 2304970 Social Science Research Network. Available at http://ssrn.com/abstract=2304970.
Martel García, Fernando. 2013b. When and Why is Attrition a Problem in Randomized Controlled Experiments and How to Diagnose it. Working Paper 2267120 IQSS. Available at SSRN: http://ssrn.com/abstract=2267120.

1. A system for integrated identification and management of causal knowledge, the system comprising:
a knowledge identification and management engine comprising a knowledge discovery graph (KDG), wherein the KDG presents information of an organization's existing causal knowledge within a domain of the KDG, wherein the KDG additionally functions as a graphical user interface to provide access to a graphical knowledge database, wherein the graphical knowledge database stores relevant disembodied information about the causal knowledge represented by the KDG;
a knowledge market configured to be accessible by one or more networks, the knowledge market having a single information architecture and/or related application programing interfaces; and
a computing device configured to receive a selection of a research goal and target population of interest in association with the KDG,
wherein the computing device if further configured to request qualitative or quantitative causal knowledge about direct causes and indirect causes of an outcome of interest including which causes in the KDG or the graphical knowledge database may be directly manipulable, indirectly manipulable, or non-manipulable,
wherein the computing device is further configured to request qualitative or quantitative causal knowledge about costs and effectiveness of intervention to change some direct or indirect cause of the outcome of interest,
wherein the computing device is further configured to request knowledge about variables that may d-separate the attrition and the outcome being investigated, including causes in common,
wherein the computing device is further configured to aggregate results received in response to the request for knowledge about direct and indirect causes, the request for knowledge about costs and effectiveness, and the request for knowledge about variables that may d-separate into the KDG using one or more aggregation modules provided by the knowledge identification and management engine or the knowledge market,
wherein the computing device is further configured to measure variables in the KDG or graphical knowledge database, including measuring possible causes of the outcome of interest and attrition,
wherein the computing device is further configured to add measurements from one or more other databases to variables in the KDG or graphical knowledge database,
wherein the computing device is further configured to generate a design for a generalizable randomized controlled trial (RCT) to test aspects of the KDG, the generation of the design including selection of sampling plans that have known probability of generating causal estimates that are consistent and approximately unbiased for the target population of interest, even when convenience non-probability samples are used,
wherein the computing device is further configured to generate a RCT implementation plan, the implementation plan including built-in safeguards against problematic attrition and a Gantt graphical abstraction engine for managing the implementation process,
wherein the computing device is further configured to process results of the RCT in connection with the KDG by determining problematic attrition and generalizing segmented or unsegmented findings from the RCT based on a non-random sample from the population to the target population or to a sub-sample thereof,
wherein the computing device is further configured to determine whether problematic attrition exists,
wherein the computing device is further configured to determine conditions under which a generalization is acceptable, and
wherein the computing device is further configured to determine whether the generalization is transportable.

2. A computer-implemented method comprising:
receiving a first dataset associated with a randomized controlled experiment (RCT), the first dataset comprising:
a variable or set of variables Z capturing a treatment allocation;
a variable or set of variables Y capturing observed outcomes of interest;
a variable or set of variables, each corresponding to one variable in set Y, indicating whether the corresponding variable Y is observed or labeled as missing; and
other variables X related to the experiment, including baseline and/or endline variables;
using a processor to test whether the treatment Z is d-separated of attrition (formally whether (Z⊥R)_{G}) by testing for independence in the observed probability distribution (Z⊥R)_{P} and reporting a p-value for the test; and
using a processor to automatically compute an identified and estimable causal quantity of interest in accordance with results of the testing, the identified and estimable causal quantity of interest comprising:
a point estimate for a causal effect for all elements in the experiment, or
a combination of a point estimate for elements with observed outcomes and an interval estimate for elements with unobserved outcomes, or
an interval estimate for all elements in the experiment.

3. The method of claim 2, further comprising:
receiving a second set of data from a non-response follow-up survey at baseline;
using a processor to fill in corresponding missing values in the baseline survey from the follow up survey;
using a processor to test whether the outcomes of interest are d-separated from attrition indicators (formally whether (Y⊥R)_{G}) by testing for independence in the observed probability distribution (Y⊥R)_{P} and determining, on the basis of the reported p-value and a pre-determined significance level, whether attrition is problematic or not;
determining by a processor based on the tests implemented by the processor, the p-values, and the pre-determined significance levels whether attrition is problematic;
if attrition is determined to be problematic, using a processor to search amongst the other baseline variables X for a variable or set of variables X′, wherein X′⊂X such that (Y⊥R|X′)_{P};
using a processor to determine, on the basis of the reported p-values and pre-determined significance level, whether:
causal effects are identified and estimable for the full experimental sample; or
causal effects are identified and estimable only for elements with observed outcomes; or
attrition is problematic but can be remedied by marginalizing over variables X′; or
attrition is problematic and marginalization is not possible; and
using a processor to automatically compute the identified and estimable causal quantity of interest in accordance with the results of the testing, including by marginalizing over X whenever (Y⊥R|Z, X)_{P}.

4. The method of claim 2, further comprising:
receiving data in real time over a network from a non-response follow-up survey at baseline;
using a processor to fill in corresponding missing values in the baseline survey from the follow up survey;
using a processor to perform adaptive tests of whether the outcomes of interest are d-separated from the attrition indicators (formally whether (Y⊥R)_{G}) by testing for independence in the observed probability distribution (Y⊥R)_{P};
using a processor to perform adaptive tests of whether there exists variables X′ amongst variables X, wherein X′⊂X such that (Y⊥R|X′)_{P};
using a processor to stop further collection of follow up survey data in real time when:
evidence that (Y⊥R)_{G} reaches a pre-determined level of confidence; or
adaptive searches reveal enough evidence to conclude, at a pre-determined level of confidence, that there exists X′ amongst variables X, wherein X′⊂X such that (Y⊥R|X′)_{P}; and
using a processor to automatically compute the identified and estimable causal quantity of interest in accordance with results of the testing, including by marginalizing over X whenever (Y⊥R|Z, X)_{P}.

5. The method of claim 2, further comprising:
receiving a second set of data from a non-response follow-up survey at endline;
using a processor to fill in corresponding missing values in the endline survey from the follow up survey;
using a processor to test whether the outcomes of interest are d-separated from the attrition indicators (formally whether (Y⊥R|Z)_{G}) by testing for independence in the observed probability distribution (Y⊥R|Z)_{P} and determining on the basis of the reported p-value and a pre-determined significance level whether attrition is problematic or not;
determining by processor on the basis of the tests implemented by the processor, p-values, and pre-determined significance levels whether attrition is problematic;
if attrition is problematic, using a processor to search amongst the other baseline variables X for a variable or set of variables X′, wherein X′⊂X such that (Y⊥R|Z, X′)_{P};
using a processor to determine, on the basis of the reported p-values and pre-determined significance level, whether:
causal effects are identified and estimable for the full experimental sample; or
causal effects are identified and estimable only for those elements with observed outcomes; or
attrition is problematic but can be remedied by marginalizing over variables X′; or
attrition is problematic and marginalization is not possible; and
using a processor to automatically compute the identified and estimable causal quantity of interest in accordance with the results of the test, including by marginalizing over X whenever (Y⊥R|Z, X)_{P}.

6. The method of claim 2, further comprising:
receiving data in real time over a network from a non-response follow-up survey at endline;
using a processor to fill in corresponding missing values in the endline survey from the follow up survey;
using a processor to perform adaptive tests of whether the outcomes of interest are d-separated from attrition indicators (formally whether (Y⊥R|Z)_{G}) by testing for independence in the observed probability distribution (Y⊥R|Z)_{P});
using a processor to perform adaptive tests of whether there exists variables X′ amongst variable X, wherein X′⊂X such that (Y⊥R|Z, X′)_{P};
using a processor to stop further collection of follow up survey data in real time when:
evidence that (Y⊥R|Z)_{G} reaches a pre-determined level of confidence; or
adaptive searches reveal enough evidence to conclude, at a pre-determined level of confidence, that there exists variables X′ amongst variables X, wherein X′⊂X such that (Y⊥R|Z, X′)_{P}; and
using a processor to automatically compute the identified and estimable causal quantity of interest in accordance with the results of the testing, including by marginalizing over X whenever (Y⊥R|Z, X)_{P}.

7. An article of manufacture comprising computer-executable instructions configured to cause a processor to:
receive a first dataset associated with a randomized controlled experiment (RCT), the first dataset comprising:
a variable or set of variables Z capturing a treatment allocation;
a variable or set of variables Y capturing observed outcomes of interest;
a variable or set of variables R, each corresponding to one variable in set Y, indicating whether the corresponding variables Y is observed or labeled as missing; and
other variables X related to the experiment, including baseline and/or endline variables;
receive in real time data from non-response follow up surveys at endline, baseline, or endline and baseline;
send in real time instructions to stop the non-response follow-up survey;
implement normal or adaptive tests of conditional or unconditional independencies in probability, including tests that (Z⊥R)_{P}, (Y⊥R)_{P}, (Y⊥R|X)_{P}, and (Y⊥R|Z, X)_{P} and report a p-value for the test and a conclusion based on a pre-determined level of significance;
determine variables X′ amongst variables X, wherein X′⊂X such that (Y⊥R|Z, X′);
automatically compute an identified and estimable causal quantity of interest in accordance with the results of the testing, including by marginalizing over X whenever (Y⊥R|Z, X)_{P}; and
execute a plurality of test and search strategies on the basis of results of the tests.

8. A system comprising:
a computer-readable medium configured to store:
baseline and/or endline data from a randomized controlled experiment, including data on outcomes, attrition, treatments, and other variables that may d-separate outcomes from attrition;
data from non-response follow-up surveys at baseline and/or endline; and
data received in real time as non-response follow-up surveys at baseline and/or endline progress; and
a processor configured to send in real time instructions to stop the non-response follow-up survey,
wherein the processor is further configured to execute normal or adaptive tests of conditional or unconditional independencies in probability, including tests that that (Z⊥R)_{P}, (Y⊥R)_{P}, (Y⊥R|X)_{P}, and (Y⊥R|Z, X)_{P} and report a p-value for the test and a conclusion based on a pre-determined level of significance, and
wherein the processor is further configured to determine variables X′ amongst variables X, wherein X′⊂X such that (Y⊥R|Z, X′).

9. A computer-implemented method comprising:
receiving a first set of data on an outcome of interest and other variables from a full census from a population of interest, said first set of data including:
a variable or set of variables Y capturing outcomes of interest; and other variables X;
receiving a second set of baseline and/or endline data from a randomized controlled experiment (RCT) implemented amongst a subset of elements from the population census, said second set of data including:
a variable or set of variables R capturing a treatment allocation;
variables Z capturing a treatment received in case of endline data;
a variable or set of variables Y capturing observed outcomes of interest; and
and other variables X in common with the population data.
using a processor to compute a variable S indicating whether an element from the population was included in the RCT study or not;
using a processor to test whether the variable capturing selection into the RCT study S is d-separated from the baseline outcome variables Y (formally whether (S⊥Y)_{G}) by testing for independence in the observed probability distribution (S⊥Y)_{P}, and reporting a p-value for the test;
using a processor to test whether the variable capturing selection into the RCT study S is d-separated from the endline outcome variables Y under the assumption that the control condition in the RCT is “absence of treatment” and not some other intervention that otherwise disrupts a natural process, wherein the processor performing the test of this step includes testing whether (S⊥Y|R=0)_{G} by testing for independence in the observed probability distribution (S⊥Y)_{P} and reporting a p-value for the test;
using a processor to automatically search for a set of variables X′, wherein X′⊂X such that (S⊥Y|X′)_{P} if data from the RCT are from a baseline, or such that (S⊥Y|R=0, X′)_{P} if data from the RCT are from endline and R=0 refers to “absence of treatment”;
using a processor to automatically check that a distribution of outcomes for variables X′ in the RCT data overlap a corresponding distribution in the census data; and
using a processor to automatically compute an identified and estimable causal quantity of interest for the population using a combination of experimental data and data from the population.

10. The method of claim 9, further comprising:
receiving a third set of baseline and/or endline data from a proposed sample of elements to be included in a prospective RCT.

11. A computer-implemented method comprising:
receiving a first set of data on an outcome of interest and other variables from a random sample from a population of interest, said first set of data including:
a variable or set of variables Y capturing observed outcomes of interest; and
other variables X;
receiving a second set of baseline and/or endline data from a randomized controlled experiment (RCT) implemented amongst a subset of elements from the population census, said second set of data including:
a variable or set of variables R capturing a treatment allocation;
variables Z capturing a treatment received in case of endline data;
a variable or set of variables Y capturing the observed outcomes of interest;
other variables X in common with a random sample of data from the population;
using a processor to test in baseline data whether (Y⊥S)_{G}_{_{S}} in an unknown underlying g-DAG by testing whether P(Yₚₒₚ)≡P(Yₛₐₘₚₗₑ) in the observed samples, wherein P(Yₚₒₚ) refers to a distribution of outcomes in the random sample from the population and P(Yₛₐₘₚₗₑ) refers to the baseline distribution of outcomes amongst elements in an experimental sample;
using a processor to test whether (Y⊥S)_{G}_{_{S}} in the unknown underlying g-DAG using endline data from an RCT, wherein a control condition refers to the “absence of treatment” and not some other intervention that otherwise disrupts a natural process, wherein the processor performing the test of this step includes testing whether P(Yₚₒₚ)≡P(Yₛₐₘₚₗₑ|R=0) in the observed samples, wherein P(Yₚₒₚ) refers to a distribution of outcomes in the random sample from the population, and P(Yₛₐₘₚₗₑ|R=0) refers to an endline distribution of outcomes amongst elements in the experimental sample assigned to absence of treatment;
using a processor to automatically search for a set of variables X′, wherein X′⊂X such that (S⊥Y|X′)_{G}, in the underlying unknown g-DAG;
testing that there exists X′ such that P(Yₚₒₚ|X′ₚₒₚ=x′ₛₐₘₚₗₑ)≡P(Yₛₐₘₚₗₑ|X′ₛₐₘₚₗₑ=w′ₛₐₘₚₗₑ) if data are from a baseline or P(Yₚₒₚ|X′ₚₒₚ=x′ₛₐₘₚₗₑ)≡P(Yₛₐₘₚₗₑ|X′ₛₐₘₚₗₑ=x′ₛₐₘₚₗₑ, R=0) if data are from an endline, wherein by definition P(Wₚₒₚ) stochastically dominates P(Wₛₐₘₚₗₑ);
using a processor to automatically check that a distribution of outcomes for variables X′ in the RCT data overlap a corresponding distribution in the census data; and
using a processor to automatically compute an identified and estimable causal quantity of interest for the population using a combination of experimental data and data from the population.

12. The method of claim 11, further comprising:
receiving a third set of baseline and/or endline data from a proposed sample of elements to be included in a prospective RCT.

13. A computer-implemented method comprising:
receiving a first set of data on an outcome of interest and other variables from a census from a population of interest, said first set of data including:
a variable or set of variables Y capturing observed outcomes of interest; and
other variables X;
receiving a second set of baseline data from a proposed sample of elements from a census to be included in a prospective RCT, said second set of data including:
a variable or set of variables Y capturing observed outcomes of interest; and
other variables X in common with a random sample of data from the population, including data on criteria that led to the selection;
using a processor to create a variable S′ in the population dataset and setting S′=0 for all elements in the dataset;
using a processor to match the elements in the proposed study sample with counterparts in the population dataset on the basis of desired selection criteria;
using a processor to set S′=1 for the closest matches amongst the random sample from the population for the elements in the proposed study sample;
using a processor to rank all available baseline variables X in the proposed sample according to how well the variables X overlap corresponding variables in the population data, with variables that overlap the most receiving the highest rank;
using a processor to fit a propensity score for S′ on the basis of X, with a regularizer that punishes the use of variables in X with low rank, returning an estimated selection equation S=f′_{S}(X);
using a processor to draw a large number of random samples from the population data using the selection equation S=f′_{S}(X);
computing how often the selected sample selection variables overlap population counterparts;
adjusting the regularization criteria until operating characteristics criteria are met; and
using the estimated sampling function to generate a study sample with guaranteed generalization properties.

14. The method of claim 13, wherein the first set of data is data from a random sample from the population of interest.

15. An article of manufacture comprising computer-executable instructions configured to cause a processor to:
receive a first dataset associated with a proposed or executed randomized controlled experiment (RCT), the first data set including:
a variable or set of variables Y capturing observed outcomes of interest; and
other variables X related to the experiment, including baseline and/or endline variables and/or a set of variables R capturing a treatment assignment;
execute parametric or non-parametric tests of conditional or unconditional independencies in probability, and report a p-value for the test and a conclusion based on a pre-determined level of significance;
execute conditional tests to determine whether two probability distributions are equivalent, and report a p-value for the test and a conclusion based on a pre-determined level of significance;
execute the preceding tests in order to determine variables X′ amongst variables X such that X′⊂X and conditional on these variables selection is independent of the outcome (S⊥Y|X′)_{P};
compute the extent to which one distribution overlaps another;
automatically compute an identified and estimable causal quantity of interest in accordance with results of the testing; and
execute a plurality of test and search strategies on the basis of the results of the testing.

16. A system comprising:
a computer-readable medium configured to store baseline and/or endline data from a prospective or executed randomized controlled experiment, including data on outcomes, treatment assignments if available, and other variables that may d-separate the selection from the outcome; and
a processor configured process a first dataset associated with a proposed or executed randomized controlled experiment (RCT) that includes:
a variable or set of variables Y capturing observed outcomes of interest;
other variables X related to the experiment, including baseline and/or endline variables; and
in executed experiments, a variable or set of variables R capturing a treatment assignment,
wherein the processor is configured to execute tests of conditional or unconditional independencies in probability,
wherein the processor is configured to report a p-value for the test and a conclusion based on a pre-determined level of significance,
wherein the processor is configured to execute conditional tests to determine whether two conditional probability distributions are equivalent, and report a p-value for the test and a conclusion based on a pre-determined level of significance,
wherein the processor is configured to execute the previous tests in order to determine variables X′ amongst variables X such that X′⊂X and conditional on these variables selection is independent of the outcome (S⊥Y|X′)_{P},
wherein the processor is configured to compute the extent to which one distribution overlaps another,
wherein the processor is configured to automatically compute an identified and estimable causal quantity of interest in accordance with the results of the testing; and
wherein the processor is configured to execute a plurality of test and search strategies on the basis of the results of the testing.
